(19) United States
(12) Patent Application Publication
(10) Pub. No.: US 2022/0178626 A1
(43) Pub. Date: Jun. 9, 2022

(54) DEVICES, SYSTEMS AND METHODS FOR THERMAL MANAGEMENT

(71) Applicant: Holo, Inc., Newark, CA (US)

(72) Inventors: Arian AGHABABAIE, San Francisco, CA (US); Brian ADZIMA, Hayward, CA (US); Peter SCHMEHL, Berkeley, CA (US); Daniel CHRISTIANSEN, San Francisco, CA (US); Harish IRRINKI, Fremont, CA (US); Karthik BODLA, Houston, TX (US)

(21) Appl. No.: 17/522,567

(22) Filed: Nov. 9, 2021

Related U.S. Application Data
(63) Continuation of application No. PCT/US20/32760, filed on May 13, 2020.
(60) Provisional application No. 62/847,721, filed on May 14, 2019.
(60) Provisional application No. 62/893,963, filed on Aug. 30, 2019.
(60) Provisional application No. 62/953,280, filed on Dec. 24, 2019.

(51) Int. Cl. F28F 3/06; F28D 21/00

(52) U.S. Cl. CPC F28F 3/06; F28F 2215/04; F28D 2021/0029; F28D 21/00

(57) ABSTRACT

The present disclosure provides a thermal management device comprising a vapor chamber, a heat pipe in fluid communication with the vapor chamber, and a fin in thermal contact with the heat pipe. The vapor chamber may contain a first working fluid and may facilitate transfer of thermal energy from a source of thermal energy to the first working fluid. The fin may comprise a fluid flow path configured to direct a second working fluid from a first opening to a second opening. The first opening may be oriented along a first direction of flow towards the fin, and the second opening may be oriented along a second direction different than the first direction. The heat pipe may direct the first working fluid from the vapor chamber through the heat pipe and may facilitate transfer of thermal energy from the first working fluid to the fin or the second working fluid.

### CROSS-REFERENCE

This application is a continuation of International Patent Application No. PCT/US20/32760, filed May 13, 2020, which claims the benefit of U.S. Provisional Patent Application No. 62/847,721 filed on May 14, 2019, U.S. Provisional Patent Application No. 62/893,963 filed on Aug. 30, 2019, and U.S. Provisional Patent Application No. 62/953,280 filed on Dec. 24, 2019, each of which is entirely incorporated herein by reference for all purposes.

### BACKGROUND

Electronic and/or mechanical systems (e.g., thermal control systems, energy storage systems, heat recovery systems, energy conversion systems, etc.) can generate heat during their operation. As these systems become more complex, they can generate more heat. In some cases, heat transfer units such as heat sinks and heat exchangers can be used to regulate the temperatures of the systems (e.g., dissipate heat from the systems) during their operation.

### SUMMARY

Given the ongoing development of increasingly complex devices and systems with high thermal loads and power densities, recognized herein is a need for alternative systems and methods for thermal management. The present disclosure provides thermal management devices with high thermal loads and power densities, and methods of use thereof. The heat dissipation capacity of the thermal management devices of the present disclosure may vary based on, for example, (i) a size and/or shape of the thermal management devices, (ii) an arrangement of heat fins and/or pipes within the thermal management devices, and/or (iii) one or more materials used to construct the thermal management devices.

Additive manufacturing and three-dimensional (3D) printing technologies may be used to generate high-performance heat transfer devices with customized and complex freeform shapes that can enhance thermal management capabilities. The heat exchanger devices of the present disclosure may be fabricated using additive manufacturing and/or other 3D printing techniques to, for example, leverage advantageous aspects of both air-cooling and two-phase cooling.

In an aspect, the present disclosure provides a thermal management device comprising: a vapor chamber, wherein the vapor chamber is configured to contain a first working fluid and facilitate transfer of thermal energy from a source of the thermal energy to the first working fluid; a heat pipe in fluid communication with the vapor chamber; and a fin in thermal contact with the heat pipe, wherein the fin comprises a fluid flow path in fluid communication with a first opening and a second opening, wherein the fluid flow path is configured to direct a second working fluid from the first opening to the second opening, wherein the first opening is oriented along a first direction of flow of the second working fluid towards the fin, wherein the second opening is oriented along a second direction different than the first direction, and wherein the heat pipe is configured to direct the first working fluid from the vapor chamber through the heat pipe and facilitate transfer of thermal energy from the first working fluid to the fin or the second working fluid.

In some embodiments, the thermal management device further comprises an array of fins, which array of fins comprises the fin. In some embodiments, the array of fins is in thermal contact with the vapor chamber.

In some embodiments, the first opening is disposed on a first surface of the fin. In some embodiments, the second opening is disposed on a second surface of the fin. In some embodiments, the first opening has a first shape and the second opening has a second shape that is different than the first shape. In some embodiments, the first opening and the second opening are disposed at different heights relative to a base portion of the fin.

In some embodiments, the second direction is at an angle greater than 0 degrees and less than or equal to 90 degrees relative to the first direction.

In some embodiments, the second direction is at an angle greater than 90 degrees and less than or equal to 180 degrees relative to the first direction.

In some embodiments, the fin is configured as an airfoil. In some embodiments, the heat pipe and the fin are configured as an airfoil.

In some embodiments, the heat pipe comprises a closed-loop capillary recirculation system. In some embodiments, the closed-loop capillary recirculation system comprises a wick structure that is configured to transport the first working fluid through the heat pipe.

In some embodiments, the heat pipe is in thermal communication with a plurality of fins of the array of fins.

In some embodiments, the array of fins comprises a first set of fins and a second set of fins. In some embodiments, the first set of fins and the second set of fins are provided in a staggered arrangement. In some embodiments, the first set of fins and the second set of fins are arranged such that the first set of fins is not obstructed by or aligned with the second set of fins.

In some embodiments, the fin is disposed between a second fin and a third fin of the array of fins. In some embodiments, a distance between the fin and the second fin and an additional distance between the fin and the third fin are substantially similar.

In some embodiments, the fin is disposed between a second fin and a third fin of the array of fins. In some embodiments, a distance between the fin and the second fin and an additional distance between the fin and the third fin are different.

In some embodiments, the array of fins comprises a plurality of fins having a same chord length, radial length, thickness profile, or angle of attack. In some embodiments, the array of fins comprises a plurality of fins having different chord lengths, radial lengths, thickness profiles, or angles of attack.

In another aspect, the present disclosure provides a thermal management device for liquid cooling, the thermal management device comprising: a plate, wherein the plate is configured to facilitate a transfer of thermal energy from a source of the thermal energy to a surface of the plate, or vice versa; an array of fins in thermal contact with the surface of the plate, wherein the array of fins is configured to facilitate a transfer of the thermal energy from the surface of the plate to a cooling fluid; and a manifold block located adjacent to the plate, wherein the manifold block comprises an inlet, an outlet, and a cooling fluid flow path in fluid communication with the inlet and the outlet, wherein the cooling fluid flow path is configured to (i) direct the cooling fluid from a reservoir located external to the manifold block to the inlet, (ii) direct the cooling fluid from the inlet through a flow splitter of the manifold block, which flow splitter is configured to (a) split the cooling fluid into a plurality of streams comprising the cooling fluid, and (b) direct the plurality of streams through the array of fins towards an outer edge of the array of fins, and (iii) direct the plurality of streams from the outer edge of the array of fins to the outlet of the manifold block.

In some embodiments, the array of fins, the plate, and the manifold block forms a single unitary structure. In some embodiments, the single unitary structure comprises copper.

In some embodiments, the array of fins comprises a plurality of fins configured in a diagonal arrangement. In some embodiments, the plurality of fins comprises at least four sets of fins comprising two or more parallel fins. In some embodiments, each of the at least four sets of fins comprises one or more fins that extend from a center of the plate to an outer edge of the plate.

In some embodiments, a first fin of a first set of fins is in thermal contact with a second fin of a second set of fins, and the first fin is oriented at an angle relative to the second fin, which angle is greater than 0 degrees and less than or equal to 180 degrees.

In some embodiments, the array of fins comprises a plurality of fins with one or more turbulating features disposed on a surface of each of the plurality of fins.

In some embodiments, the array of fins comprises one or more jagged fins that extend upwards from the surface of the plate in a zigzag pattern.

In some embodiments, the array of fins comprises a plurality of tapered fins.

In some embodiments, the thermal management device further comprises one or more turbulating pins configured to enhance turbulence within the cooling fluid when the cooling fluid flows through the array of fins.

In some embodiments, the flow splitter comprises at least four curved surfaces extending outwards from the inlet to the outer edge of the array of fins. In some embodiments, each of the at least four curved surfaces is configured to direct one of the plurality of streams through a portion of the array of fins.

In some embodiments, each of the at least four curved surfaces is oriented at an angle relative to one other, which angle is greater than 0 degrees and less than or equal to 90 degrees.

In another aspect, the present disclosure provides a thermal management device comprising: an array of fins comprising a first fin and a second fin adjacent to the first fin; and a heat transfer structure disposed between and in contact with the first fin and the second fin, wherein the first fin and the second fin is configured for heat transfer to or from a fluid in contact with the first fin and the second fin, and wherein the heat transfer structure is configured for heat transfer (i) to the first fin and the second fin, or (ii) from the first fin and the second fin.

In some embodiments, the thermal management device further comprises a plate adjacent to the array of fins. In some embodiments, the plate is configured to transfer heat from a source of the heat to the array of fins, or transfer the heat from the array of fins to a sink of the heat.

In some embodiments, the thermal management device further comprises a manifold block disposed adjacent to the plate. In some embodiments, the manifold block comprises an inlet, an outlet, and a fluid flow path in fluid communication with the inlet and the outlet. In some embodiments, the fluid flow path is configured to direct the fluid from the inlet of the manifold block, through at least a portion of the array of fins, and towards the outlet of the manifold block.

In some embodiments, the first fin or the second fin are oriented at an angle relative to the plate, which angle is between about 45° and about 135°.

In some embodiments, the thermal management device further comprises an array of manifold walls in thermal contact with the array of fins. In some embodiments, a fin of the array of fins and a manifold wall of the array of manifold walls are oriented in different directions.

In some embodiments, the fin of the array of fins and the manifold wall of the array of manifold walls are oriented perpendicular to each other.

In some embodiments, the array of fins and the array of manifold walls comprise a same material. In some embodiments, the array of fins and the array of manifold walls comprise different materials.

In some embodiments, the array of fins comprises a plurality of zones. In some embodiments, a first zone and a second zone of the plurality of zones have different thermal resistivities.

In some embodiments, a first flow rate of the fluid across the first zone and a second flow rate of the fluid across the second zone are different.

In some embodiments, a thermal resistivity of a zone of the plurality of zones is between about 5 square millimeters degrees Celsius per Watt (mm²·° C./W) and about 50 mm²·° C./W.

In some embodiments, an area of a zone of the plurality of zones is between about 0.01 square millimeters (mm²) to about 1000 mm².

In some embodiments, the thermal management device exhibits a thermal resistance that is at least 5% less than a thermal management device without any of the heat transfer structure.

In some embodiments, the thermal management device exhibits a thermal resistance that is at least 10% less than a thermal management device without any of the heat transfer structure.

In some embodiments, the thermal management device exhibits a thermal resistance that is at least 40% less than a thermal management device without any of the heat transfer structure.

In some embodiments, a distance between the first fin and the second fin is at least about 40 micrometers. In some embodiments, a thermal resistivity of the thermal management device is at most about 25 mm²·° C./W.

In some embodiments, the distance between a first fin and a second fin is at least about 250 micrometers.

In some embodiments, the thermal resistivity is at most about 20 mm²·° C./W.

In some embodiments, the heat transfer structure fills at least 5% of a volume disposed between the first fin and the second fin. In some embodiments, the heat transfer structure fills at least 10% of the volume disposed between the first fin and the second fin. In some embodiments, the heat transfer structure fills between about 20% and about 50% of the volume disposed between the first fin and the second fin.

In some embodiments, the heat transfer structure is in contact with at least 5% of a surface of the first fin or the second fin. In some embodiments, the heat transfer structure is in contact with at least 10% of the surface of the first fin or the second fin. In some embodiments, the heat transfer structure is in contact with at least 20% of the surface of the first or second fin.

In some embodiments, the array of fins comprises a material exhibiting a thermal conductivity greater than about 200 Watts per meter-Kelvin (W/m·K).

In some embodiments, the heat transfer structure is selected from the group consisting of: a linear ridge parallel to the baseplate, a lattice, a pin, and a helix.

In another aspect, the present disclosure provides a thermal management device, comprising: a baseplate in thermal communication with a heat source, wherein an area of the baseplate is divided into a plurality of zones, wherein a zone of the plurality of zones comprises a plurality of fins in thermal communication with the baseplate, wherein one or more ancillary structures are disposed between at least two adjacent fins and in thermal communication with at least one of the at least two adjacent fins and optionally with the baseplate, wherein the ancillary structures are selected from the group consisting of: linear ridges, aerodynamic solids, chevrons, triangular prisms, lattices, pins, and helices, wherein the baseplate and the array of fins comprise a material exhibiting a thermal conductivity greater than about 200 W/m-K, wherein the thermal management device is configured for a cooling fluid to flow through the thermal management device with a device flow rate and a device flow velocity.

In some embodiments, one or more fins of the plurality of fins are planar. In some embodiments, one or more fins of the plurality of fins are jagged. In some embodiments, one or more fins of the plurality of fins are parallel. In some embodiments, the linear ridges or the triangular prisms are parallel to the baseplate. In some embodiments, at least some of the fins have a comb structure.

In another aspect, the present disclosure provides a thermal management device comprising: an array of fins and a manifold block located adjacent to the array of fins, wherein a fin of the array of fins is configured for heat transfer to or from a fluid in contact with the fin, wherein at least a portion of a surface of the fin is textured, and wherein the manifold block comprises an inlet, an outlet, and a fluid flow path in fluid communication with the inlet and the outlet, wherein the fluid flow path is configured to direct the fluid (i) from the inlet to the fin, and (ii) from the fin to the outlet.

In some embodiments, the thermal management device further comprises a plate adjacent to the array of fins. In some embodiments, the plate is configured to transfer heat from a source of the heat to the array of fins or transfer the heat from the array of fins to a sink of the heat.

In some embodiments, the array of fins further comprises an additional fin adjacent to the fin. In some embodiments, the fin and the additional fin are not in contact with each other.

In some embodiments, the thermal management device further comprises an array of manifold walls in thermal contact with the array of fins. In some embodiments, the fin of the array of fins and a manifold wall of the array of manifold walls are oriented in different directions.

In some embodiments, the fin of the array of fins and the manifold wall of the array of manifold walls are oriented perpendicular to each other.

In some embodiments, the array of fins and the array of manifold walls comprises a same material or different materials.

In some embodiments, the array of fins comprises a plurality of zones. In some embodiments, a first zone and a second zone of the plurality of zones have different thermal resistivities.

In some embodiments, a first flow rate of the fluid across the first zone and a second flow rate of the fluid across the second zone are different.

In some embodiments, a thermal resistivity of a zone of the plurality of zones is between about 5 mm²·° C./W and about 50 mm²·° C./W.

In some embodiments, an area of a zone of the plurality of zones is between about 0.01 square millimeter (mm²) to about 1000 mm².

In some embodiments, the array of fins further comprises an additional fin adjacent to the fin. In some embodiments, a distance between the fin and the additional fin is at least about 100 micrometers. In some embodiments, a thermal resistivity of the thermal management device is at most about 35 mm²·° C./W. In some embodiments, the distance is at least about 150 micrometers.

In some embodiments, the distance is at least about 300 micrometers. In some embodiments, a thermal resistivity of the thermal management device is about 39 mm²·° C./W.

In some embodiments, the thermal management device exhibits a thermal resistivity that is at least 5% less than a thermal management device having an array of fins that are not textured. In some embodiments, the at least the portion of the surface of the fin has a protrusion or a depression.

In another aspect, the present disclosure provides a thermal management device comprising: an array of fins configured for heat transfer to or from a fluid in contact with the array of fins, wherein the array of fins comprises a first subarray of fins with a first fin configuration and a second subarray of fins with a second fin configuration; and a manifold block located adjacent to the array of fins, wherein the manifold block comprises an inlet, an outlet, and a fluid flow path in fluid communication with the inlet and the outlet, wherein the fluid flow path is configured to direct the fluid (i) from the inlet to the array of fins, and (ii) from the array of fins to the outlet.

In some embodiments, the first fin configuration and the second fin configuration comprise a fin density, a fin material, a fin position, a fin orientation, a fin size, or a fin geometry.

In some embodiments, the first fin configuration and the second fin configuration are different.

In some embodiments, the first fin configuration provides a first flow characteristic for the fluid as the fluid flows through the first subarray of fins. In some embodiments, the second fin configuration provides a second flow characteristic for the fluid as the fluid flows through the first subarray of fins.

In some embodiments, the first flow characteristic and the second flow characteristic comprise different fluid flow rates.

In some embodiments, the first fin configuration provides a first thermal performance characteristic for the first subarray of fins. In some embodiments, the second fin configuration provides a second thermal performance characteristic for the second subarray of fins.

In some embodiments, the first thermal performance characteristic and the second thermal performance characteristic are different. In some embodiments, the first set and the second set of thermal performance characteristics comprise a thermal resistivity or a thermal conductivity.

In some embodiments, the first subarray of fins and the second subarray of fins comprise a same material. In some embodiments, the first subarray of fins and the second subarray of fins comprise the same material at different densities. In some embodiments, the first subarray of fins and the second subarray of fins comprise different materials.

In another aspect, the present disclosure provides a method for thermal management, comprising: (a) providing a thermal management device comprising (i) a vapor chamber containing a first working fluid, (ii) a heat pipe in fluid communication with the vapor chamber, and (iii) a fin in thermal contact with the heat pipe, wherein the fin comprises a fluid flow path in fluid communication with a first opening and a second opening of the fin, wherein the fluid flow path is configured to direct a second working fluid from the first opening to the second opening, wherein the first opening is oriented along a first direction of flow of the second working fluid towards the fin, and wherein the second opening is oriented along a second direction that is different than the first direction; (b) transferring thermal energy from a source of the thermal energy to the first working fluid; and (c) directing the first working fluid from the vapor chamber through the heat pipe to facilitate transfer of the thermal energy from the first working fluid to the fin or the second working fluid.

In some embodiments, the thermal management device comprises an array of fins, wherein the array of fins comprises the fin. In some embodiments, the fin is configured as an airfoil. In some embodiments, the heat pipe and the fin are configured as an airfoil.

In another aspect, the present disclosure provides a method for thermal management, comprising: (a) providing a thermal management device comprising (i) a plate, (ii) an array of fins in thermal contact with the plate, and (iii) a manifold block located adjacent to the plate, wherein the manifold block comprises an inlet, an outlet, and a cooling fluid flow path in fluid communication with the inlet and the outlet; (b) transferring thermal energy from a source of the thermal energy to a surface of the plate; and (c) transferring the thermal energy from the surface of the plate to a cooling fluid in thermal contact with the array of fins, wherein transferring the thermal energy from the surface to the cooling fluid comprises (i) directing the cooling fluid along the cooling fluid flow path from the inlet of the manifold block through a flow splitter of the manifold block, (ii) splitting the cooling fluid into a plurality of streams comprising the cooling fluid, (iii) directing the plurality of streams through the array of fins towards an outer edge of the array of fins, and (iv) directing the plurality of streams from the outer edge of the array of fins to the outlet of the manifold block.

In some embodiments, the array of fins comprises a plurality of fins in a diagonal arrangement. In some embodiments, the flow splitter comprises one or more curved surfaces extending outwards from the inlet to the outer edge of the array of fins.

In another aspect, the present disclosure provides a method for thermal management, comprising: (a) providing a thermal management device comprising (i) an array of fins comprising a first fin and a second fin adjacent to the first fin and (ii) a heat transfer structure disposed between the first fin and the second fin, wherein the heat transfer structure is in contact with the first fin and the second fin; and (b) transferring thermal energy from the first fin or the second fin to a fluid in contact with the first fin, the second fin, or the heat transfer structure.

In some embodiments, the heat transfer structure is selected from the group consisting of a linear ridge parallel to the baseplate, a lattice, a pin, and a helix.

In another aspect, the present disclosure provides a method for thermal management, comprising: (a) providing a thermal management device comprising (i) a baseplate in thermal communication with a heat source, wherein an area of the baseplate is divided into a plurality of zones, wherein a zone of the plurality of zones comprises a plurality of fins in thermal communication with the baseplate, and (ii) one or more ancillary structures disposed between at least two adjacent fins of the plurality of fins and in thermal communication with at least one of the at least two adjacent fins, wherein the ancillary structures are selected from the group consisting of linear ridges, aerodynamic solids, chevrons, triangular prisms, lattices, pins, and helices, wherein the baseplate and the array of fins comprise a material exhibiting a thermal conductivity greater than about 200 W/m-K; and (b) directing a cooling fluid through the thermal management device at a device flow rate and a device flow velocity.

In some embodiments, the linear ridges or the triangular prisms are parallel to the baseplate.

In another aspect, the present disclosure provides a method for thermal management, comprising: (a) providing a thermal management device comprising (i) an array of fins, wherein the array of fins comprises a fin, wherein at least a portion of a surface of the fin is textured, and (ii) a manifold block located adjacent to the array of fins, wherein the manifold block comprises an inlet, an outlet, and a fluid flow path in fluid communication with the inlet and the outlet; and (b) transferring thermal energy from the fin to a fluid in contact with the fin, wherein transferring the thermal energy comprises directing a fluid along the fluid flow path (i) from the inlet to the fin, and (ii) from the fin to the outlet.

In some embodiments, the portion of the surface of the fin has one or more protrusions or depressions.

In another aspect, the present disclosure provides a method for thermal management, comprising: (a) providing a thermal management device comprising (i) an array of fins, wherein the array of fins comprises a first subarray of fins with a first fin configuration and a second subarray of fins with a second fin configuration, and (ii) a manifold block located adjacent to the array of fins, wherein the manifold block comprises an inlet, an outlet, and a fluid flow path in fluid communication with the inlet and the outlet; and (b) transferring thermal energy from the array of fins to a fluid in contact with the array of fins, wherein transferring the thermal energy comprises directing the fluid along the fluid flow path (i) from the inlet to the array of fins, and (ii) from the array of fins to the outlet.

In some embodiments, the first fin configuration provides a first flow characteristic for the fluid as the fluid flows through the first subarray of fins, and the second fin configuration provides a second flow characteristic for the fluid as the fluid flows through the first subarray of fins.

In some embodiments, the first fin configuration provides a first thermal performance characteristic for the first subarray of fins, and the second fin configuration provides a second thermal performance characteristic for the second subarray of fins.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a thermal management device comprising a heat pipe and a fin in thermal contact with a vapor chamber, in accordance with some embodiments.

FIG. 2 schematically illustrates a fluid flow path through a fin of a thermal management device, in accordance with some embodiments.

FIG. 3 schematically illustrates a top view of a thermal management device with an array of fins and an array of heat pipes, in accordance with some embodiments.

FIG. 4 schematically illustrates an example of a three-dimensional (3D) printing system configured to generate a thermal management device, in accordance with some embodiments.

FIG. 5 schematically illustrates a computer system that is programmed or otherwise configured to implement methods provided herein.

FIG. 6 schematically illustrates a manifold block of a liquid cooling device, in accordance with some embodiments.

FIG. 7 schematically illustrates a manifold block in thermal contact with a source of thermal energy, in accordance with some embodiments.

FIG. 8 schematically illustrates an internal cross-section of a liquid cooling device, in accordance with some embodiments.

FIG. 9 schematically illustrates a cold plate of a liquid cooling device, in accordance with some embodiments.

FIG. 10 schematically illustrates a cooling fluid flow path through a manifold block of the liquid cooling device, in accordance with some embodiments.

FIG. 11 schematically illustrates a cooling fluid flow path through an exit channel of a manifold block, in accordance with some embodiments.

FIG. 12 schematically illustrates a bottom surface of a manifold block of a liquid cooling device, in accordance with some embodiments.

FIG. 13 schematically illustrates a cooling fluid flow path through a liquid cooling device, in accordance with some embodiments.

FIG. 14 schematically illustrates a diagonal arrangement of fins, in accordance with some embodiments.

FIG. 15 schematically illustrates a cooling fluid flow path through an array of fins, in accordance with some embodiments.

FIG. 16A schematically illustrates a plurality of tapered fins, in accordance with some embodiments.

FIG. 16B schematically illustrates a plurality of jagged fins, in accordance with some embodiments.

FIG. 17 schematically illustrates a liquid cooling device with a 4-way exit, in accordance with some embodiments.

FIG. 18 schematically illustrates a bottom surface of a manifold block of a liquid cooling device with a 4-way exit, in accordance with some embodiments.

FIG. 19 schematically illustrates a first internal cross-section of a liquid cooling device with a 4-way exit, in accordance with some embodiments.

FIG. 20 schematically illustrates a second internal cross-section of a liquid cooling device with a 4-way exit, in accordance with some embodiments.

FIG. 21 schematically illustrates a cooling fluid flow path through a liquid cooling device with a 4-way exit, in accordance with some embodiments.

FIG. 22 schematically illustrates one or more turbulating fins, in accordance with some embodiments.

FIG. 23 schematically illustrates one or more turbulating features disposed on one or more fins of the array of fins, in accordance with some embodiments.

FIGS. 24A-24C schematically illustrate a plate, an array of fins, and a manifold block of a thermal management device, in accordance with some embodiments.

FIGS. 25A-25B schematically illustrate an array of fins and an array of manifold walls, in accordance with some embodiments.

FIG. 26 schematically illustrates a performance comparison between a manifold micro-channel (MMC) cold plate and a commercial micro-channel cold plate, in accordance with some embodiments.

FIG. 27 schematically illustrates a heat map comparison between a manifold micro-channel (MMC) cold plate and a commercial micro-channel cold plate, in accordance with some embodiments.

FIG. 28A schematically illustrates a commercial micro-channel cold plate, in accordance with some embodiments.

FIG. 28B schematically illustrates a series of wavy microchannels, in accordance with some embodiments.

FIG. 28C schematically illustrates a plurality of impingement surfaces, in accordance with some embodiments.

FIGS. 28D-28E schematically illustrate one or more connecting structures disposed between fins in an array of fins, in accordance with some embodiments.

FIGS. 29-30 schematically illustrate a comparison of thermal performances of manifold microchannel cold plates and commercial microchannel cold plates as a function of feature size, in accordance with some embodiments.

FIGS. 31A-31B schematically illustrate a test setup for measuring a thermal performance of a thermal management device, in accordance with some embodiments.

FIGS. 32A-32B schematically illustrate a plurality of fins with a comb structure and a plurality of fins with one or more aerodynamic solids, in accordance with some embodiments.

FIGS. 33A-33B schematically illustrate a plurality of fins that are discontinuous, in accordance with some embodiments.

FIGS. 34A-34B schematically illustrate a thermal management device with discrete walls and a thermal management device with continuous walls, in accordance with some embodiments.

FIG. 35 schematically illustrates an array of fins with varying heights across a length of the array of fins, in accordance with some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “airfoil,” as used herein, generally refers to an object that generates a pressure differential and/or an aerodynamic force (e.g., a lift force) as a working fluid flows over one or more surfaces of the object. Examples of the airfoil include a wing, a compressor rotor, a stator, a turbine blade, and/or a vane. A chord length of the airfoil may be the distance between a leading edge of the airfoil and a trailing edge of the airfoil. A pressure differential and/or an aerodynamic force may be generated when a working fluid flowing from the leading edge of the airfoil to the trailing edge of the airfoil. A thickness of the airfoil may be a distance between a pressure side and a suction side of the airfoil. The thickness of the airfoil may vary from the leading edge of the airfoil to the trailing edge of the airfoil. A radial length of the airfoil may be a distance from the base of the airfoil to a tip of the airfoil. The chord length, the thickness, and/or an angle of attack of the airfoil may vary along the extent of the radial length of the airfoil. An angle of attack may be an angle between a reference line on the airfoil (e.g., the chord length) and a vector (e.g., a first direction of flow) representing the relative motion of a fluid (e.g., a second working fluid) across one or more surfaces of the airfoil. In some cases, the chord length, the thickness, and/or an angle of attack of the airfoil may gradually increase and/or decrease along the extent of the radial length of the airfoil.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The thermal management devices of the present disclosure may be formed by, for example, various three-dimensional (3D) printing techniques (e.g., stereolithography (SLA) or digital light processing (DLP)). The thermal management devices may be single-piece devices with unitary structures. For example, the thermal management devices may be substantially uniform (i.e., homogeneous), and may not include any seams on a surface of such devices and/or any material discontinuities within an internal structure of such devices. Such devices may have uniform grain structures. Such devices may have substantially ordered grains or grain boundaries. In another example, the thermal management devices may comprise different portions with different grain structures (i.e., heterogeneous). The different portions can be formed of the same material. Alternatively, the different portions can be formed using different materials. In some embodiments, the thermal management devices of the present disclosure may comprise a plurality of pieces coupled to form a unitary structure. For example, the thermal management devices may comprise a plurality of pieces with different grain structures. The thermal management devices disclosed herein may improve cooling or heating performance and may enhance thermal load management by increasing a rate and/or an amount of heat transfer between said thermal management devices and one or more devices in thermal communication with said thermal management devices.

In an aspect, the present disclosure provides a thermal management device. The thermal management device may comprise a vapor chamber, a heat pipe in fluid communication with the vapor chamber, and a fin in thermal contact with the heat pipe.

The vapor chamber may be a sealed (e.g., hermetically sealed) hollow chamber that may be configured to facilitate a transfer of thermal energy using a working fluid. The vapor chamber may be configured to contain a first working fluid. The first working fluid may be configured to receive and/or absorb thermal energy from a source of thermal energy, and undergoes a phase change (e.g., a liquid to a vapor, or a vapor to a liquid) when receiving and/or absorbing thermal energy. The first working fluid may be configured to transfer the thermal energy to a sink of thermal energy (e.g., a heat sink) or a second working fluid. The thermal energy may be directed from the first working fluid to the second working fluid through an intermediate structure, such as a heat conductive structure or medium.

The first working fluid and/or the second working fluid may comprise a working fluid. A working fluid may be a fluid (e.g., a coolant or a heat transfer fluid) that is usable to transfer heat to and/or from a region of interest by conduction, convection, and/or forced convection. As used herein, a working fluid may be a gas and/or a liquid that is capable of absorbing and/or transmitting thermal energy. The working fluid may be oxygen, nitrogen, an inert gas (e.g., argon or helium), air, water, ammonia, methanol, ethanol, hydrogen, helium, propane, butane, isobutane, ammonia, sulfur dioxide, or any combination thereof. The working fluid may include a hydrocarbon. Such hydrocarbon may be an organic hydrocarbon. The working fluid may include, for example, one or more chlorofluorocarbons, one or more hydrochlorofluorocarbons, one or more hydrofluorocarbons, and/or one or more fluorocarbons. For example, the working fluid may be trichlorofluoromethane; dichlorodifluoromethane; difluoromethane; pentafluoroethane; chlorotrifluoromethane; chlorodifluoromethane; dichlorofluoromethane; chlorofluoromethane; bromochlorodifluoromethane; 1,1,2-trichloro-1,2,2-trifluoroethane; 1,1,1-trichloro-2,2,2-trifluoroethane; 1,2-dichloro-1,1,2,2-tetrafluoroethane; 1-chloro-1,1,2,2,2-pentafluoroethane; 2-chloro-1,1,1,2-tetrafluoroethane; 1,1-dichloro-1-fluoroethane; 1-chloro-1,1-difluoroethane; tetrachloro-1,2-difluoroethane; tetrachloro-1,1-difluoroethane; 1,1,2-trichlorotrifluoroethane; 1-bromo-2-chloro-1,1,2-trifluoroethane; 2-bromo-2-chloro-1,1,1-trifluoroethane; 1,1-dichloro-2,2,3,3,3-pentafluoropropane; and/or 1,3-dichloro-1,2,2,3,3-pentafluoropropane. The working fluid may be trifluoromethane (HFC-23); difluoromethane (HFC-32); fluoromethane (HFC-41); 2-chloro-1,1,1,2-tetrafluoroethane (HFC-124); 1,1,2,2,2-pentafluoroethane (HFC-125); 1,1,2,2-tetraflu-oroethane (HFC-134); 1,1,1,2-tetrafluoroethane (HFC-134a,); 1,1-difluoroethane (HFC-152a); and/or 1,1,1,2,3,3,3-heptafluoropropane (HFC-227ea). The working fluid may be carbon tetrafluoride; perfluorooctane; perfluoro-2-methylpentane; perfluoro-1,3-dimethylcyclohexane; perfluorodecalin; hexafluoroethane; and/or perfluoromethylcyclohexane.

The first working fluid may exist in a vapor phase, a gas phase, a liquid phase, or both a gas phase and a liquid phase within the vapor chamber. The vapor chamber may comprise a closed-loop capillary recirculation system. The closed-loop capillary recirculation system may be a wick structure that is configured to transport the first working fluid through the vapor chamber while the first working fluid exists in a vapor phase, a liquid phase, and/or a gas phase.

The vapor chamber may have various shapes. The vapor chamber may be in the shape of a sphere, a cuboid, a rectangular prism, a cube, a triangular prism, an octagonal prism, a triangular pyramid, a tetrahedron, a square pyramid, a cylinder, a cone, a disc, or any partial shape or combination of shapes thereof. The vapor chamber may have a cross-section that is circular, triangular, square, rectangular, pentagonal, hexagonal, or any partial cross-section or combination of cross-sections thereof.

The vapor chamber may be in thermal contact with a source of thermal energy. The source of thermal energy may transmit thermal energy from the source of thermal energy to the vapor chamber, the heat pipe, the fin, the first working fluid, and/or the second working fluid. The source of thermal energy may include a circuit, a computer processor, a plurality of computer processors, a light source (e.g., a lamp, such as an incandescent lamp, a halogen lamp, a carbon arc lamp, or a discharge lamp), a torch, a laser, a heater, a furnace (e.g., an induction furnace, an electric arc furnace, a gas-fired furnace, a plasma arc furnace, a microwave furnace, or an electric resistance furnace), or a hot fluid (e.g., superheated steam). The source of thermal energy may be an object (e.g., a mechanical component, a mechanical structure, and/or a surface of a mechanical component or a mechanical structure) that is in thermal contact with a hot object, such as a circuit, a computer processor, a plurality of computer processors, a light source (e.g., a lamp, such as an incandescent lamp, a halogen lamp, a carbon arc lamp, or a discharge lamp), a torch, a laser, a heater, a furnace (e.g., an induction furnace, an electric arc furnace, a gas-fired furnace, a plasma arc furnace, a microwave furnace, or an electric resistance furnace), or an open flame. The source of thermal energy may include an electronic component (e.g., a circuit board, a computer processor(s), a graphics processing unit, or an application-specific integrated circuit) and/or an object (e.g., a mechanical component, a mechanical structure, and/or a surface of a mechanical component or a mechanical structure) that is in thermal communication with the electronic component such that the object is capable of absorbing and transmitting at least a portion of the thermal energy generated by the electronic component.

The source of thermal energy may generate thermal energy by combustion. In an example, a hydrocarbon (e.g., methane) may be combined with oxygen and subjected to an oxidation reaction (e.g., a combustion reaction) to generate carbon monoxide and/or carbon dioxide, water, and thermal energy.

The source of thermal energy may generate thermal energy by resistive heating. Resistive heating may include heating achieved by passing an electrical current through an electrically resistive material. The electrically resistive material may be a conducting material with a resistance property that may impede the movement of electrons through the material and/or cause electrons to collide with each other, thereby generating thermal energy. The source of thermal energy may generate thermal energy through inductive heating. Inductive heating may involve the use of electromagnetic induction to generate electrical currents inside a conducting material. The electrical currents may flow through the conducting material and generate thermal energy by resistive heating.

The source of thermal energy may generate thermal energy through dielectric heating. Dielectric heating may involve the use of radio wave or microwave electromagnetic radiation to cause the rotation of molecules within a material.

The thermal energy generated by the source of thermal energy may be transferred from the source of thermal energy to the vapor chamber, the heat pipe, the fin, the first working fluid, and/or the second working fluid using one or more heat transfer mechanisms. The one or more heat transfer mechanisms may include advection, conduction, convection, radiation, and/or any combination thereof. Advection may involve the transfer of heat by the flow of a fluid. Conduction may involve the transfer of heat when vibrating atoms and molecules adjacent to one another interact with nearby atoms and molecules and transfer heat and/or kinetic energy to the nearby atoms and molecules. Convection may involve the transfer of heat by a movement of a working fluid. In some cases, convection may involve the transfer of heat by buoyancy forces caused when thermal energy expands a working fluid. In other cases, convection may involve the transfer of heat by diffusion. Alternatively, convection may involve forced convection whereby a working fluid is forced to flow by a source of thermal energy using a pump and/or a fan. Radiation may involve the transfer of energy through photons in electromagnetic waves.

The source of thermal energy may transfer thermal energy from the source of thermal energy to the vapor chamber, the heat pipe, the fin, the first working fluid and/or the second working fluid using one or more heat transfer mechanisms (e.g., advection, conduction, convection, and/or radiation). The source of thermal energy may transfer thermal energy from the source of thermal energy to a surface of the vapor chamber using any one or more heat transfer mechanisms disclosed herein. In such cases, the vapor chamber may be configured to facilitate a transfer of thermal energy from the source of thermal energy to the first working fluid using a surface of the vapor chamber. For example, the surface of the vapor chamber may absorb thermal energy from the source of thermal energy and then transfer the thermal energy from the surface of the vapor chamber to the first working fluid by conduction. The first working fluid changes states or phases from a liquid to a gas or vapor when the first working fluid absorbs thermal energy from the source of thermal energy and/or a surface of the vapor chamber. The first working fluid changes states or phases from a gas or vapor back to a liquid when the first working fluid transmits thermal energy from the first working fluid to a fin of the thermal management device or another working fluid (e.g., a second working fluid) in thermal contact with the thermal management device.

The thermal management device may comprise a heat pipe in fluid communication with the vapor chamber. The heat pipe may be a sealed pipe and/or a sealed tube with a hollow portion internal to the heat pipe. The hollow portion of the heat pipe may be in fluid communication with the vapor chamber. The heat pipe may be configured to contain a fluid (e.g., a first working fluid in a gas state or a liquid state). The first working fluid may transition from a liquid to a gas and may flow from the vapor chamber to the heat pipe after the first working fluid absorbs thermal energy from the source of thermal energy or a surface of the vapor chamber in thermal contact with the source of thermal energy.

The heat pipe may be configured to transport the fluid through a hollow portion of the heat pipe and/or direct the fluid back into the vapor chamber through a hollow portion of the heat pipe. The heat pipe may be configured to facilitate a transfer of thermal energy between a source of thermal energy and a working fluid (e.g., a second working fluid) using another working fluid (e.g., the first working fluid) that is contained within the heat pipe. The heat pipe may be configured to direct the first working fluid from the vapor chamber through the heat pipe and may facilitate a transfer of thermal energy from the first working fluid to a fin of the thermal management device or another working fluid (e.g., a second working fluid) in thermal contact with the thermal management device. The heat pipe may be in fluid communication with the vapor chamber such that the first working fluid may flow from the vapor chamber through the heat pipe. The first working fluid may flow from the vapor chamber to the heat pipe when the first working fluid absorbs thermal energy conducted from a surface of the vapor chamber to the first working fluid. At least a portion of the first working fluid may transition from a liquid state to a gas state (e.g., evaporate) when the first working fluid absorbs thermal energy conducted from a surface of the vapor chamber to the first working fluid. In such cases, the at least the portion of the first working fluid in the gas state may flow up from the vapor chamber and through the heat pipe as a vapor. In some cases, the at least the portion of the first working fluid in the gas state may transition from a gas state to a liquid state (e.g., condense) after the at least the portion of the first working fluid in the gas state transmits thermal energy from the at least the portion of the first working fluid in the gas state to a fin of the thermal management device or another working fluid (e.g., a second working fluid) in thermal contact with the thermal management device. In such cases, the at least the portion of the first working fluid in the gas state may transition from a gas state back to a liquid state and may flow through the heat pipe back down into the vapor chamber as a liquid. The heat pipe may be a constant conductance heat pipe, an annular heat pipe, a planar heat pipe, a variable conductance heat pipe, a pressure controlled heat pipe, a diode heat pipe, a thermosyphon, a rotating heat pipe, and/or a heat pipe loop.

The heat pipe may comprise a closed-loop capillary recirculation system. The closed-loop capillary recirculation system may be a wick structure that is configured to transport the first working fluid through the heat pipe back down to the vapor chamber while the first working fluid exists in a vapor phase, a liquid phase, and/or a gas phase.

The thermal management device may comprise a fin that is adjacent to and/or in thermal contact with a heat pipe of the thermal management device, a vapor chamber of the thermal management device, and/or a second working fluid. The fin may be a vertical structure that extends from a surface of the heat pipe and/or a surface of the vapor chamber. The fin may have a horizontal cross-section and/or a vertical cross-section that is circular, elliptical, teardrop-shaped, triangular, square, rectangular, pentagonal, hexagonal, or any partial cross-section or combination of cross-sections thereof. The fin may be a tube fin, a plate fin, a pin fin, or an annular fin.

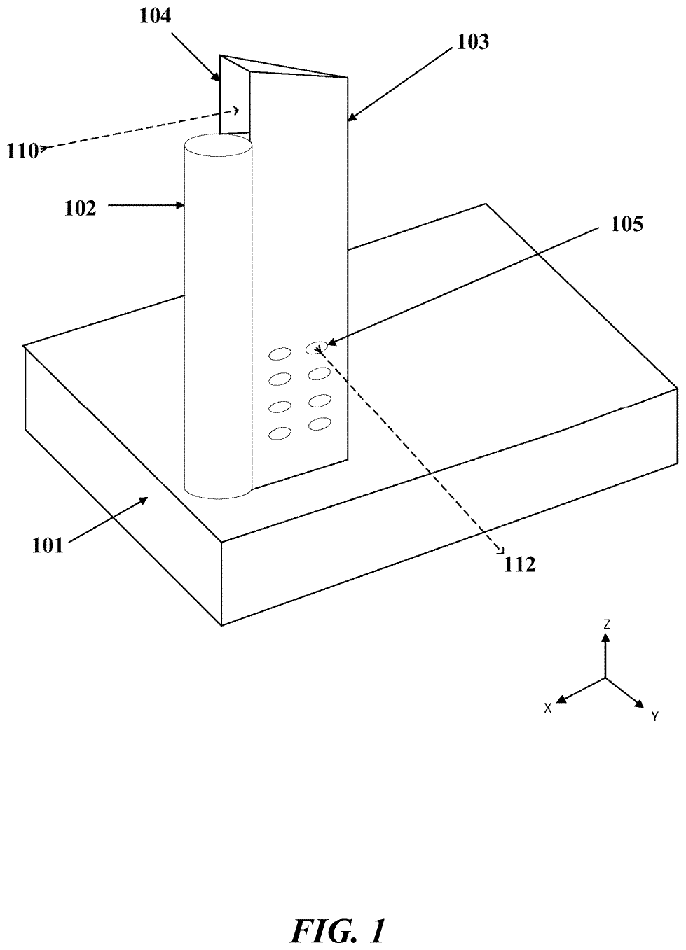

In an example, FIG. 1 schematically illustrates a thermal management device comprising a vapor chamber 101, a heat pipe 102, and a fin 103. The fin 103 may be adjacent to and in thermal contact with the heat pipe 102 and/or the vapor chamber 101. The illustrated fin 103 may comprise a vertical structure that extends from a surface of the heat pipe 102 and/or a surface of the vapor chamber 101. The vertical structure may have a horizontal cross-section (along an x-y plane) that is triangular. The fin 103 may be a tube fin, though as an alternative the fin 103 may be a plate fin, a pin fin, or an annular fin. The fin 103 may be configured to increase the rate of heat transfer between the fin 103 and the vapor chamber 101, the heat pipe 102, and/or a working fluid (e.g., a first working fluid and/or a second working fluid) by increasing an amount of surface area available to facilitate heat transfer between the fin 103 and the vapor chamber 101, the heat pipe 102, and/or the working fluid.

The fin 103 may be configured as an airfoil. A radial length of the airfoil may be a distance from the base of the airfoil (e.g., the surface of the vapor chamber 101) to a tip of the airfoil (e.g., an uppermost surface of the fin 103). The radial length may be at least about 0.1 millimeter (mm), 1 mm, 10 mm, 20 mm, 30 mm, 40 mm, 50 mm, 10 cm, 100 cm, 1 meter (m), 10 m, 100 m, or greater. In some cases, the radial length may be at most about 100 m, 10 m, 1 m, 100 cm, 10 cm, 50 mm, 40 mm, 30 mm, 20 mm, 10 mm, 1 mm, 0.1 mm, or less.

In some examples, the airfoil may have a shape that incorporates one or more geometric features of a National Advisory Committee for Aeronautics (NACA) airfoil. The NACA airfoil may be, for example, a NACA 0006 airfoil, a NACA 0008 airfoil, a NACA 0009 airfoil, a NACA 0010 airfoil, a NACA 0012 airfoil, a NACA 0015 airfoil, a NACA 0018 airfoil, a NACA 0021 airfoil, a NACA 0024 airfoil, a NACA 1408 airfoil, a NACA 1410 airfoil, a NACA 1412 airfoil, a NACA 2408 airfoil, a NACA 2410 airfoil, a NACA 2411 airfoil, a NACA 2412 airfoil, a NACA 2414 airfoil, a NACA 2415 airfoil, a NACA 2418 airfoil, a NACA 2421 airfoil, a NACA 2424 airfoil, a NACA 4412 airfoil, a NACA 4415 airfoil, a NACA 4418 airfoil, a NACA 4421 airfoil, a NACA 4424 airfoil, a NACA 6409 airfoil, and/or a NACA 6412 airfoil. The fin may have one or more horizontal cross-sections in the shape of one or more distinctly shaped airfoils. In any of the embodiments described herein, the shape of the airfoil may be configured to allow a working fluid (e.g., a second working fluid) to flow along one or more surfaces of the fin (e.g., the leading edge of the airfoil and/or the trailing edge of the airfoil) with reduced flow resistance, thereby enhancing the amount of heat transfer between the fin and the working fluid.

The fin may be adjacent to and/or in thermal contact with one or more heat pipes. In such cases, the fin and the one or more heat pipes adjacent to and/or in thermal contact with the fin may be collectively configured as an airfoil. Alternatively, one or more fins may be adjacent to and/or in thermal contact with one or more heat pipes. In such cases, the one or more fins and the one or more heat pipes adjacent to and/or in thermal contact with the one or more fins may be collectively configured as an airfoil.

The fin may be hollow such that another working fluid (e.g., a second working fluid) may flow through an inner portion or volume of the fin. For example, the fin may comprise a fluid flow path in fluid communication with a first opening on the fin and a second opening on the fin. The first opening may be a hole, a perforation, or any portion of the fin or a surface of the fin through which a working fluid may flow in or out. The second opening may be a hole, a perforation, or any portion of the fin or a surface of the fin through which a working fluid may flow in or out. The first opening may be in the shape of a circle, a square, a rectangle, a triangle, a pentagon, a hexagon, a heptagon, an octagon, a nonagon, a decagon, or any polygon with at least three or more sides. The second opening may be in the shape of a circle, a square, a rectangle, a triangle, a pentagon, a hexagon, a heptagon, an octagon, a nonagon, a decagon, or any polygon with at least three or more sides. The first opening may be located on any portion of the fin, any portion of a front, back, top, bottom, and/or lateral surface of the fin, or any portion of a structural component (e.g., a wall) of the fin. The second opening may be located on any portion of the fin, any portion of a front, back, top, bottom, and/or lateral surface of the fin, or any portion of a structural component (e.g., a wall) of the fin. The fluid flow path may be configured to direct a second working fluid from the first opening to the second opening. The fluid flow path may be configured to direct a second working fluid to flow along a first direction of flow towards the fin and into the fin through the first opening, flow through the fin to the second opening, and flow out of the fin through the second opening along a second direction of flow that is different than the first direction of flow. The fluid flow path may be configured to increase an amount of surface area of the fin in contact with the second working fluid, thereby enhancing the amount of heat transfer between the fin and the second working fluid. The fluid flow path may be configured such that the second working fluid generates turbulence when the second working fluid flows along the fluid flow path through the fin. The turbulence generated by the second working fluid as the second working fluid flows along the fluid flow path through the fin may increase the amount of thermal energy exchanged between the second working fluid and one or more internal surfaces of the fin and/or a rate at which thermal energy may be exchanged between the second working fluid and one or more internal surfaces of the fin.

The second working fluid may be a gas and/or liquid that is capable of absorbing or transmitting thermal energy. The second working fluid may be air, water, ammonia, methanol, ethanol, hydrogen, helium, propane, butane, isobutane, ammonia, sulfur dioxide and/or any combination thereof. The second working fluid may include one or more chlorofluorocarbons, one or more hydrochlorofluorocarbons, one or more hydrofluorocarbons, and/or one or more fluorocarbons. For example, the second working fluid may be trichlorofluoromethane; dichlorodifluoromethane; difluoromethane; pentafluoroethane; chlorotrifluoromethane; chlorodifluoromethane; dichlorofluoromethane; chlorofluoromethane; bromochlorodifluoromethane; 1,1,2-trichloro-1,2,2-trifluoroethane; 1,1,1-trichloro-2,2,2-trifluoroethane; 1,2-dichloro-1,1,2,2-tetrafluoroethane; 1-chloro-1,1,2,2,2-pentafluoroethane; 2-chloro-1,1,1,2-tetrafluoroethane; 1,1-dichloro-1-fluoroethane; 1-chloro-1,1-difluoroethane; tetrachloro-1,2-difluoroethane; tetrachloro-1,1-difluoroethane; 1,1,2-trichlorotrifluoroethane; 1-bromo-2-chloro-1,1,2-trifluoroethane; 2-bromo-2-chloro-1,1,1-trifluoroethane; 1,1-dichloro-2,2,3,3,3-pentafluoropropane; or 1,3-dichloro-1,2,2,3,3-pentafluoropropane. The second working fluid may be trifluoromethane (HFC-23); difluoromethane (HFC-32); fluoromethane (HFC-41); 2-chloro-1,1,1,2-tetrafluoroethane (HFC-124); 1,1,2,2,2-pentafluoroethane (HFC-125); 1,1,2,2-tetraflu-oroethane (HFC-134); 1,1,1,2-tetrafluoroethane (HFC-134a,); 1,1-difluoroethane (HFC-152a); or 1,1,1,2,3,3,3-heptafluoropropane (HFC-227ea). The second working fluid may be carbon tetrafluoride; perfluorooctane; perfluoro-2-methylpentane; perfluoro-1,3-dimethylcyclohexane; perfluorodecalin; hexafluoroethane; or perfluoromethylcyclohexane. The second working fluid may exist in a vapor phase, a gas phase, a liquid phase, or both a gas phase and a liquid phase. The second working fluid may be a different working fluid than the first working fluid. The second working fluid may not be contained within the vapor chamber and/or heat pipe of the thermal management device. In some cases, a fluid transport mechanism located external to the thermal management device may be configured to direct the second working fluid to flow towards the fin and/or through the fin. The fluid transport mechanism may comprise a fan, a pump, and/or a propeller.

Referring to FIG. 1, the fin 103 may have a first opening 104 and a second opening 105. The first opening 104 on the fin 103 may be oriented along a first direction of flow 110 of a second working fluid towards the fin 103. The first opening 104 may be located on an upper portion or an upper surface of the fin 103 and may extend from an upper surface of the heat pipe 102 to a top portion or a top surface of the fin 103. The second opening 105 on the fin 103 may be oriented along a second direction of flow 112 that is different than the first direction of flow 110. For example, the second opening 105 may be oriented along a second direction of flow 112 that is at an angle greater than 0 degrees and less than or equal to 90 degrees relative to the first direction of flow 110. The angle between the first direction of flow 110 and the second direction of flow 112 may be at least about 1 degree, 2 degrees, 3 degrees, 4 degrees, 5 degrees, 6 degrees, 7 degrees, 8 degrees, 9 degrees 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, or more. The angle between the first direction of flow 110 and the second direction of flow 112 may be greater than 90 degrees and less than or equal to 180 degrees. In such cases, the angle between the first direction of flow 110 and the second direction of flow 112 may be at least about 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees, 160 degrees, 165 degrees, 170 degrees, 175 degrees, 180 degrees, or more. The second opening 105 may be located on a front surface, a back surface, a top surface, a bottom surface, or a lateral surface of the fin 103. As shown in FIG. 1, the second opening 105 may be disposed on a lateral surface of the fin 103. The fin 103 may comprise a plurality of second openings comprising the second opening 105. In such cases, a fluid flow path may be configured to direct the second working fluid to flow along a first direction of flow 110 towards the fin 103 and into the fin 103 through the first opening 104, flow through the fin 103 to the plurality of second openings comprising the second opening 105, and flow out of the fin 103 through the plurality of second openings along a second direction of flow 112 that is different than the first direction of flow 110. The second working fluid may generate turbulence when flowing out of the fin 103 through the plurality of second openings along a second direction of flow 112 that is different than the first direction of flow 110. The turbulence created by the flow of the second working fluid may increase thermal transport between one or more surfaces of the fin 103 and the second working fluid.

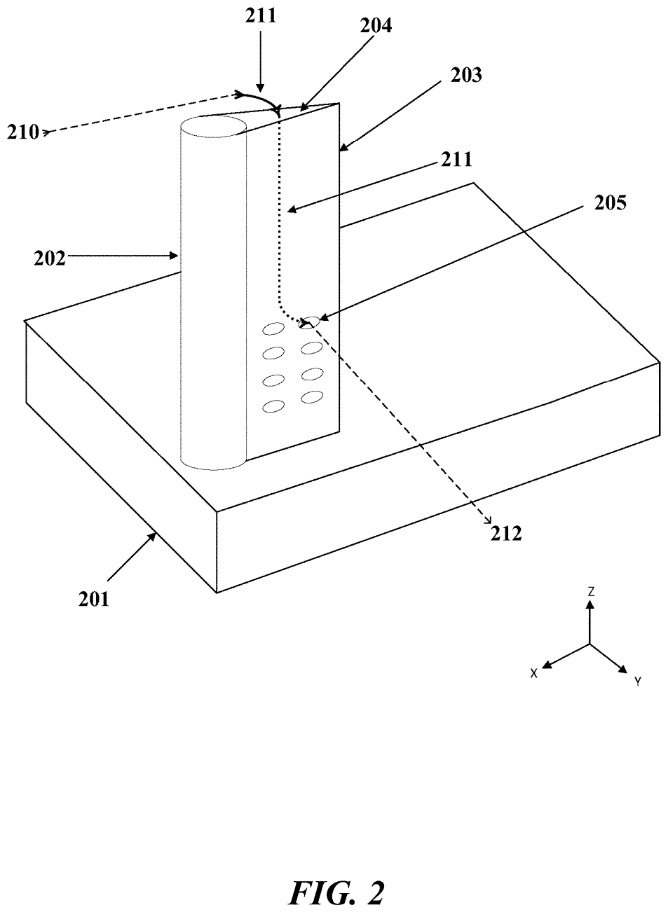

FIG. 2 illustrates an example of a thermal management device comprising a vapor chamber 201, a heat pipe 202, and a fin 203. The fin 203 may have a first opening 204 and a second opening 205. The fin 203 may have a plurality of second openings comprising the second opening 205. A second working fluid may flow along a first direction of flow 210 towards the fin 203. A fluid flow path 211 may be configured to direct a second working fluid that is flowing along a first direction of flow 210 to flow towards the fin 203, flow into the fin 203 through the first opening 204, flow through the fin 203 to a plurality of second openings comprising the second opening 205, and flow out of the fin 203 through the plurality of second openings along a second direction of flow 212 that is different than the first direction of flow 210. As illustrated in FIG. 2, the fluid flow path 211 may be configured to direct the second working fluid to flow internally through a hollow section of the fin 203 before flowing out of the fin 203 through the plurality of second openings comprising the second opening 205.

The thermal management device may comprise an array of fins and an array of heat pipes. The array of fins may comprise the fin. The array of heat pipes may comprise the heat pipe. The array of fins may comprise at least 1 fin, 2 fins, 3 fins, 4 fins, 5 fins, 6 fins, 7 fins, 8 fins, 9 fins, 10 fins, 11 fins, 12 fins, 13 fins, 14 fins, 15 fins, 16 fins, 17 fins, 18 fins, 19 fins, 20 fins, 25 fin, 50 fins, 100 fins, 200 fins, 300 fins, 400 fins, 500 fins, 1000 fins, 2000 fins, or more. The array of fins may comprise at most 2000 fins, 1000 fins, 500 fins, 400 fins, 300 fins, 200 fins, 100 fins, 50 fins, 25 fins, 20 fins, 19 fins, 18 fins, 17 fins, 16 fins, 15 fins, 14 fins, 13 fins, 12 fins, 11 fins, 10 fins, 9 fins, 8 fins, 7 fins, 6 fins, 5 fins, 4 fins, 3 fins, 2 fins, or 1 fin. The array of heat pipes may comprise at least 1 heat pipe, 2 heat pipes, 3 heat pipes, 4 heat pipes, 5 heat pipes, 6 heat pipes, 7 heat pipes, 8 heat pipes, 9 heat pipes, 10 heat pipes, 11 heat pipes, 12 heat pipes, 13 heat pipes, 14 heat pipes, 15 heat pipes, 16 heat pipes, 17 heat pipes, 18 heat pipes, 19 heat pipes, 20 heat pipes, 25 heat pipes, 50 heat pipes, 100 heat pipes, 200 heat pipes, 300 heat pipes, 400 heat pipes, 500 heat pipes, 1000 heat pipes, 2000 heat pipes, or more. The array of heat pipes may comprise at most 2000 heat pipes, 1000 heat pipes, 500 heat pipes, 400 heat pipes, 300 heat pipes, 200 heat pipes, 100 heat pipes, 50 heat pipes, 25 heat pipes, 20 heat pipes, 19 heat pipes, 18 heat pipes, 17 heat pipes, 16 heat pipes, 15 heat pipes, 14 heat pipes, 13 heat pipes, 12 heat pipes, 11 heat pipes, 10 heat pipes, 9 heat pipes, 8 heat pipes, 7 heat pipes, 6 heat pipes, 5 heat pipes, 4 heat pipes, 3 heat pipes, 2 heat pipes, or 1 heat pipe. The array of fins and the array of heat pipes may be in thermal contact with the vapor chamber. The array of fins may comprise one or more fins configured as an airfoil.

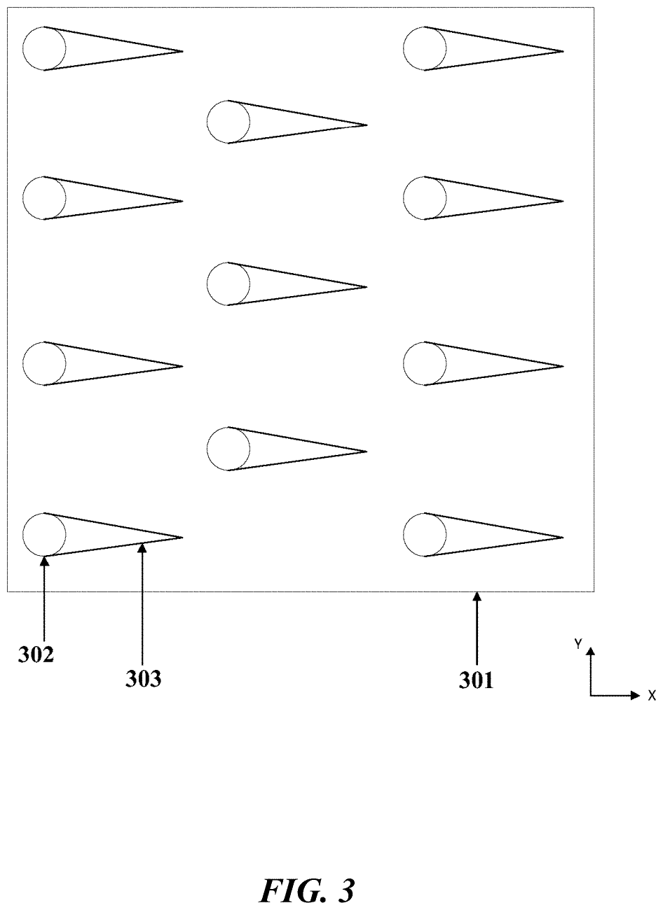

Each fin of the array of fins may be adjacent to and in thermal contact with a heat pipe of the array of heat pipes. For example, as illustrated in FIG. 3, the thermal management device may comprise a vapor chamber 301, an array of heat pipes comprising a heat pipe 302, and an array of fins comprising a fin 303. Each heat pipe 302 may be adjacent to and in thermal contact with a corresponding fin 303. Each respective heat pipe 302 and each corresponding fin 303 that is adjacent to and in thermal contact with the heat pipe 302 may be collectively configured as an airfoil. In some cases, a fin 303 of the array of fins may be adjacent to and in thermal contact with two or more heat pipes of the array of heat pipes. In such cases, the fin 303 and the two or more heat pipes adjacent to and in thermal contact with the fin 303 may be collectively configured as an airfoil. In other cases, a heat pipe 302 of the array of heat pipes may be adjacent to and in thermal contact with two or more fins of the array of fins. In such cases, the heat pipe 302 and the two or more fins adjacent to and in thermal contact with the heat pipe 302 may be collectively configured as an airfoil.

As illustrated in FIG. 3, each fin 303 of the array of fins may be in thermal contact with a heat pipe 302 of the array of heat pipes. The array of fins and the array of heat pipes may extend vertically upwards from a surface of the vapor chamber 301. The array of fins and the array of heat pipes in thermal contact with the array of fins may have a staggered arrangement, as shown in greater detail in FIG. 3. The staggered arrangement may involve a spatial arrangement of at least a subset of the one or more fins 303 of the array of fins in one or more rows and/or columns. The staggered arrangement may involve a spatial arrangement of at least a subset of the one or more heat pipes 302 of the array of heat pipes in one or more rows and/or columns.

The staggered arrangement of the array of heat pipes and/or the array of fins may be configured such that a fluid flow path of a working fluid to one heat pipe and/or fin in a first column of heat pipes and/or fins is not obstructed by another heat pipe and/or another fin in a second column of heat pipes and/or fins that is positioned in front of the first column of heat pipes and/or fins. The staggered arrangement may allow a working fluid (e.g., a second working fluid) to efficiently flow through the array of fins and the array of heat pipes, thereby enhancing the rate of heat transfer between the array of fins and the second working fluid and/or between the array of heat pipes and the second working fluid. For example, the staggered arrangement may allow a working fluid (e.g., a second working fluid) to flow through the array of fins and the array of heat pipes with thermal exposure to one or more surfaces of each fin of the array of fins and one or more surfaces of each heat pipe of the array of heat pipes, thereby enhancing the amount of heat transfer between the array of fins and the second working fluid and/or between the array of heat pipes and the second working fluid. Thermal exposure may involve thermal contact that facilitates a transfer of thermal energy between the array of fins and the second working fluid and/or between the array of heat pipes and the second working fluid, through one or more heat transfer mechanisms.

The staggered arrangement may comprise one or more rows comprising one or more fins and one or more heat pipes adjacent to and in thermal contact with the one or more fins. Each fin in each of the one or more rows may be separated from another fin in the same respective row by a fin separation distance. The fin separation distance between the one or more fins in the row may be the same. Alternatively, the fin separation distance between the one or more fins in the row may be different. For example, the fin separation distance between a first fin and a second fin in a row may be different than the fin separation distance between a third fin and fourth fin in the same row. A fin in a row of fins may be positioned slightly higher or slightly lower in the Y-direction relative to another fin in the row of fins. The one or more rows may be separated from each other by a row separation distance. The row separation distances between each of the rows in a staggered arrangement may be the same. Alternatively, the row separation distances between each of the rows in a staggered arrangement may be different. For example, the row separation distance between a first row and a second row in a staggered arrangement may be different than the row separation distance between a third row and a fourth row in the staggered arrangement. In some cases, a row in the staggered arrangement may be slightly offset (e.g., positioned slightly to the left or slightly to the right) in the X-direction relative to another row in the staggered arrangement.

The staggered arrangement may comprise one or more columns comprising one or more fins and/or one or more heat pipes adjacent to and in thermal contact with the one or more fins. Each fin in each of the one or more columns may be separated from another fin in the same respective column by a fin separation distance. The fin separation distance between the one or more fins in the column may be the same. Alternatively, the fin separation distance between the one or more fins in the column may be different. For example, the fin separation distance between a first fin and a second fin in a column may be different than the fin separation distance between a third fin and fourth fin in the same column. In some cases, a fin in a column of fins may be slightly offset (e.g., positioned slightly to the left or slightly to the right) in the X-direction relative to another fin in the column of fins. The one or more columns may be separated from each other by a column separation distance. The column separation distances between each of the columns in a staggered arrangement may be the same. Alternatively, the column separation distances between each of the columns in a staggered arrangement may be different. For example, the column separation distance between a first column and a second column in a staggered arrangement may be different than the column separation distance between a third column and a fourth column in the staggered arrangement. In some cases, a column in the staggered arrangement may be positioned slightly higher or slightly lower in the Y-direction relative to another column in the staggered arrangement.

The staggered arrangement may comprise one or more fins adjacent to and in thermal contact with one or more heat pipes. The one or more fins and the one or more heat pipes adjacent to and in thermal contact with one or more heat pipes may be collectively configured as airfoils. Each airfoil comprising the one or more fins and the one or more heat pipes may have a different angle of attack. An angle of attack may be an angle between a reference line on the airfoil (e.g., the chord length) and a vector (e.g., a first direction of flow) representing the relative motion of a fluid (e.g., a second working fluid) across one or more surfaces of the airfoil. The angle of attack for an airfoil may range from 0 degrees to 90 degrees. The angle of attack for an airfoil may be at least about 0 degrees, 5 degrees, 10 degrees, 15 degrees, 20 degrees, 25 degrees, 30 degrees, 35 degrees, 40 degrees, 45 degrees, 50 degrees, 60 degrees, 70 degrees, 80 degrees, or 90 degrees. Alternatively, the angle of attack for an airfoil may be at most about 90 degrees, 80 degrees, 70 degrees, 60 degrees, 50 degrees, 45 degrees, 40 degrees, 35 degrees, 30 degrees, 25 degrees, 20 degrees, 15 degrees, 10 degrees, 5 degrees or less (e.g., 1 degree or 0 degrees).

The angle of attack for each airfoil in the staggered array may be different. Alternatively, the angle of attack for each airfoil in the staggered array may be substantially similar.

The staggered arrangement may comprise one or more fins adjacent to and in thermal contact with one or more heat pipes. The one or more fins and the one or more heat pipes adjacent to and in thermal contact with one or more heat pipes may be collectively configured as airfoils. In such cases, each airfoil comprising the one or more fins and the one or more heat pipes may have a different chord length and/or a different radial length. A chord length of the airfoil may be the distance between a leading edge of the airfoil and a trailing edge of the airfoil. A radial length of the airfoil may be a distance from the base of the airfoil (e.g., the surface of the vapor chamber) to a tip of the airfoil (e.g., an uppermost surface of the fin). Each airfoil comprising the one or more fins and the one or more heat pipes may have a different thickness profile. A thickness profile may be defined by a variation of the thickness of the airfoil along the X-direction (e.g., from the leading edge of the airfoil to the trailing edge of the airfoil). A thickness profile may be defined by a rate of change of the thickness of the airfoil along the X-direction (e.g., from the leading edge of the airfoil to the trailing edge of the airfoil).

The staggered arrangement may comprise one or more fins adjacent to and in thermal contact with one or more heat pipes. The one or more fins and the one or more heat pipes adjacent to and in thermal contact with one or more heat pipes may be collectively configured as airfoils. In such cases, each airfoil comprising the one or more fins and the one or more heat pipes may have one or more distinct shape profiles. A shape profile of an airfoil may be a shape that is defined by a variation of the chord length, the thickness, and/or the angle of attack of an airfoil as a function of the radial length of the airfoil. The shape profile for an airfoil in the staggered arrangement may be different than the shape profile for another airfoil in the staggered arrangement. For example, the chord length, the thickness, and/or the angle of attack for a first airfoil may vary along the extent of the radial length of the first airfoil according to a first function. The chord length, the thickness, and/or the angle of attack for a second airfoil may vary along the extent of the radial length of the second airfoil according to a second function that is different than the first function.

The source of thermal energy may be in thermal contact with a vapor chamber of the thermal management device. The vapor chamber may be in thermal contact with an array of heat pipes comprising one or more heat pipes and an array of fins comprising one or more fins. The vapor chamber may be in fluid communication with the array of heat pipes and/or the array of fins. The array of fins may be in thermal contact with the array of heat pipes.

The source of thermal energy may transfer thermal energy to a surface of the vapor chamber by conduction. The surface of the vapor chamber may facilitate a transfer of the thermal energy from the source of thermal energy to the first working fluid in the vapor chamber, the array of heat pipes, the array of fins, and/or the second working fluid.

Upon a transfer of thermal energy from the source of thermal energy to the first working fluid in the vapor chamber, the first working fluid may absorb the thermal energy conducted through the surface of the vapor chamber to the first working fluid. Subsequently, at least a portion of the first working fluid may transition from a liquid state to a gas state (e.g., evaporate). In such cases, the at least the portion of the first working fluid in the gas state may flow up from the vapor chamber and through the one or more heat pipes as a vapor.

The one or more heat pipes may be in thermal contact with the second working fluid. The second working fluid may flow past the one or more heat pipes and/or the one or more fins of the thermal management device. The first working fluid in the gas state may transfer thermal energy from the first working fluid to one or more surfaces of the one or more heat pipes and/or one or more surfaces of the one or more fins. The one or more surfaces of the one or more heat pipes and/or the one or more fins may facilitate a transfer of thermal energy from the first working fluid to the second working fluid. The second working fluid may absorb the thermal energy transferred from the first working fluid in the gas state to the one or more surfaces of the one or more heat pipes and/or the one or more fins which may be in thermal contact with the second working fluid. The at least the portion of the first working fluid in the gas state may transition from a gas state to a liquid state (e.g., condense) after the at least the portion of the first working fluid in the gas state transmits thermal energy from the at least the portion of the first working fluid in the gas state to the one or more surfaces of the one or more heat pipes and/or the one or more fins, or to another working fluid (e.g., a second working fluid) in thermal contact with the one or more heat pipes and/or the one or more fins. In such cases, the at least the portion of the first working fluid in the gas state may transition from a gas state back to a liquid state and may flow through the one or more heat pipes back down into the vapor chamber as a liquid.

The one or more heat pipes may be in thermal contact with one or more fins. The first working fluid in the gas state may transfer thermal energy from the first working fluid to one or more surfaces of the one or more heat pipes. The one or more surfaces of the one or more heat pipes may facilitate a transfer of thermal energy from the first working fluid to the one or more fins of the thermal management device. A second working fluid may flow along a fluid flow path that is in fluid communication with a first opening on the one or more fins and a second opening on the one or more fins. The fluid flow path may be configured to direct the second working fluid from the first openings on the one or more fins to the second openings on the one or more fins. For example, the fluid flow path may be configured to direct the second working fluid to flow along a first direction of flow towards the one or more fins, flow into the one or more fins through the first openings, flow through the one or more fins to the second openings, and flow out of the one or more fins through the second openings along a second direction of flow. The second direction of flow may be different than the first direction of flow. The one or more surfaces of the one or more heat pipes may facilitate a transfer of thermal energy from the first working fluid to the one or more fins. The one or more fins may facilitate a transfer of thermal energy from the one or more heat pipes and/or the first working fluid to the second working fluid flowing past and/or through the one or more fins. The second working fluid may absorb the thermal energy transferred from the first working fluid in the gas state to the surfaces of the one or more heat pipes and to the one or more fins, which may be in thermal contact with the second working fluid. The at least the portion of the first working fluid in the gas state may transition from a gas state to a liquid state (e.g., condense) after the at least the portion of the first working fluid in the gas state transmits thermal energy from the at least the portion of the first working fluid in the gas state to the one or more fins or to another working fluid (e.g., a second working fluid) in thermal contact with the one or more fins. In such cases, the at least the portion of the first working fluid in the gas state may transition from a gas state back to a liquid state and may flow through the one or more heat pipes back down into the vapor chamber as a liquid.

The source of thermal energy may transfer thermal energy from the source of thermal energy to a surface of the vapor chamber by conduction. The surface of the vapor chamber may facilitate a transfer of the thermal energy from the source of thermal energy to the array of heat pipes and/or the array of fins. The array of heat pipes and the array of fins may be in thermal contact with the second working fluid. The second working fluid may be configured to absorb the thermal energy transferred from the source of thermal energy to the one or more fins and/or the one or more heat pipes. The transfer of thermal energy from the one or more fins to the second working fluid may occur by advection, conduction, convection, and/or radiation. The transfer of thermal energy from the one or more heat pipes to the second working fluid may occur by advection, conduction, convection, and/or radiation.

### Methods for Forming Thermal Management Devices

The present disclosure provides systems and methods for forming a thermal management device or system. The thermal management device or system may be fabricated using one or more additive manufacturing techniques, such as one or more three-dimensional (3D) printing techniques.

Additive manufacturing techniques may include vat photopolymerization, powder bed fusion, material extrusion, material jetting, binder jetting, and/or direct energy deposition. Additive manufacturing techniques may include one or more three-dimensional (3D) printing techniques. A 3D printing technique may include direct light processing (DLP), continuous direct light processing (CDLP), stereolithography (SLA), fused deposition modeling (FDM), fused filament fabrication (FFF), selective laser sintering (SLS), material jetting (MJ), nano particle jetting (NPJ), drop on demand (DOD), binder jetting, direct metal laser sintering (DMLS), selective laser melting (SLM), electron beam melting (EBM), multi jet fusion (MJF), direct energy deposition (DED), laser engineered net shaping, and/or electron beam additive manufacturing.

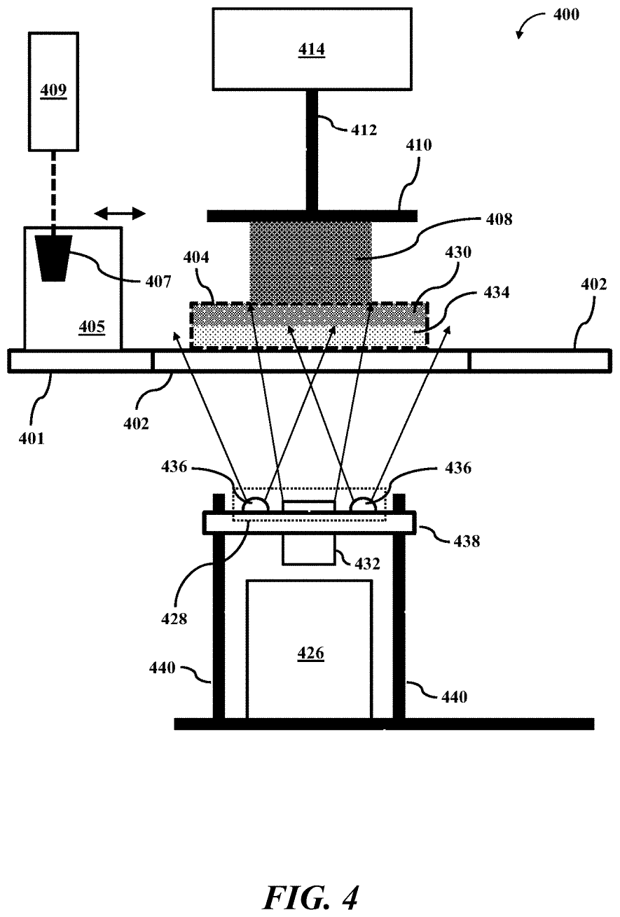

In an example, stereolithography (SLA) may be used to print the thermal management devices illustrated in FIGS. 1-3. Printing of the thermal management devices may be performed using a three-dimensional (3D) printing system, such as the 3D printing system of FIG. 4.

FIG. 4 illustrates an example of a three-dimensional (3D) printing system 400 which may be used to print the thermal management devices of the present disclosure. The three-dimensional (3D) printing system 400 may include an open platform 401 comprising a print window 402 to hold a film of a viscous liquid 404, which may include a photoactive resin. The open platform 401 may be a vat or a container configured to retain at least a portion of the viscous liquid. Alternatively, the open platform 401 may not be a vat or a container. For example, the open platform 401 may be a substrate or slab that does not have a depression (e.g., vat or container) for retaining a viscous liquid 404. The viscous liquid 404 may be sufficiently viscous such that the viscous liquid 404 remains on the open platform 401.

The 3D printing system 400 may be configured to use the viscous liquid 404 to generate a green part corresponding to the thermal management device. A green part may be a part that holds a plurality of particles together before the plurality of particles are fused together (e.g., through sintering) to create a 3D object (e.g., the thermal management device) comprising the plurality of particles. The green part may not be the final 3D object (i.e., further processing may be needed to generate the thermal management device from the green part or a derivative of the green part). A green part may correspond to a thermal management device that is printed using any of the 3D printing methods disclosed herein. A green part may correspond to the shape and/or size of the thermal management device or may correspond to the shape and/or size of a portion of the thermal management device. The green part may have the same shape and/or dimensions as the thermal management device. The green part may have a similar shape to the thermal management device and dimensions that are proportional to the dimensions of the thermal management device. In some examples, the green part may correspond to the shape and/or size of the thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. In other examples, the green part may correspond to the shape and/or size of a thermal management device with an array of heat pipes and/or an array of fins adjacent to and in thermal contact with the array of heat pipes.

The green part may comprise a polymeric material and a plurality of particles (e.g., metal, ceramic, or both) that are encapsulated by the polymeric material. The polymeric material may be a polymer (or polymeric) matrix. The polymeric material may be created by polymerizing monomers into the polymeric material and/or cross-linking oligomers into the polymeric material, as described in further detail elsewhere herein. The plurality of particles may be encapsulated in the polymer (or polymeric) matrix. The plurality of particles may be capable of sintering or melting. The green part may be self-supporting. The green part may be heated in a heater (e.g., in a furnace) to burn off and/or vaporize at least a portion of the polymeric material and to coalesce the plurality of particles into the thermal management device or into at least a portion of the thermal management device.

The thermal management device and/or a green part corresponding to the thermal management device may be fabricated using at least one viscous liquid. The at least one viscous liquid may be a resin. A resin may be a viscous liquid that is usable to print a 3D object. The resin may include a photoactive resin. The photoactive resin may include a polymeric precursor and at least one photoinitiator. A polymeric precursor may be a polymerizable and/or cross-linkable component, such as a monomer, for example. A photoinitiator may be a compound that activates curing of the polymerizable and/or cross-linkable component, thereby subjecting the polymerizable and/or cross-linkable component to polymerization and/or cross-linking. Polymerization may be a process of reacting monomers together to form one or more chains of polymers. Polymerization may include step-growth polymerization, chain-growth polymerization, or photopolymerization. Step-growth polymerization may involve reactions between monomers with one or more functional groups to form polymer chains. Chain-growth polymerization may involve reactions between one or monomers and an initiator to add monomer molecules onto one or more active sites of a polymer chain. An initiator may be a compound that reacts with monomers to form an intermediate compound. The intermediate compound may be capable of linking one or more monomers into a polymer chain. Photopolymerization may be a chain-growth polymerization initiated by the absorption of visible or ultraviolet light. Cross-linking may be a process of joining two or more polymer chains together by using a chemical reaction to form covalent bonds between two or more polymer chains.

The resin may include a plurality of particles (e.g., metal particles, non-metal particles, or both). The resin may be a paste, a slurry, or a photopolymer slurry. The plurality of particles may be added to the resin. The plurality of particles may be solids or semi-solids (e.g., gels). The plurality of particles may be suspended throughout the resin. The plurality of particles in the resin may have a distribution that is monodisperse or polydisperse. The resin may contain additional optical absorbers and/or non-photoreactive components (e.g., fillers, binders, plasticizers, etc.). The 3D printing methods disclosed herein may be performed with at least 1, 2, 3, 4, 5, 6, 7, 8, 9, 10 or more resins. A plurality of resins comprising different materials (e.g., a different photoactive resin and/or a different plurality of particles) may be used for printing a multi-material 3D object.

The resin used to fabricate the thermal management device may include a plurality of particles (e.g., metallic, intermetallic, ceramic, and/or polymeric particles). The plurality of particles may be used to fabricate the thermal management device and/or a green part corresponding to the thermal management device or a portion of the thermal management device. The thermal management devices disclosed herein may be fabricated using the plurality of particles. The plurality of particles may comprise inorganic materials and/or organic materials. The inorganic materials may be a metallic material, an intermetallic material, a ceramic material, a composite material, or any combination thereof. The organic materials may comprise one or more polymers.

The resin used to fabricate the thermal management device may comprise a metallic material. The metallic material may comprise one or more elements selected from the group consisting of aluminum, platinum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, and gold.

The resin used to fabricate the thermal management device may comprise an intermetallic material. The intermetallic material may be a solid-state compound exhibiting metallic bonding, defined stoichiometry and ordered crystal structure (i.e., alloys). The intermetallic material may be in a prealloyed powder form. Examples of such prealloyed powders may include, but are not limited to, brass (copper and zinc), bronze (copper and tin), duralumin (aluminum, copper, manganese, and/or magnesium), gold alloys (gold and copper), rose-gold alloys (gold, copper, and zinc), nichrome (nickel and chromium), and/or stainless steel (iron, carbon, and additional elements including manganese, nickel, chromium, molybdenum, boron, titanium, silicon, vanadium, tungsten, cobalt, and/or niobium). The prealloyed powders may include superalloys. The superalloys may comprise iron, nickel, cobalt, chromium, tungsten, molybdenum, tantalum, niobium, titanium, and/or aluminum.

The resin used to fabricate the thermal management device may comprise a ceramic material. The ceramic material may comprise metal (e.g., aluminum, platinum, titanium, etc.), non-metal (e.g., oxygen, nitrogen, etc.), and/or metalloid (e.g., germanium, silicon, etc.) atoms primarily held in ionic and/or covalent bonds. A metal may be any element selected from the group consisting of aluminum, platinum, calcium, magnesium, barium, scandium, titanium, vanadium, chromium, manganese, iron, cobalt, nickel, copper, zinc, yttrium, niobium, molybdenum, ruthenium, rhodium, silver, cadmium, actinium, and gold. A non-metal may be any element selected from the group consisting of hydrogen, carbon, nitrogen, oxygen, phosphorus, sulfur, selenium, fluorine, chlorine, bromine, iodine, astatine, tennessine, helium, neon, argon, krypton, xenon, radon, and oganesson. A metalloid may be any element selected from the group consisting of arsenic, tellurium, germanium, silicon, antimony, boron, polonium, astatine, and selenium. The ceramic material may be, for example, aluminide, boride, beryllia, carbide, chromium oxide, hydroxide, sulfide, nitride, mullite, kyanite, ferrite, titania zirconia, yttria, and/or magnesia.

The resin used to fabricate the thermal management device may comprise one or more polymers. The one or more polymers may comprise monomers to be polymerized into the one or more polymers, oligomers to be cross-linked into the one or more polymers, or both. The monomers may be of the same or different types. An oligomer may comprise two or more monomers that are covalently linked to each other. The oligomer may be of any length, such as at least 2 (dimer), 3 (trimer), 4 (tetramer), 5 (pentamer), 6 (hexamer), 7, 8, 9, 10, 20, 30, 40, 50, 100, 200, 300, 400, 500, or more monomers. The one or more polymers may comprise a homopolymer and/or a copolymer. The homopolymer may comprise one or more identical monomer units. The copolymer may be a linear copolymer or a branched copolymer. The copolymer may be an alternating copolymer, periodic copolymer, statistical copolymer, random copolymer, and/or block copolymer. Examples of monomers may include one or more of hydroxyethyl methacrylate; n-Lauryl acrylate; tetrahydrofurfuryl methacrylate; 2, 2, 2-trifluoroethyl methacrylate; isobornyl methacrylate; polypropylene glycol monomethacrylates, aliphatic urethane acrylate (i.e., Rahn Genomer 1122); hydroxyethyl acrylate; n-Lauryl methacrylate; tetrahydrofurfuryl acrylate; 2, 2, 2-trifluoroethyl acrylate; isobornyl acrylate; polypropylene glycol monoacrylates; trimethylpropane triacrylate; trimethylpropane trimethacrylate; pentaerythritol tetraacrylate; pentaerythritol tetraacrylate; triethyleneglycol diacrylate; triethylene glycol dimethacrylate; tetrathyleneglycol diacrylate; tetrathylene glycol dimethacrylate; neopentyldimethacrylate; neopentylacrylate; hexane dioldimethacylate; hexane diol diacrylate; polyethylene glycol 400 dimethacrylate; polyethylene glycol 400 diacrylate; diethylglycol diacrylate; diethylene glycol dimethacrylate; ethyleneglycol diacrylate; ethylene glycol dimethacrylate; ethoxylated bis phenol A dimethacrylate; ethoxylated bis phenol A diacrylate; bisphenol A glycidyl methacrylate; bisphenol A glycidyl acrylate; ditrimethylolpropane tetraacrylate; and ditrimethylolpropane tetraacrylate.

The resin used to fabricate the thermal management device may comprise one or more composite materials. The one or more composite materials may comprise fiberglass, carbon fibers, carbon nanofibers, fiber-reinforced polymers, carbon-fiber-reinforced polymers, and/or glass-reinforced plastics.

Referring to FIG. 4, the three-dimensional (3D) printing system 400 may include a deposition head 405 that comprises a nozzle 407 that is in fluid communication with a source of the viscous liquid 409. The source of the viscous liquid 409 may be a syringe. The syringe may be operatively coupled to a syringe pump. The syringe pump can direct the syringe in a positive direction (from the source of the viscous liquid 409 towards the nozzle 407) to dispense the viscous liquid. The syringe pump can direct the syringe in a negative direction (away from the nozzle 407 towards the source of the viscous liquid 409) to retract any excess viscous liquid in the nozzle and/or on the print window back into the syringe. The deposition head 405 may be configured to move across the open platform 401 comprising the print window 402 to deposit the film of the viscous liquid 404. In some cases, the three-dimensional (3D) printing system 400 may comprise an additional source of an additional viscous liquid that is in fluid communication with the nozzle 407 or an additional nozzle of the deposition head 405. In some cases, the three-dimensional (3D) printing system 400 may comprise an additional deposition head comprising an additional nozzle that is in fluid communication with an additional source of an additional viscous liquid. In some cases, the three-dimensional (3D) printing system 400 may comprise three or more deposition heads and three or more sources of the same or different viscous liquids.

The viscous liquid comprising the resin and the plurality of particles may be stored in a source of the viscous liquid. The source of the viscous liquid may be a cup, container, syringe, or any other repository that can hold the viscous liquid. The source of the viscous liquid may in fluid communication (e.g., via a passageway) with the nozzle of the deposition head. The source of the viscous liquid may be connected to a flow unit. The flow unit may provide and control flow of the viscous liquid from the source of the viscous liquid towards the nozzle, thereby dispensing the viscous liquid. Alternatively or in addition to, the flow unit may provide and control flow of the viscous liquid in a direction away from the nozzle and towards the source of the viscous liquid, thereby retrieving the viscous liquid. The flow unit may use pressure mechanisms to control the speed and direction of the flow of the viscous liquid. The flow unit may be a syringe pump, vacuum pump, an actuator (e.g., linear, pneumatic, hydraulic, etc.), a compressor, or any other suitable device to exert pressure (positive or negative) to the viscous liquid in the source of the viscous liquid. A controller may be operatively coupled to the flow unit the control the speed, duration, and/or direction of the flow of the viscous liquid.

The source of the viscous liquid may comprise a sensor (e.g., an optical sensor) to detect the volume of the viscous liquid. The controller may be operatively coupled to the sensor to determine when the source of the viscous liquid may be replenished with new viscous liquid. Alternatively or in addition to, the source of the viscous liquid may be removable. The controller may determine when the source of the viscous liquid may be replaced with a new source of the viscous liquid comprising with the viscous liquid.

The three-dimensional (3D) printing system 400 of FIG. 4 may be configured to move the deposition head 405 across the open platform 401 and dispense the viscous liquid 404 through the nozzle 407 to deposit one or more layers of a film of the viscous liquid 404 over the print window 402. The deposition head 405 may be configured to move across the open platform 401 and deposit the film of the viscous liquid 404 over the print window 402. The deposition head 405 may be configured to deposit the viscous liquid 404 in a configuration such that the resulting green part generated by photopolymerization corresponds to the thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. The deposition head 405 may be configured to deposit the viscous liquid 404 in a configuration such that the green part generated by photopolymerization corresponds to a thermal management device with an array of fins and an array of heat pipes arranged in a staggered arrangement.

The film of the viscous liquid 404 may have a thickness ranging between about 1 micrometer (μm) to about 1000 μm. The film of the viscous liquid 404 may have a thickness of at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The film of the viscous liquid 404 may have a thickness of at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less. The thickness of the film of the viscous liquid 404 may have a tolerance ranging between about 1 μm to about 10 μm. The thickness of the film of the viscous liquid 404 may have a tolerance of at least about 1 μm, 2 μm, 3 μm, 4 μm, 5 μm, 6 μm, 7 μm, 8 μm, 9 μm, 10 μm, or more. The thickness of the film of the viscous liquid 404 may have a tolerance of at most about 10 μm, 9 μm, 8 μm, 7 μm, 6 μm, 5 μm, 4 μm, 3 μm, 2 μm, 1 μm, or less.

The deposition head 405 may comprise a nozzle 407. The nozzle 407 may be in fluid communication with the source of the viscous liquid 404. The deposition head 405 may dispense the viscous liquid 404 over the print window 402 through the nozzle 407 as a process of depositing the film of the viscous liquid 404 over the print window 402. The deposition head 405 may be configured to deposit the viscous liquid 404 in a configuration such that the resulting green part generated by photopolymerization corresponds to the thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. The deposition head 405 may retrieve any excess viscous liquid 404 from the print window 402 back into the source of the viscous liquid 404 through the nozzle 407. In some cases, the source of the viscous liquid 404 may be connected to the flow unit to provide and control flow of the viscous liquid towards or away from the nozzle 407 of the deposition head 405. Alternatively or in addition to, the nozzle 407 may comprise a nozzle flow unit that provides and controls flow of the viscous liquid towards or away from the print window 402. Examples of the nozzle flow unit include a piezoelectric actuator and an auger screw that is connected to an actuator.

The deposition head may comprise a wiper. The wiper may be movable along a direction towards and/or away from the print window. The wiper may have a variable height relative to the print window. The deposition head may comprise an actuator connected to the wiper to control movement of the wiper in a direction towards and away from the print window. The actuator may be a mechanical, hydraulic, pneumatic, or electro-mechanical actuator. The controller may be operatively coupled to the actuator to control the movement of the wiper in a direction towards and away from the print window. Alternatively or in addition to, a vertical distance between the wiper and the print window (e.g., a distance perpendicular to the print window) may be static. The deposition head may comprise a plurality of wipers with different configurations. In some cases, the deposition head may comprise the nozzle and three wipers.

The wiper of the deposition head may be configured to (i) reduce or inhibit flow of the viscous liquid out of the deposition head, (ii) flatten the film of the viscous liquid, and/or (iii) remove any excess of the viscous liquid. In an example, the wiper may be configured to be in contact with the print window and reduce or inhibit flow of the viscous liquid out of the deposition head. In another example, the wiper may be movable along a direction away from the print window and configured to flatten the film of the viscous liquid. The wiper may flatten the film of the viscous liquid to a defined height (or thickness). In a different example, the wiper may be movable along a direction away from the print window and configured to remove the excess of the viscous liquid.

The wiper may comprise polymer (e.g., rubber, silicone), metal, or ceramic. The wiper may comprise (e.g., entirely or as a coating) one or more fluoropolymers that prevent adhesion of the viscous liquid on the wiper. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (a copolymer of tetrafluoroethylene and perfluoromethylvinylether, i.e. MFA).

The wiper of the deposition head may be a blade (e.g., a squeegee blade, a doctor blade). The blade may have various shapes. The blade may be straight and/or curved. The wiper may be a straight blade with a flat surface. The wiper may be a straight blade with a curved surface. The wiper may be a curved blade (curved along the long axis of the wiper) with a flat surface. The wiper may be a curved blade (curved along the long axis of the wiper) with a curved surface. In some cases, the wiper may comprise at least one straight portion and at least one curved portion along its length. For example, the wiper may be a blade comprising a straight central portion between two curved portions.

In an example, the wiper may be a straight blade and configured perpendicular to the print window. In another example, the wiper may be a straight blade with a flat surface, and tilted at an angle. When the deposition head moves to remove any excess viscous liquid from the print window, the tilted straight blade may concentrate the excess resin at the bottom of the blade. The straight blade may be tilted at an angle ranging between about 1 degree to about 50 degrees. The straight blade may be tilted at an angle of at least about 1 degree, 2 degrees, 3 degrees, 4 degrees, 5 degrees, 6 degrees, 7 degrees, 8 degrees, 9 degrees, 10 degrees, 20 degrees, 30 degrees, 40 degrees, 50 degrees, or more. The straight blade may be tiled at an angle of at most about 50 degrees, 40 degrees, 30 degrees, 20 degrees, 10 degrees, 9 degrees, 8 degrees, 7 degrees, 6 degrees, 5 degrees, 4 degrees, 3 degrees, 2 degrees, 1 degree, or less.

In another example, the wiper may be a straight blade with a curved surface (a curved blade). When the deposition head moves to remove any excess viscous liquid from the print window, the curved blade may concentrate the excess resin in the center of the concave surface of the wiper. The curved blade may reduce or prevent the excess resin from spilling out from the sides of the blade. A radius of curvature of the surface of the blade may range between about 10 millimeter (mm) to about 1000 mm. The radius of curvature of the surface of the blade may be at least about 10 millimeters (mm), 20 mm, 30 mm, 40 mm, 50 mm, 60 mm, 70 mm, 80 mm, 90 mm, 100 mm, 200 mm, 300 mm, 400 mm, 500 mm, 1000 mm, or more. The radius of curvature of the surface of the blade may be at most about 1000 mm, 500 mm, 400 mm, 300 mm, 200 mm, 100 mm, 90 mm, 80 mm, 70 mm, 60 mm, 50 mm, 40 mm, 30 mm, 20 mm, 10 mm, or less.

The wiper of the deposition head may be a roller. The roller may have a surface that is flat or textured. The roller may be configured to rotate clockwise and/or counterclockwise while the deposition head moves across the print window. Alternatively, or in addition, the roller may be configured to be static while the deposition head moves across the print window. In some cases, the wiper of the deposition head may be a rod. The rod may have a surface that is flat or textured. The rod may be configured to rotate clockwise and/or counterclockwise while the deposition head moves across the print window. Alternatively, or in addition, the rod may be configured to be static while the deposition head moves across the print window. In an example, the rod may be a wire wound rod, e.g., a Meyer rod.

The deposition head may comprise a slot die. The slot die may be configured to move along a direction away from the print window. The slot die may be height adjustable with respect to the print window. The slot die may comprise a channel in fluid communication with the source of the viscous liquid. The channel may comprise a first opening to receive the viscous liquid from the source of the viscous liquid. The channel may comprise a second opening opposite of the first opening to dispense the viscous liquid to the print window. The second opening may be an injection point. The channel may have a reservoir between the first and second openings to hold a volume of the viscous liquid. The injection point of the slot die may comprise a flat surface to flatten the film of the viscous liquid to a defined height (or thickness).

The deposition head comprising the slot die may include a separate nozzle to suction and retrieve any excess viscous liquid from the film of the viscous liquid during printing. The separate nozzle of the deposition head comprising the slot die may be in fluid communication with a repository to collect the excess viscous liquid. The repository may be a recycling bin. The repository may also be in fluid communication with the slot die to send the excess viscous liquid collected in the repository back into the reservoir of the slot die. Alternatively or in addition to, the collected excess viscous liquid may be removed for reprocessing. The reprocessing of the collected excess viscous liquid may comprise (i) filtering out any polymerized solid particulates, (ii) filtering out any of the plurality of particles that may be greater than a target particle size, (iii) remixing the viscous liquid to ensure homogeneity, and/or (iv) removing at least a portion of air entrapped in the viscous liquid. The at least the portion of air entrapped in the viscous liquid may be removed by centrifuging the viscous liquid.

The three-dimensional (3D) printing system may further comprise an additional deposition head comprising an additional nozzle. The additional nozzle of the additional deposition head may be in fluid communication with an additional source of an additional viscous liquid. The nozzle of the deposition head of the three-dimensional (3D) printing system may be in fluid communication with the source of the viscous liquid and the additional source of the additional viscous liquid. Alternatively or in addition to, the deposition head may comprise a first nozzle in fluid communication with the source of the viscous liquid, and (b) a second nozzle in fluid communication with the additional source of the additional viscous liquid. The presence of the additional source of the additional viscous liquid may allow for printing of at least a portion of one or more components (e.g., a heat pipe, a fin, and/or a vapor chamber) of the thermal management device using multiple materials (multi-materials) in different layers and/or in different portions within the same layer.

The viscous liquid and the additional viscous liquid may be the same. As an alternative, the viscous liquid and the additional viscous liquid may be different. The viscous liquid and the additional viscous liquid may comprise different types of the photoactive resin, the plurality of particles, or both. Alternatively or in addition to, the viscous liquid and the additional viscous liquid may comprise different amounts (concentrations in terms of weight by volume) of the photoactive resin, the plurality of particles, or both. In an example, the viscous liquid may comprise metallic particles, and the additional viscous liquid may comprise ceramic particles. A first concentration of the metallic particles in the viscous liquid and a second concentration of the ceramic particles in the additional viscous liquid may be the same or different. A first photoactive resin in the viscous liquid and a second photoactive resin in the additional viscous liquid may be the same or different. In another example, the viscous liquid may comprise a first type of metallic particles, and the additional viscous liquid may comprise a second type of metallic particles. In a different example, the viscous liquid may comprise ceramic particles at a first concentration, and the additional viscous liquid may comprise the same ceramic particles at a second concentration that is different from the first concentration.

The three-dimensional (3D) printing system may comprise a build head. The build head may be configured to hold and/or support at least a portion (e.g., a layer) of the thermal management device generated using the resin. During printing, the at least the portion of the thermal management device may be printed on the build head. The build head may be configured to move relative to the print window during printing. The build head may be configured to move along a direction away from the print window during printing. Such movement may be relative movement, and thus the moving piece may be the build head, the print window, or both. The build head may be connected to a build head actuator for moving the build head relative to the print window. The build head actuator may be a mechanical, hydraulic, pneumatic, or electro-mechanical actuator. Alternatively or in addition to, the open platform comprising the print window may be connected to an open platform actuator for moving the open platform relative to the build head. The open platform actuator may be a mechanical, hydraulic, pneumatic, or electro-mechanical actuator. The controller may be operatively coupled to the build head actuator and/or the open platform actuator to control the relative distance between the build head and the print window. The relative distance between the build head and the print window may be adjusted to adjust a thickness of a layer within the at least the portion of the 3D object (e.g., the thermal management device) and/or at least a portion of a green part corresponding to the thermal management device.

The three-dimensional (3D) printing system may comprise a cleaning zone. The cleaning zone may be configured adjacent to the open platform. The cleaning zone may be configured in a path of movement of the deposition head across the open platform. The cleaning zone may be configured to clean the deposition head. Cleaning the deposition head may (i) improve reliability and reproducibility of printing at least the portion of the thermal management device and/or printing at least a portion of a green part corresponding to the thermal management device, and (ii) reduce wear and tear of the deposition head. The deposition head may be static or move relative to the cleaning zone while the cleaning zone cleans the deposition head. The cleaning zone may comprise a wiper, a nozzle configured to provide at least one cleaning solvent, or both. The wiper of the cleaning zone may be a blade (e.g., a doctor blade), a roller, or a rod. In some cases, one or more wipers of the cleaning zone may come in contact with one or more wipers of the deposition head and remove any excess resin remaining on the one or more wipers of the deposition head. In some cases, one or more nozzles of the cleaning zone may dispense or jet the at least one cleaning solvent to the one or more wipers of the deposition head for cleaning. The one or more nozzles of the cleaning zone may be in fluid communication with at least one source of the at least one cleaning solvent. At least a portion of the viscous liquid may be soluble in the at least one cleaning solvent. The cleaning zone may comprise a repository that can hold the excess viscous liquid that is removed from the deposition head and/or the at least one cleaning solvent.

The three-dimensional (3D) printing system may comprise a repository (e.g., vat or container) adjacent to the open platform. The repository may be configured to collect the viscous liquid from the film of the deposition head. The repository may be configured to hold any excess viscous liquid that is removed from the print window by the deposition head. After removing any excess viscous liquid from the print window, the deposition head may move and use at least one wiper to collect the excess viscous liquid into the repository. The repository may be a recycling bin. The repository may be in fluid communication with the source of the viscous liquid to recycle the collected excess viscous liquid for printing. Alternatively or in addition to, the collected excess viscous liquid may be removed for reprocessing. The reprocessing of the collected excess viscous liquid may comprise (i) filtering out any polymerized solid particulates, (ii) filtering out any of the plurality of particles that may be greater than a target particle size, (iii) remixing the viscous liquid to ensure homogeneity, and/or (iv) removing at least a portion of air entrapped in the viscous liquid. The at least the portion of air entrapped in the viscous liquid may be removed by centrifuging the viscous liquid. In some cases, the repository may comprise a sensor (e.g., an optical sensor or a weight scale) to detect when the repository is full and/or when an amount of the collected excess viscous liquid is above a predefined threshold.

The three-dimensional (3D) printing system may comprise a sensor. The sensor may be configured to move across the open platform and/or measure a thickness of at least a portion of the film of the viscous liquid. The sensor may assess integrity of the film of the viscous liquid before inducing polymerization of the polymeric precursors in the photoactive resin in the film of the viscous liquid. The sensor may detect any variation in thickness across the film. The sensor may detect any irregularities (e.g., defects, empty spots, solid particles, etc.) in the film. The sensor may be configured to perform quality control after printing at least a portion (e.g., a layer) of the 3D object. The sensor may scan a remaining portion of the film of the viscous liquid after printing, and the controller that is operatively coupled to the sensor may determine if the previous printing process was successful or not. The sensor may be an optical profilometer (e.g., an in-line profilometer).

The three-dimensional (3D) printing system may comprise a transparent film adjacent to the open platform and configured to hold the film of the viscous liquid. The transparent film may cover the print window. The transparent film may comprise one or more fluoropolymers that reduce adhesion of a cured portion of the viscous liquid on the transparent film. Examples of the one or more fluoropolymers include polyvinylidene fluoride (PVDF), ethylenchlorotrifluoroethylene (ECTFE), ethylenetetrafluoroethylene (ETFE), polytetrafluoroethylene (PTFE), perfluoroalkoxy (PFA), and modified fluoroalkoxy (e.g., MFA). The transparent film may reduce or eliminate any undesirable force (e.g., a sliding or rotational mechanism) that may otherwise be needed to separate the cured portion of the viscous liquid and the print window. This may yield a reduced failure rate and increased printing speed.

The three-dimensional (3D) printing system may comprise an optical source that provides a light through the print window for curing the at least the portion of the film of the viscous liquid. The optical source may include lamps (e.g., incandescent lamps, halogen lamps, carbon arc lamps, or discharge lamps), torches, lasers, light emitting diodes (LEDs), super luminescent diodes (SLDs), gas-filled tubes such as fluorescent bulbs, or any other equipment capable of producing a stream of photons. The optical source may emit electromagnetic waves with a wavelength ranging from about 200 nm to about 700 nm. The optical source may include sources of ultraviolet light. In some cases, a light of the optical source may comprise a first wavelength for curing the photoactive resin in a first portion of the film of the viscous liquid. The first wavelength may activate the at least one photoinitiator of the photoactive resin, thereby initiating curing of the polymeric precursors into the polymeric material. The light may be a photoinitiation light, and the first portion of the film may be a photoinitiation layer. The optical source may provide an additional light having a second wavelength for inhibiting curing of the photoactive resin in a second portion of the film of the viscous liquid. The first wavelength and the second wavelength may be different. In some cases, the photoactive resin may comprise at least one photoinhibitor. The second wavelength may activate the at least one photoinhibitor in the photoactive resin, thereby inhibiting curing of the polymeric precursors into the polymeric material. The additional light may be a photoinhibition light, and the second portion of the film of the viscous liquid may be a photoinhibition layer. In some cases, a dual-wavelength projector (e.g., a dual-wavelength laser) may be used as the optical source to provide both the photoinitiation light and the photoinhibition light.

The light of the optical source may comprise a first wavelength for curing the photoactive resin in a first portion of the film of the viscous liquid. The first wavelength may activate the at least one photoinitiator of the photoactive resin, thereby initiating curing of the polymeric precursors into the polymeric material. The polymeric material may encapsulate the plurality of particles in the photoactive resin. The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device. The light may be a photoinitiation light, and the first portion of the film may be a photoinitiation layer. The light may be a patterned light. The three-dimensional (3D) printing system may further comprise an additional optical source comprising an additional light having a second wavelength for inhibiting curing of the photoactive resin in a second portion of the film of the viscous liquid. The additional optical source may include lamps (e.g., incandescent lamps, halogen lamps, carbon arc lamps, or discharge lamps), torches, lasers, light emitting diodes (LEDs), super luminescent diodes (SLDs), gas-filled tubes such as fluorescent bulbs, or any other equipment capable of producing a stream of photons. The additional optical source may emit electromagnetic waves with a wavelength ranging from about 200 nm to about 700 nm. The additional optical source may include sources of ultraviolet light. The first wavelength of the light emitted from the optical source may be different than the second wavelength of the additional light emitted from the additional optical source. The second wavelength may activate the at least one photoinhibitor of the photoactive resin, thereby inhibiting curing of the polymeric precursors into the polymeric material. The additional light may be a photoinhibition light, and the second portion of the film of the viscous liquid may be a photoinhibition layer. In some cases, the additional light may be a flood light.

The optical source that directs the photoinitiation light may be a mask-based display, such as a liquid crystal display (LCD) device, or light emitting, such as a discrete light emitting diode (LED) array device. Alternatively, the optical source that directs the photoinitiation light may be a digital light processing (DLP) device, including a digital micro-mirror device (DMD) for producing patterned light that can selectively illuminate and cure 3D printed structures. The initiation light directed from the DLP device may pass through one or more projection optics (e.g., a light projection lens) prior to illuminating through the print window and to the film of the viscous liquid. The one or more projection optics may be integrated in the DLP device. Alternatively or in addition to, the one or more projection optics or may be configured between the DLP device and the print window. A relative position of the one or more projection optics relative to the DLP device and the print window may be adjustable to adjust an area of the photoinitiation layer in the film of the viscous liquid. The area of the photoinitiation layer may be defined as a build area. In some cases, the one or more projection optics may be on a projection optics platform. The projection optics platform may be coupled to an actuator that directs movement of the projection optics platform. The controller may be operatively coupled to the actuator to control movement of the projection optics platform. The controller may direct the actuator (e.g., a screw-based mechanism) to adjust a relative position of the one or more projection optics to the DLP device and the print window during printing the 3D object.

The additional optical source that directs the photoinhibition light may comprise a plurality of light devices (e.g., a plurality of light emitting diodes (LEDs)). The light devices may be adjacent to a light platform. The light platform may be configured (i) move relative to the print window and (ii) yield a uniform projection of the photoinhibition light within the photoinhibition layer in the film of the viscous liquid adjacent to the print window. The position of the light platform may be independently adjustable with respect to a position of the optical source that directs the photoinitiation light. The light platform comprising the plurality of light devices may be arranged with respect to the print window such that a peak intensity of each of the plurality of light devices is directed at a different respective position (e.g., corner or other position) of the build area. In an example, the build area may have four corners and a separate beam of light (e.g., a separate LED) may be directed to each corner of the build area. The beams of photoinhibition light from the plurality of light devices may overlap to provide the uniform projection of the photoinhibition light within the photoinhibition layer. The light platform may be coupled to an actuator that is configured to direct movement of the light platform. The controller may be operatively coupled to the actuator to control movement of the light platform. The controller may direct the actuator (e.g., a screw-based mechanism) to adjust a relative position of the plurality of light devices to the print window during printing the 3D object. In some cases, the one or more projection optics to the DLP device (for the photoinitiation light) may be on the light platform.

Whether using one optical source or two optical sources, a photoinhibition light may be configured to create a photoinhibition layer in the film of the viscous liquid adjacent to the print window. The photoinhibition light may be configured to form the photoinhibition layer in the film of the viscous liquid adjacent to the transparent film that is covering the print window. Furthermore, the photoinitiation light may be configured to cure the photoactive resin in the photoinitiation layer that resides between the photoinhibition layer and the build head. The photoactive resin in the photoinitiation layer may be cured into at least a portion of the thermal management device and/or at least a portion of a green part corresponding to the thermal management device. The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device. In some examples, the photoactive resin in the photoinitiation layer may be cured into at least a portion of the thermal management device (e.g., a fin, a portion of the fin, a heat pipe, a portion of the heat pipe, a vapor chamber, and/or a portion of the vapor chamber) and/or at least a portion of a green part corresponding to the thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. The photoinitiation light may be configured to cure the photoactive resin in the photoinitiation layer that resides between the photoinhibition layer and the at least the portion of the 3D structure (e.g., a portion of a green part corresponding to a portion of the thermal management device) adjacent to the build head.

As illustrated in FIG. 4, the three-dimensional (3D) printing system 400 may be further configured to direct light through the print window 402 to the one or more layers of the film to cure the photoactive resin in at least a portion of the one or more layers of the film, thereby printing at least a portion of the thermal management device and/or a green part corresponding to at least a portion of the thermal management device. The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device.

As shown in FIG. 4, illumination (e.g., a light from an optical source) may be transmitted through the print window 402 to cure at least a portion of the film of the viscous liquid 404 to print at least a portion of a 3D structure 408. The at least a portion of the 3D structure 408 may correspond to a portion of the thermal management device (e.g., a fin, a portion of the fin, a heat pipe, a portion of the heat pipe, a vapor chamber, and/or a portion of the vapor chamber) or at least a portion of a green part corresponding to thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. The at least the portion of the 3D structure 408 is illustrated in FIG. 4 as a block; however, in practice a wide variety of complicated shapes may be printed. The at least the portion of the 3D structure 408 may include entirely solid structures, hollow core prints, lattice core prints, and generative design geometries.

The illumination transmitted through the print window 402 may initiate photopolymerization of at least a portion of the film of the viscous liquid 404. Photopolymerization of the polymeric precursors into the polymeric material may be controlled by one or more photoactive species, such as a photoinitiator. The at least one photoinitiator may be configured to initiate formation of the polymeric material from the polymeric precursor. For example, the at least one photoinitiator may be a photon-absorbing compound that (i) is activated by a first light comprising a first wavelength and (ii) initiates photopolymerization of the polymeric precursors. The first light may comprise wavelengths ranging between about 420 nanometers (nm) to about 510 nm. In an example, the first wavelength to induce photoinitiation may be about 460 nm.

Relative rates of the photoinitiation by the at least one photoinitiator may be controlled by adjusting the intensity and/or duration of the first light. By controlling the relative rates of the photoinitiation, an overall rate and/or amount (degree) of polymerization of the polymeric precursors into the polymeric material may be controlled. Controlling the relative rates of the photoinitiation may help to (i) prevent polymerization of the polymeric precursors at an interface between a print window and the resin, (ii) control the rate at which polymerization takes place in the direction away from the print window, and/or (iii) control a thickness of the polymeric material within the film of the viscous liquid and/or resin.

The photoinitiator may be a photon-absorbing compound that (i) is activated by a first light comprising a first wavelength and (ii) initiates photopolymerization of the polymeric precursors. Examples of photoinitiators include one or more of benzophenones, thioxanthones, anthraquinones, benzoylformate esters, hydroxyacetophenones, alkylaminoacetophenones, benzil ketals, dialkoxyacetophenones, benzoin ethers, phosphine oxides acyloximino esters, alphahaloacetophenones, trichloromethyl-S-triazines, titanocenes, dibenzylidene ketones, ketocoumarins, dye sensitized photoinitiation systems, maleimides, and mixtures thereof. Examples of photoinitiators in a photoactive resin include one or more of 1-hydroxy-cyclohexyl-phenyl-ketone (Irgacure™ 184; BASF, Hawthorne, N.J.); a 1:1 mixture of 1-hydroxy-cyclohexyl-phenyl-ketone and benzophenone (Irgacure™ 500; BASF); 2-hydroxy-2-methyl-1-phenyl-1-propanone (Darocur™ 1173; BASF); 2-hydroxy-1-[4-(2-hydroxyethoxy)phenyl]-2-methyl-1-propanone (Irgacure™ 2959; BASF); methyl benzoylformate (Darocur™ MBF; BASF); oxy-phenyl-acetic acid 2-[2-oxo-2-phenyl-acetoxy-ethoxy]-ethyl ester; oxy-phenyl-acetic 2-[2-hydroxy-ethoxy]-ethyl ester; a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester (Irgacure™ 754; BASF); alpha,alpha-dimethoxy-alpha-phenylacetophenone (Irgacure™ 651; BASF); 2-benzyl-2-(dimethylamino)-1-[4-(4-morpholinyl)-phenyl]-1-butanone (Irgacure™ 369; BASF); 2-methyl-1-[4-(methylthio)phenyl]-2-(4-morpholinyl)-1-propanone (Irgacure™ 907; BASF); a 3:7 mixture of 2-benzyl-2-(dimethylamino)-1-[4-(4-morpholinyl) phenyl]-1-butanone and alpha,alpha-dimethoxy-alpha-phenylacetophenone per weight (Irgacure™ 1300; BASF); diphenyl-(2,4,6-trimethylbenzoyl) phosphine oxide (Darocur™ TPO; BASF); a 1:1 mixture of diphenyl-(2,4,6-trimethylbenzoyl)-phosphine oxide and 2-hydroxy-2-methyl-1-phenyl-1-propanone (Darocur™ 4265; BASF); phenyl bis(2,4,6-trimethyl benzoyl) phosphine oxide, which can be used in pure form (Irgacure™ 819; BASF, Hawthorne, N.J.) or dispersed in water (45% active, Irgacure™ 819DW; BASF); 2:8 mixture of phosphine oxide, phenyl bis(2,4,6-trimethyl benzoyl) and 2-hydroxy-2-methyl-1-phenyl-1-propanone (Irgacure™ 2022; BASF); Irgacure™ 2100, which comprises phenyl-bis(2,4,6-trimethylbenzoyl)-phosphine oxide); bis-(eta 5-2,4-cyclopentadien-1-yl)-bis-[2,6-difluoro-3-(1H-pyrrol-1-yl) phenyl]-titanium (Irgacure™ 784; BASF); (4-methylphenyl) [4-(2-methylpropyl) phenyl]-iodonium hexafluorophosphate (Irgacure™ 250; BASF); 2-(4-methylbenzyl)-2-(dimethylamino)-1-(4-morpholinophenyl)-butan-1-one (Irgacure™ 379; BASF); 4-(2-hydroxyethoxy)phenyl-(2-hydroxy-2-propyl)ketone (Irgacure™ 2959; BASF); bis-(2,6-dimethoxybenzoyl)-2,4,4-trimethylpentylphosphine oxide; a mixture of bis-(2,6-dimethoxybenzoyl)-2,4,4-trimethylpentylphosphine oxide and 2 hydroxy-2-methyl-1-phenyl-propanone (Irgacure™ 1700; BASF); 4-Isopropyl-9-thioxanthenone; and mixtures thereof. Additional examples of the photoinitiator may include sulfanylthiocarbonyl and other radicals generated in photoiniferter polymerizations; sulfanylthiocarbonyl radicals used in reversible addition-fragmentation chain transfer polymerization; and/or nitrosyl radicals used in nitroxide mediate polymerization.

The at least one photoinitiator may be present in an amount ranging between about 0.001 percent by weight (wt %) to about 10 wt % in the photoactive resin. The at least one photoinitiator may be present in an amount of at least about 0.001 wt. %, 0.002 wt. %, 0.003 wt. %, 0.004 wt. %, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt. %, or more in the photoactive resin. The at least one photoinitiator may be present in an amount of at most about 10 wt %, 9 wt %, 8 wt %, 7 wt %, 6 wt %, 5 wt %, 4 wt %, 3 wt %, 2 wt %, 1 wt %, 0.9 wt %, 0.8 wt %, 0.7 wt %, 0.6 wt %, 0.5 wt %, 0.4 wt %, 0.3 wt %, 0.2 wt %, 0.1 wt %, 0.009 wt. %, 0.008 wt. %, 0.007 wt. %, 0.006 wt. %, 0.005 wt. %, 0.004 wt. %, 0.003 wt. %, 0.002 wt. %, 0.001 wt. %, or less in the photoactive resin.

As illustrated in FIG. 4, the at least the portion of the 3D structure 408 may be printed on a build head 410, which may be connected by a rod 412 to one or more 3D printing mechanisms 414. The 3D printing mechanisms 414 may include various mechanical structures for moving the build head 410 in a direction towards and/or away from the open platform 401. This movement may be a relative movement, and thus moving pieces can be the build head 410, the open platform 401, or both, in various embodiments. The 3D printing mechanisms 414 may include Cartesian (xyz) type 3D printer motion systems or delta type 3D printer motion systems. The 3D printing mechanisms 414 may include one or more controllers to direct movement of the build head 410, the open platform 401, or both.

Multiple devices emitting various wavelengths and/or intensities of light, including a light projection device 426 and light sources 428, may be positioned below the print window 402 and in communication with the one or more controllers. The light sources 428 can include at least 2, 3, 4, 5, 6, or more light sources. As an alternative to the light sources 428, a single light source may be used. The light projection device 426 directs a first light having a first wavelength through the print window 402 and into the film of the viscous liquid 404 adjacent to the print window 402. The first wavelength emitted by the light projection device 426 may be selected to induce photoinitiation and may be used to create at least a portion of the 3D structure on the at least the portion of the 3D structure 408 that is adjacent to the build head 410 by curing the photoactive resin in the film of the viscous liquid 404 within a photoinitiation layer 430. The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device. The light projection device 426 may be utilized in combination with one or more projection optics 432 (e.g. a projection lens for a digital light processing (DLP) device), such that the light output from the light projection device 426 passes through the one or more projection optics 432 prior to illuminating the film of the viscous liquid 404 adjacent to the print window 402.

The light projection device 426 may be a DLP device including a digital micro-mirror device (DMD) for producing patterned light that can selectively illuminate and cure the photoactive resin in the photoinitiation layer 430. The light projection device 426, in communication with the one or more controllers, may receive instructions defining a pattern of illumination to be projected from the light projection device 426 into the photoinitiation layer 430 to cure a layer of the photoactive resin onto the at least the portion of the 3D structure 408.

In some cases, photoinhibition may be used in conjunction with photoinitiation in order to, for example, help prevent adhesion of the cured layer onto a print window. In such cases, the photoactive resin used to generate the thermal management device and/or a green part corresponding to the thermal management device may comprise at least one photoinhibitor. The photoinhibitor may be configured to inhibit curing of the polymerizable and/or cross-linkable component. The at least one photoinhibitor may be another photon-absorbing compound that (i) is activated by a second light comprising a second wavelength and (ii) inhibits the photopolymerization of the polymeric precursors. The at least one photoinhibitor in the photoactive resin may comprise one or more radicals that may preferentially terminate growing polymer radicals, rather than initiating polymerization of the polymeric precursors. In situations where the photoactive resin comprises at least one photoinhibitor, the three-dimensional (3D) printing system may be configured to control the photopolymerization of the polymeric precursors into the polymeric material using the at least one photoinitiator and the at least one photoinhibitor. For example, the at least one photoinitiator may be configured to initiate formation of the polymeric material from the polymeric precursor. The at least one photoinitiator may be a photon-absorbing compound that (i) is activated by a first light comprising a first wavelength and (ii) initiates photopolymerization of the polymeric precursors. The at least one photoinhibitor may be configured to inhibit formation of the polymeric material from the polymeric precursor. The at least one photoinhibitor may be another photon-absorbing compound that (i) is activated by a second light comprising a second wavelength and (ii) inhibits the photopolymerization of the polymeric precursors. The first wavelength and the second wavelength may be different. The first light and the second light may be directed by the same light source. Alternatively, the first light may be directed by a first light source and the second light may be directed by a second light source. The first light may comprise wavelengths ranging between about 420 nanometers (nm) to about 510 nm. The second light may comprise wavelengths ranging between about 350 nm to about 410 nm. In an example, the first wavelength to induce photoinitiation may be about 460 nm. The second wavelength to induce photoinhibition may be about 365 nm.

The photoinhibitor may comprise a hexaarylbiimidazole (HABI) or a functional variant thereof. The hexaarylbiimidazole may comprise a phenyl group with a halogen and/or an alkoxy substitution. In an example, the phenyl group comprises an ortho-chloro-substitution. In another example, the phenyl group comprises an ortho-methoxy-substitution. In another example, the phenyl group comprises an ortho-ethoxy-substitution. Examples of the functional variants of the hexaarylbiimidazole include: 2,2′-Bis(2-chlorophenyl)-4,4′,5,5′-tetraphenyl-1,2′-biimidazole; 2-(2-methoxyphenyl)-1-[2-(2-methoxyphenyl)-4,5-diphenyl-2H-imidazol-2-yl]-4,5-diphenyl-1H-imidazole; 2-(2-ethoxyphenyl)-1-[2-(2-ethoxyphenyl)-4,5-diphenyl-2H-imidazol-2-yl]-4,5-diphenyl-1H-imidazole; and 2,2′,4-tris-(2-Chlorophenyl)-5-(3,4-dimethoxyphenyl)-4′,5′-diphenyl-1,1′-biimidazole.

Other examples of the photoinhibitor may include one or more of: zinc dimethyl dithiocarbamate: zinc dimethyl dithiocarbamate; zinc diethyl dithiocarbamate; zinc dibutyl dithiocarbamate; nickel dibutyl dithiocarbamate; zinc dibenzyl dithiocarbamate; tetramethylthiuram disulfide; tetraethylthiuram disulfide (TEDS); tetramethylthiuram monosulfide; tetrabenzylthiuram disulfide; tetraisobutylthiuram disulfide; dipentamethylene thiuram hexasulfide; N,N′-dimethyl N,N′-di(4-pyridinyl)thiuram disulfide; 3-Butenyl 2-(dodecylthiocarbonothioylthio)-2-methylpropionate; 4-Cyano-4-[(dodecyl sulfanylthiocarbonyl)sulfanyl]pentanoic acid; 4-Cyano-4-[(dodecylsulfanylthiocarbonyl)sulfanyl]pentanol; Cyanomethyl dodecyl trithiocarbonate; Cyanomethyl [3-(trimethoxysilyl)propyl] trithiocarbonate; 2-Cyano-2-propyl dodecyl trithiocarbonate; S,S-Dibenzyl trithiocarbonate; 2-(Dodecylthiocarbonothioylthio)-2-methylpropionic acid; 2-(Dodecylthiocarbonothioylthio)-2-methylpropionic acid N-hydroxysuccinimide; Benzyl 1H-pyrrole-1-carbodithioate; Cyanomethyl diphenylcarbamodithioate; Cyanomethyl methyl(phenyl)carbamodithioate; Cyanomethyl methyl(4-pyridyl)carbamodithioate; 2-Cyanopropan-2-yl N-methyl-N-(pyridin-4-yl)carbamodithioate; Methyl 2-[methyl(4-pyridinyl)carbamothioylthio]propionate; 1-Succinimidyl-4-cyano-4-[N-methyl-N-(4-pyridyl)carbamothioylthio]pentanoate; Benzyl benzodithioate; Cyanomethyl benzodithioate; 4-Cyano-4-(phenylcarbonothioylthio)pentanoic acid; 4-Cyano-4-(phenylcarbonothioylthio)pentanoic acid N-succinimidyl ester; 2-Cyano-2-propyl benzodithioate; 2-Cyano-2-propyl 4-cyanobenzodithioate; Ethyl 2-(4-methoxyphenylcarbonothioylthio)acetate; 2-Phenyl-2-propyl benzodithioate; Cyanomethyl methyl(4-pyridyl)carbamodithioate; 2-Cyanopropan-2-ylN-methyl-N-(pyridin-4-yl)carbamodithioate; Methyl 2-[methyl(4-pyridinyl)carbamothioylthio]propionate; 1,1′-Bi-1H-imidazole; and functional variants thereof. Other examples of the at least one photoinhibitor may include one or more of thiocarbamates, xanthates, dithiobenzoates, hexaarylbiimidazoles, photoinitiators that generate ketyl and other radicals that tend to terminate growing polymer chains radicals (i.e., camphorquinone (CQ) and benzophenones), atom-transfer radical polymerization (ATRP) deactivators, and/or polymeric versions thereof.

The photoinhibitor may be present in the mixture at an amount from about 0.001 percent by weight (wt. %) to about 10 wt. %. The photoinhibitor may be present in the mixture at amount of at least about 0.001 wt. %, 0.002 wt. %, 0.003 wt. %, 0.004 wt. %, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.5 wt. %, 1 wt. %, 5 wt. %, 6 wt. %, 7 wt. %, 8 wt. %, 9 wt. %, 10 wt. %, or more. The photoinhibitor may be present in the mixture at an amount of at most about 10 wt. %, 9 wt. %, 8 wt. %, 7 wt. %, 6 wt. %, 5 wt. %, 1 wt. %, 0.5 wt. %, 0.1 wt. %, 0.05 wt. %, 0.04 wt. %, 0.03 wt. %, 0.02 wt. %, 0.01 wt. %, 0.009 wt. %, 0.008 wt. %, 0.007 wt. %, 0.006 wt. %, 0.005 wt. %, 0.004 wt. %, 0.003 wt. %, 0.002 wt. %, 0.001 wt. %, or less.

For photoinhibition to occur during the 3D printing, the amount of the photoinhibitor in the mixture may be sufficient to generate inhibiting radicals at a greater rate that initiating radicals are generated. One skilled in the art will understand how to manipulate the ratio of the amount of the photoinhibitor and/or the photoinitiator based on the intensity of the optical sources available, as well as the quantum yields and light absorption properties of the photoinhibitor and the photoinitiator in the mixture.

Relative rates of the photoinitiation by the at least one photoinitiator and relative rates of the photoinhibition by the at least one photoinhibitor may be controlled by adjusting the intensity and/or duration of the first light, the second light, or both. By controlling the relative rates of the photoinitiation and the photoinhibition, an overall rate and/or amount (degree) of polymerization of the polymeric precursors into the polymeric material may be controlled. Such a process may be used to (i) prevent polymerization of the polymeric precursors at an interface between a print window and the resin, (ii) control the rate at which polymerization takes place in the direction away from the print window, and/or (iii) control a thickness of the polymeric material within the film of the viscous liquid and/or resin.

As illustrated in FIG. 4, the three-dimensional (3D) printing system may include one or more light sources 428 configured to direct a second light having a second wavelength into the film of the viscous liquid 404 adjacent to the open platform 401 comprising the print window 402. The second light may be provided as multiple beams from the light sources 428 through the print window 402 simultaneously. As an alternative, the second light may be generated from the light sources 428 and provided as a single beam through the print window 402. The second wavelength emitted by the light sources 428 may be selected to induce photoinhibition in the photoactive resin in the film of the viscous liquid 404 and is used to create a photoinhibition layer 434 within the film of the viscous liquid 404 directly adjacent to the print window 402. The light sources 428 can produce a flood light to create the photoinhibition layer 434, the flood light being a non-patterned, high-intensity light. The light sources 428 may be light emitting diodes (LEDs) 436. The light sources 428 can be arranged on a light platform 438. The light platform 438 is mounted on adjustable axis rails 440. The adjustable axis rails 440 allow for movement of the light platform 438 along an axis towards or away from the print window 402. The light platform 438 and the one or more projection optics 432 may be moved independently. A relative position of the light platform comprising the light sources may be adjusted to project the second light into the photoinhibition layer 434 at the respective peak intensity and/or in a uniform projection manner. The light platform 438 may function as a heat-sink for at least the light sources 428 arranged on the light platform 438.

The respective thicknesses of the photoinitiation layer 430 and the photoinhibition layer 434 may be adjusted by the one or more controllers. This change in layer thickness(es) may be performed for each new 3D printed layer, depending on the desired thickness of the 3D printed layer, and/or the type of viscous liquid in the film of the viscous liquid 404. The thickness(es) of the photoinitiation layer 430 and the photoinhibition layer 434 may be changed, for example, by changing the intensity of the respective light emitting devices (426 and/or 428), exposure times for the respective light emitting devices, or both. By controlling relative rates of reactions between the photoactive species (e.g., at least one photoinitiator and at least one photoinhibitor), the overall rate of curing of the photoactive resin in the photoinitiation layer 430 and/or the photoinhibition layer 434 may be controlled. This process can thus be used to prevent curing from occurring at the film of the viscous liquid-print window interface and control the rate at which curing of the photoactive resin takes place in the direction normal to the film of the photoactive resin-print window interface.

A thickness of the photoinitiation layer, the photoinhibition layer, or both may be adjusted by adjusting an intensity and duration of the photoinitiation light, the photoinhibition light, or both. The thickness of the photoinitiation layer, the photoinhibition layer, or both may be adjusted to adjust the thickness of the printed layer of the at least the portion of the 3D object. Alternatively or in addition to, the thickness of the photoinitiation layer, the photoinhibition layer, or both may be adjusted by adjusting the speed at which the build head moves away in a direction away from the print window.

The green part corresponding to at least a portion of the thermal management device may comprise a binder. The binder may be any compound or resin that retains or partially retains the plurality of particles comprising the green part in a shape corresponding to the thermal management device or a portion of the thermal management device. The green part may comprise a polymeric material. The polymeric material may be a polymer (or polymeric) matrix. The polymeric material may be created by polymerizing monomers into the polymeric material and/or cross-linking oligomers into the polymeric material, as described in further detail elsewhere herein. The polymeric material may encapsulate the plurality of particles in the green part.

The green part corresponding to at least the portion of the thermal management device may be fabricated using the three-dimensional (3D) printing system disclosed herein. The green part corresponding to at least the portion of the thermal management device may be heated at a processing temperature to sinter at least a portion of the plurality of particles and to burn off at least a portion of other components (i.e., organic components). Sintering may involve using heat to fuse one or more of a plurality of particles together at one or more grain boundaries between one or more of the plurality of particles in the green part. Sintering may involve using heat to close one or more pores or a porous network created in a green part during de-binding. Alternatively, sintering may involve using heat to remove at least a portion of a polymeric material or a binder remaining in the green part after de-binding and/or pre-sintering. The heat for sintering may be supplied by a light source. Examples of a light source may include lamps, torches, lasers, light emitting diodes (LEDs), super luminescent diodes (SLDs), gas-filled tubes such as fluorescent bulbs, or any other equipment capable of producing a stream of photons. A light source may emit electromagnetic waves with a wavelength ranging from about 200 nm to about 700 nm. A light source may include sources of ultraviolet light. The light source used for sintering may be located external to the green part. Alternatively, the heat for sintering may be supplied by a source of thermal energy. Examples of a source of thermal energy may include lamps, torches, lasers, heaters, furnaces, or an open flame. A furnace may be an enclosed chamber with heat energy supplied by fuel combustion, electricity, conduction, convection, induction, radiation, or any combination thereof. The source of thermal energy may generate thermal energy through resistive heating. Resistive heating may include heating achieved by passing an electrical current through a material. The material may be a conducting material with a resistance property that may impede the movement of electrons through the material or cause electrons to collide with each other, thereby generating heat. The source of thermal energy may generate thermal energy through induction heating. Induction heating may involve the use of electromagnetic induction to generate electrical currents inside a conducting material. The electrical currents may flow through the conducting material and generate thermal energy by resistive heating. The source of thermal energy may generate thermal energy through dielectric heating. Dielectric heating may involve the use of radio wave or microwave electromagnetic radiation to cause the rotation of molecules within a material. The source of thermal energy may be a processing chamber. The temperature of the processing chamber may be regulated with any source of thermal energy disclosed herein. The processing chamber may be an oven or a furnace. The oven or furnace may be heated with various heating approaches, such as resistive heating, convective heating and/or radiative heating. Examples of the furnace include an induction furnace, electric arc furnace, gas-fired furnace, plasma arc furnace, microwave furnace, and electric resistance furnace. Such heating may be employed at a fixed or variating heating rate from an initial temperature to a target temperature or temperature range. The source of thermal energy used for sintering may be located external to the green part.

The processing temperature (i.e., the sintering temperature) for sintering the green part corresponding to the thermal management device (including the metal and/or intermetallic particles) may range between about 300 degrees Celsius to about 2200 degrees Celsius. The processing temperature for sintering the green part may be at least about 300 degrees Celsius, 350 degrees Celsius, 400 degrees Celsius, 450 degrees Celsius, 500 degrees Celsius, 550 degrees Celsius, 600 degrees Celsius, 650 degrees Celsius, 700 degrees Celsius, 750 degrees Celsius, 800 degrees Celsius, 850 degrees Celsius, 900 degrees Celsius, 950 degrees Celsius, 1000 degrees Celsius, 1050 degrees Celsius, 1100 degrees Celsius, 1150 degrees Celsius, 1200 degrees Celsius, 1250 degrees Celsius, 1300 degrees Celsius, 1350 degrees Celsius, 1400 degrees Celsius, 1450 degrees Celsius, 1500 degrees Celsius, 1550 degrees Celsius, 1600 degrees Celsius, 1700 degrees Celsius, 1800 degrees Celsius, 1900 degrees Celsius, 2000 degrees Celsius, 2100 degrees Celsius, 2200 degrees Celsius, or more. The processing temperature for sintering the green part (including the particles) may be at most about 2200 degrees Celsius, 2100 degrees Celsius, 2000 degrees Celsius, 1900 degrees Celsius, 1800 degrees Celsius, 1700 degrees Celsius, 1600 degrees Celsius, 1550 degrees Celsius, 1500 degrees Celsius, 1450 degrees Celsius, 1400 degrees Celsius, 1350 degrees Celsius, 1300 degrees Celsius, 1250 degrees Celsius, 1200 degrees Celsius, 1150 degrees Celsius, 1100 degrees Celsius, 1050 degrees Celsius, 1000 degrees Celsius, 950 degrees Celsius, 900 degrees Celsius, 850 degrees Celsius, 800 degrees Celsius, 750 degrees Celsius, 700 degrees Celsius, 650 degrees Celsius, 600 degrees Celsius, 550 degrees Celsius, 500 degrees Celsius, 450 degrees Celsius, 400 degrees Celsius, 350 degrees Celsius, 300 degrees Celsius, or less.

During sintering of the green part comprising the plurality of particles, the temperature of the processing chamber may change at a rate ranging between about 0.1 degrees Celsius per minute (degrees Celsius/min) to about 200 degrees Celsius/min. The temperature of the processing chamber may change at a rate of at least about 0.1 degrees Celsius/min, 0.2 degrees Celsius/min, 0.3 degrees Celsius/min, 0.4 degrees Celsius/min, 0.5 degrees Celsius/min, 1 degrees Celsius/min, 2 degrees Celsius/min, 3 degrees Celsius/min, 4 degrees Celsius/min, 5 degrees Celsius/min, 6 degrees Celsius/min, 7 degrees Celsius/min, 8 degrees Celsius/min, 9 degrees Celsius/min, 10 degrees Celsius/min, 20 degrees Celsius/min, 50 degrees Celsius/min, 100 degrees Celsius/min, 150 degrees Celsius/min, 200 degrees Celsius/min, or more. The temperature of the processing chamber may change at a rate of at most about 200 degrees Celsius/min, 150 degrees Celsius/min, 100 degrees Celsius/min, 50 degrees Celsius/min, 20 degrees Celsius/min, 10 degrees Celsius/min, 9 degrees Celsius/min, 8 degrees Celsius/min, 7 degrees Celsius/min, 6 degrees Celsius/min, 5 degrees Celsius/min, 4 degrees Celsius/min, 3 degrees Celsius/min, 2 degrees Celsius/min, 1 degrees Celsius/min, 0.5 degrees Celsius/min, 0.4 degrees Celsius/min, 0.3 degrees Celsius/min, 0.2 degrees Celsius/min, 0.1 degrees Celsius/min, or less.

Sintering the green part comprising the plurality of particles may involve holding at a fixed temperature between room temperature and the processing temperature for a time ranging between about 1 min to about 240 min. The sintering process may comprise holding at a fixed temperature for at least about 10 min, 20 min, 30 min, 40 min, 50 min, 60 min, 90 min, 120 min, 150 min, 180 min, 210 min, 240 min, or more. The sintering process may comprise holding at a fixed temperature for at most about 240 min, 210 min, 180 min, 150 min, 120 min, 90 min, 60 min, 50 min, 40 min, 30 min, 20 min, 10 min, 1 min, or less. During the sintering process, the temperature may not be held at a processing temperature for an extended period of time (e.g., once a target temperature is reached, the temperature may be reduced). In an example, the sintering process may increase the temperature to a first temperature and immediately (e.g., without holding at the first temperature for a period of time) lower the temperature to a second temperature that is lower than the first temperature.

Prior to sintering the plurality of particles, the green part may be treated (e.g., immersed, jetted, etc.) with a solvent (liquid or vapor). The solvent may be an extraction solvent. The extractable material may be soluble in the solvent. A first solubility of the extractable material in the solvent may be higher than a second solubility of the polymeric material in the solvent. The solvent may be a poor solvent for the polymeric material. Thus, treating the green part with the solvent may solubilize and extract at least a portion of the extractable material out of the green part into the solvent, and create one or more pores in the at least the portion of the 3D object. The one or more pores may be a plurality of pores. The green part may be treated with the solvent and heat at the same time. The one or more pores may create at least one continuous porous network in the at least the portion of the 3D object. Such process may be a solvent de-binding step.

The green part corresponding to the thermal management device may undergo de-binding prior to sintering. De-binding may include, for example, using heat to evaporate the polymeric material or at least a portion of the polymeric material that encapsulates the plurality of particles in the green part. Alternatively, de-binding may involve using heat to solubilize or vaporize at least a portion of the polymeric material and/or binder in the green part. Solubilizing may involve the use of heat to remove at least a portion of the polymeric material or binder from the green part in a liquid form. Vaporizing may involve the use of heat to remove at least a portion of the polymeric material or binder from the green part in gas or vapor form. De-binding the green part by solubilizing or vaporizing at least a portion of the polymeric material or binder in the green part may create one or more pores in at least a portion of the green part. The one or more pores may create a continuous porous network in at least a portion of the green part. De-binding may involve using heat to decompose the polymeric material and/or binder in the green part. Decomposing the polymeric material and/or binder in the green part may involve using heat to remove at least a portion of the polymeric material and/or binder from the green part in a gas, liquid, or vapor form. Decomposing the polymeric material and/or binder may involve removing at least a portion of the polymeric material and/or binder through the one or more pores in the green part. Decomposing and/or de-binding the polymeric material and/or binder may involve using heat to remove at least a portion of the green part that does not include the plurality of particles.

The green part corresponding to the thermal management device may undergo pre-sintering prior to sintering. Pre-sintering may involve using heat to remove at least a portion of the polymeric material or binder from the green part in part through one or more pores in the green part. Pre-sintering may involve using heat to partially fuse one or more of a plurality of particles together at one or more grain boundaries between the one or more of the plurality of particles in the green part. Alternatively, pre-sintering may involve using heat to partially close one or more pores or a porous network created in a green part during de-binding. Pre-sintering may occur at a pre-sintering temperature. The pre-sintering temperature may be less than a sintering temperature. A sintering temperature may be a temperature at which one or more of a plurality of particles in a green part can fuse together at one or more grain boundaries between the one or more of the plurality of particles in the green part. The sintering temperature may be less than one or more melting temperatures of the one or more of the plurality of particles in a green part.

The three-dimensional (3D) printing system 400 of FIG. 4 may be configured to implement a method for fabricating the thermal management devices disclosed herein. The method may comprise providing a deposition head adjacent to an open platform comprising a print window. The deposition head may be movable across the open platform. The deposition head may comprise a nozzle in fluid communication with a source of a viscous liquid comprising a plurality of particles for printing the thermal management device. The viscous liquid may be a photoactive resin. The deposition head may comprise a wiper.

The method may comprise moving the deposition head across the open platform and dispensing the viscous liquid through the nozzle to deposit a film of the viscous liquid over the print window. The deposition head may be configured to dispense and/or deposit the viscous liquid in a configuration such that a green part generated by photopolymerization of the viscous liquid corresponds to the shape and/or the size of the thermal management device, a portion of the thermal management device, a fin of the thermal management device, a portion of the fin, a heat pipe of the thermal management device, a portion of the heat pipe, the vapor chamber of the thermal management device, and/or a portion of the vapor chamber. A green part may be a part that holds a plurality of particles together before the plurality of particles are fused together (e.g., through sintering) to create a 3D object (e.g., the thermal management device) comprising the plurality of particles. The green part may not be the final 3D object (i.e., further processing may be needed to generate the 3D object from the green part or a derivative of the green part). The green part may correspond to the size and/or the shape of a 3D object (e.g., a thermal management device) or a portion of the 3D object. The green part may be printed using stereolithography (SLA) and/or by photopolymerization of at least a portion of a film of a viscous liquid (e.g., a resin) that is deposited over a print window. The green part may correspond to the shape and/or size of the thermal management device or may correspond to the shape and/or size of a portion of the thermal management device. The green part may have the same shape and/or dimensions as the thermal management device or a portion of the thermal management device. The green part may have a similar shape to the thermal management device and dimensions that are proportional to the dimensions of the thermal management device or a portion of the thermal management device.

The method may comprise directing light through a print window of the three-dimensional (3D) printing system to the film of the viscous liquid to cure the photoactive resin in at least a portion of the film, thereby printing at least a portion of the thermal management device (e.g., a fin of the thermal management device, a portion of the fin, a heat pipe of the thermal management device, a portion of the heat pipe, a vapor chamber of the thermal management device, and/or a portion of the vapor chamber). The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing of the resin corresponds to the size and/or the shape of the thermal management device or a portion of the thermal management device.

The method may further comprise configuring the wiper to be in contact with the print window, and using the wiper to reduce or inhibit flow of the viscous liquid out of the deposition head while moving the deposition head to deposit the film.

The method may further comprise positioning the wiper at a distance away from the print window, and using the wiper to flatten the film of the viscous liquid into a desired thickness while moving the deposition head. The desired thickness of the film of the viscous liquid may be substantially the same as the distance between the wiper and the print window. The distance between the wiper and the print window may be adjustable. Thus, the thickness of the film of the viscous liquid may be adjustable. The thickness of the film may be adjusted to control a thickness of the at least the portion of the 3D object. In some cases, after printing the at least the portion of the 3D object, the method may further comprise moving the deposition head cross the open platform in a first direction, and using the wiper of the deposition head that is in contact with the print window to remove any excess of the viscous liquid from the print window. Furthermore, in some cases, the deposition head may further comprise an additional wiper. After moving the deposition head in the first direction and using the wiper to remove the excess of the viscous liquid from the print window, the method may further comprise moving the deposition head in the second direction opposite of the first direction and using the additional wiper to collect the excess of the viscous liquid between the additional wiper and the wiper within the deposition head.

The excess of the viscous liquid may be collected and used (recycled) to deposit an additional film of the viscous liquid over the print window. In some cases, if a volume of the excess of viscous liquid collected by the deposition head is not sufficient to deposit the additional film, the nozzle of the deposition head may dispense more viscous liquid into the collected excess of viscous liquid. In an example, the controller may use a computer model of the 3D object, such as a computer-aided design (CAD) stored in a non-transitory computer storage medium, to determine theoretical amounts of (i) the viscous liquid used in a first printing step and (ii) the excess of the viscous liquid remaining on the print window. The controller may also use the computer model of the 3D object to determine a theoretical amount of the viscous liquid needed to deposit a film of the viscous liquid for the second printing step. If the volume of the collected excess of viscous liquid is not sufficient for the second printing step, the controller may direct the nozzle to dispense more viscous liquid. The system may comprise a repository (e.g., vat or container) adjacent to the open platform. After each printing step, the deposition head may move to the repository and collect the excess viscous liquid into the repository. The collected excess viscous liquid may be reprocessed and used for printing.

The deposition head may be coupled to a motion stage adjacent to the open platform. Thus, the method may comprise moving the motion stage to move the deposition head across the open platform to at least deposit the film of the viscous liquid on the print window. The open platform may have different shapes (e.g., rectangle or ring), and movement of the motion stage may have different shapes. The motion stage may move linearly, thereby directing the deposition head in a first direction and/or in a second direction that is opposite to the first direction. The motion stage may move circularly, thereby direction the deposition clockwise and/or counterclockwise.

The method may comprise providing a build head for holding at least a portion of the 3D object during fabrication. Prior to directing the light through the print window and to the film of the viscous liquid, the method may further comprise moving the build head towards the print window and bringing in contact with the film of the viscous liquid. Subsequent to directing the light to cure at least a portion of the photoactive resin in the film of viscous liquid between the print window and the build head, the method may further comprise moving the build head in a direction away from the print window.

The method may comprise moving the build head in the direction away from the window while forming the 3D object. The rate of movement of the build head may be controlled to adjust a thickness of one or more layers in the 3D object. A surface of the build head in contact with a first layer of the 3D object may be smooth, knurled, or serrated to adjust contact surface area and/or frictional force between the surface and the first layer of the 3D object. Alternatively or in addition to, the first layer of the 3D object may be a support layer for the 3D object that may be removed post-processing.

The method may comprise using a plurality of viscous liquids for printing the 3D object. In some cases, the method may comprise providing an additional deposition head comprising an additional nozzle. The additional nozzle may be in fluid communication with an additional source of an additional viscous liquid. The method may further comprise moving the additional deposition head across the open platform and depositing a film of the additional viscous liquid over the print window. In some cases, the method may comprise providing the additional source of the additional viscous liquid that is in fluid communication with the nozzle of the deposition head. The method may further comprise dispensing the additional viscous liquid through the nozzle to the print window during printing. Alternatively or in addition to, the method may comprise providing the additional source of the additional viscous liquid that is in fluid communication with an additional nozzle in the deposition head. The method may further comprise dispensing the additional viscous liquid through the additional nozzle to the print window during printing.

The method may comprise providing a cleaning zone adjacent to the open platform. The method may further comprise moving the deposition head to the cleaning zone and activating the cleaning zone to clean the deposition head. The deposition head may be cleaned prior to depositing a new film of the viscous liquid. The deposition head may be cleaned subsequent to printing at least a portion of the 3D object.

The method may comprise providing a sensor (e.g., an optical profilometer) adjacent to the open platform. The method may further comprise moving the sensor across the open platform and using the sensor to measure a thickness of at least a portion of the film of the viscous liquid prior and/or subsequent to printing at least a portion of the 3D object. The sensor may be configured to detect an irregularity in the thickness and/or a defect (e.g., a hole) in the film of the viscous liquid. The sensor may be configured to alert the controller to direct the deposition head to clean the print window and re-deposit the film of the viscous liquid.

The method may comprise providing a transparent film adjacent to the print window. The transparent film may cover the print window. The transparent film may comprise one or more fluoropolymers that reduce adhesion of a cured portion of the viscous liquid on the transparent film. The method may further comprise directing the light through the print window, through the transparent film, and to the film of the viscous liquid to cure the photoactive resin in the at least the portion of the film of the viscous liquid, thereby printing at least a portion of the 3D object.

The method may comprise using a plurality of wavelengths of light for printing at least a portion of the 3D object (e.g., a portion of the thermal management device, a fin of the thermal management device, a portion of the fin, a heat pipe of the thermal management device, a portion of the heat pipe, the vapor chamber of the thermal management device, and/or a portion of the vapor chamber). The method may comprise directing the light comprising a first wavelength to cure the photoactive resin in a first portion of the film of the viscous liquid. The light comprising the first wavelength may activate at least one photoinitiator to initiate curing of polymeric precursors into a polymeric material to form the least the portion of the 3D object. The photoactive resin and/or the polymeric precursors may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device.

The method may further comprise directing an additional light having a second wavelength to inhibit curing of the photoactive resin in a second portion of the film of the viscous liquid. The first wavelength and the second wavelength may be different. The additional light having a second wavelength may activate at least one photoinhibitor to inhibit curing of the polymeric precursors into the polymeric material in the second portion of the film adjacent to the print window.

The method may comprise providing the light comprising the first wavelength using an optical source. The method may comprise providing the additional light comprising the second wavelength using an additional optical source. In some cases, the method may comprise providing a light comprising a first wavelength and an additional light comprising a second wavelength using the same optical source.

The method may comprise adjusting a position of the additional optical source independently and relative to a position of the optical source. In some cases, the method may further comprise providing a light platform to hold the additional optical source. In other cases, the method may further comprise, prior to curing the photoactive resin in the first portion of the film of the viscous liquid, moving the light platform relative to the print window and yielding a uniform projection of the additional light within the second portion of the film of the viscous liquid adjacent to the print window.

The three-dimensional (3D) printing system may be configured to implement a method for printing the thermal management device. The method may comprise providing a resin (e.g., a viscous liquid) adjacent to a build surface (e.g., the open platform comprising the print window). The resin may be provided (i.e., deposited or dispensed) in a configuration such that a green part generated by photopolymerization of the viscous liquid corresponds to a portion of the thermal management device, a fin of the thermal management device, a portion of the fin, a heat pipe of the thermal management device, a portion of the heat pipe, the vapor chamber of the thermal management device, and/or a portion of the vapor chamber. The resin may comprise a polymeric precursor. The resin may comprise at least one photoinitiator that is configured to initiate formation of a polymeric material from the polymeric precursor. The resin may comprise at least one photoinhibitor that is configured to inhibit formation of the polymeric material from the polymeric precursor. The resin may comprise a plurality of particles (e.g., metallic, intermetallic, and/or ceramic particles) for forming at least a portion of the 3D object.

The method may comprise exposing the resin (e.g., the viscous liquid) to a first light under conditions sufficient to cause the at least one photoinitiator to initiate formation of the polymeric material from the polymeric precursor. The polymeric material may encapsulate the plurality of particles. The plurality of particles encapsulated in the polymeric material may be usable for forming at least a portion the 3D object (e.g., a fin, a portion of the fin, a heat pipe, a portion of the heat pipe, a vapor chamber, and/or a portion of the vapor chamber). The resin and/or the polymeric precursors of the resin may be cured in a manner and/or a configuration such that the portion of the film of the viscous liquid that is cured corresponds to the size and/or the shape of the thermal management device or a portion of the thermal management device. The photoactive resin and/or the polymeric precursors may be cured in a manner and/or a configuration such that a resulting green part generated by photopolymerization or curing corresponds to the size and/or the shape of the thermal management device or a portion of the thermal management device. In some cases, the method may comprise exposing the resin to a second light under conditions sufficient to cause the at least one photoinhibitor to inhibit formation of the polymeric material adjacent to the build surface.

The method may further comprise repeating, one or more times, (a) providing the resin to the build surface and (b) exposing the resin to (i) the first light to initiate formation of the polymeric material in and (ii) the second light to inhibit formation of the polymeric material adjacent to the build surface. The first light may comprise a first wavelength and the second light may comprise a second wavelength. The first and second wavelengths may be different. The first wavelength may be sufficient to activate the at least one photoinitiator, and the second wavelength may be sufficient to activate the at least one photoinhibitor. The first light may be a photoinitiation light, and the second light may be a photoinhibition light.

The method may further comprise providing a build head adjacent to the build surface. The at least the portion of the 3D object may be formed adjacent to the build head. Additional portions of the 3D object may be formed adjacent to the at least the portion of the 3D object on the build head. During formation of the 3D object, the build head may be moved along a direction away from the build surface. The controller operatively coupled to the build head may be used to adjust a relative distance between the build head and the build surface, thereby adjusting a thickness of a photoinhibition layer within the resin adjacent to the build surface, a photoinitiation layer between the photoinhibition layer and the build head, or both.

The build surface may comprise an optically transparent window. Accordingly, the method may comprise exposing the resin to the photoinitiation light and/or the photoinhibition light through the optically transparent window.

The polymeric precursor of the resin may comprise monomers. Accordingly, the method may comprise exposing the resin to the first light to induce polymerization of the monomers to generate the polymeric material. Alternatively or in addition to, the polymeric precursor of the resin may comprise oligomers. Accordingly, the method may comprise exposing the resin to the first light to induce cross-linking between the oligomers to generate the polymeric material.

The resin may further comprise at least one dye (e.g., an ultraviolet (UV) absorber) configured to absorb the second light (the photoinhibition light). Accordingly, the method may comprise exposing the resin to the second light to initiate the at least one dye to reduce an amount of the second light exposed to the at least one photoinhibitor in at least a portion of the resin.

Once the at least the portion of the thermal management device is printed (herein referred to as a green part), the method may further comprise removing the green part from the build head. The green part may be separated from the build head by inserting a thin material (e.g. a steel blade) between the green part and the build head. A first layer of the green part that is in contact with the build head may not comprise the plurality of particles for easy removal from the build head by the thin material. The method may further comprise washing the green part. The green part may be washed by jetting a solvent (e.g., isopropanol) to remove any excess polymeric precursor.

The method may further comprise subjecting the green part comprising the polymeric material to heating (e.g., in a furnace), to thereby heat at least the plurality of particles encapsulated in the at least the polymeric material. The heating may be under conditions sufficient to sinter the plurality of particles to form a final product that is at least a portion of a 3D object or an entire 3D object. During heating (e.g., sintering), the organic components (e.g., the polymeric material, additives, etc.) may decompose and leave the green part. At least a portion of the decomposed organic components may leave the green part in a gas or vapor phase.

The green part may be heated in a processing chamber. The temperature of the processing temperature may be regulated with at least one heater. The processing chamber may be an oven or a furnace. The oven or furnace may be heated with various heating approaches, such as resistive heating, convective heating and/or radiative heating. Examples of the furnace include an induction furnace, electric arc furnace, gas-fired furnace, plasma arc furnace, microwave furnace, and electric resistance furnace. Such heating may be employed at a fixed or variating heating rate from an initial temperature to a target temperature or temperature range.

The green part corresponding to at least a portion of the thermal management device may be heated from room temperature to a processing temperature. The processing temperature may be kept constant or substantially constant for a given period of time, or may be adjusted to one or more other temperatures. The processing temperature may be selected based on the material of the particles in the green part (e.g., the processing temperature may be higher for material having a higher melting point than other materials). The processing temperature may be sufficient to sinter but not completely melt the particles in the green part. As an alternative, the processing temperature may be sufficient to melt the particles in the green part.

During sintering of the green part comprising the plurality of particles (e.g. metal, intermetallic, and/or ceramic), the green part may be subjected to cooling by a fluid (e.g., liquid or gas). The fluid may be applied to the green part and/or the processing chamber to decrease the temperature of the green part. The fluid may be subjected to flow upon application of positive or negative pressure. Examples of the fluid for cooling the green part include water, oil, hydrogen, nitrogen, argon, etc. Cooling the green part during the sintering process may control grain size within the sintered part.

In some cases, the resin may further comprise an extractable material (e.g., a binder). Accordingly, the method may comprise additional steps of treating the green part (e.g., de-binding and/or pre-sintering) prior to subjecting the green part to heating (e.g., sintering).

The extractable material may be soluble in the polymeric precursor and/or dispersed throughout the rein. Accordingly, the method may comprise curing the polymeric precursor of the resin in at least a portion of the resin, thereby creating a first solid phase comprising the polymeric material and a second solid phase comprising the extractable material within at least a portion of the 3D object (e.g., the thermal management device). Such method may be a polymerization-induced phase separation (PIPS) process. The plurality of particles (e.g., metallic, intermetallic, and/or ceramic particles) may be encapsulated by the first solid phase comprising the polymeric material. The at least the portion of the 3D object may be a green part that can undergo heating to sinter at least a portion of the plurality of particles and burn off at least a portion of other components (i.e., organic components).

The extractable material may be soluble in a solvent (e.g., isopropanol). The solvent may be an extraction solvent. A first solubility of the extractable material in the solvent may be higher than a second solubility of the polymeric material in the solvent. The solvent may be a poor solvent for the polymeric material. Accordingly, the method may further comprise (i) treating (e.g., immersed, jetted, etc.) the green part with the solvent (liquid or vapor), (ii) solubilizing and extracting at least a portion of the extractable material from the second solid phase of the green part into the solvent, and (iii) generating one or more pores in the green part. The one or more pores in the green part may be a plurality of pores. The one or more pores may create at least one continuous porous network in the green part. In some cases, the method may further comprise treating the green part with the solvent and heat at the same time. Such a process may be a solvent de-binding process.

The solvent for the solvent de-binding process may not significantly swell the polymeric material in the green part. In some cases, the viscous liquid may comprise acrylate-based polymeric precursors. Since acrylate-based polymers are of intermediate polarity, both protic polar solvents (e.g., water and many alcohols such as isopropanol) and non-polar solvents (e.g., heptane) may be used. Examples of the solvent for the solvent de-binding process include water, isopropanol, heptane, limolene, toluene, and palm oil. On the other hand, intermediate polarity solvents (e.g., acetone) may be avoided.

The solvent de-binding process may involve immersing the green part in a container comprising the liquid solvent. A volume of the solvent may be at least about 2 times the volume of the green part. The volume of the solvent may be at least about 2, 3, 4, 5, 6, 7, 8, 9, 10 times or more than the volume of the green part. The container comprising the liquid solvent and the green part may be heated to a temperature ranging between about 25 degrees Celsius to about 50 degrees Celsius. The container comprising the liquid solvent and the green part may be heated (e.g., a water bath, oven, or a heating unit from one or more sides of the green part) to a temperature of at least about 25 degrees Celsius, 26 degrees Celsius, 27 degrees Celsius, 28 degrees Celsius, 29 degrees Celsius, 30 degrees Celsius, 35 degrees Celsius, 40 degrees Celsius, 45 degrees Celsius, 50 degrees Celsius, or more. The container comprising the liquid solvent and the green part may be heated to a temperature of at most about 50 degrees Celsius, 45 degrees Celsius, 40 degrees Celsius, 35 degrees Celsius, 30 degrees Celsius, 29 degrees Celsius, 28 degrees Celsius, 27 degrees Celsius, 26 degrees Celsius, 25 degrees Celsius, or less. The solvent de-binding process may last between about 0.1 hours (h) to about 48 h. The solvent de-binding process may last between at least about 0.1 h, 0.2 h, 0.3 h, 0.4 h, 0.5 h, 1 h, 2 h, 3 h, 4 h, 5 h, 6 h, 12 h, 18 h, 24 h, 30 h, 36 h, 42 h, 48 h, or more. The solvent de-binding may last between at most about 48 h, 42 h, 36 h, 30 h, 24 h, 18 h, 12 h, 6 h, 5 h, 4 h, 3 h, 2 h, 1 h, 0.5 h, 0.4 h, 0.3 h, 0.2 h, 0.1 h, or less. After the solvent de-binding process, the solvent may be removed and the green part may be allowed to dry. A weight of the green part may be measured before and after the solvent de-binding to determine the amount of material extracted from the green part.

After the solvent de-binding process, the green part may be heated (e.g., sintered) and/or cooled as abovementioned. During heating (e.g., sintering), at least a portion of the organic components (e.g., the polymeric material, additives, etc.) may decompose and leave the green part in part through the at least one continuous porous network. The presence of the at least one continuous porous network from the solvent de-binding step may improve the speed of the sintering process.

Subsequent to sintering the green part, the heated (e.g., sintered) particles as part of a nascent 3D object (e.g., the thermal management device) may be further processed to yield the 3D object. This may include, for example, performing surface treatment, such as polishing, on one or more surfaces of the nascent 3D object.

Other features and elements of the three-dimensional (3D) printing system 400 of FIG. 4 may be as described in U.S. Patent Publication No. 2018-0333911 A1 and U.S. Patent Publication No. 2018-0361666 A1, each of which is entirely incorporated herein by reference.

### Example

In an example, the three-dimensional (3D) printing system 400 of FIG. 4 may be used to print the thermal management device of FIG. 1. Initially, a computer model (e.g., CAD model) of the thermal management device may be obtained in computer memory. The computer model may be sliced or partitioned into a plurality of slices (e.g., a first slice, a second slice, etc.). The plurality of slices may be parallel to a base or a bottom surface of the vapor chamber 101. The plurality of slices may correspond to one or more horizontal cross-sections of the thermal management device or a portion of the thermal management device (e.g., a fin 103 of the thermal management device, a portion of the fin 103, a heat pipe 102 of the thermal management device, a portion of the heat pipe 102, the vapor chamber 101 of the thermal management device, and/or a portion of the vapor chamber 101). The plurality of slices may have a thickness of at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The plurality of slices may have a thickness of at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less.

Next, resin may be deposited on a portion of the print window 402 of the open platform 401. The open platform 401 may be a build platform. After resin is deposited on a portion of the print window 402 of the open platform 401, a build head 410 may be provided. The build head 410 may be configured to hold at least a portion of the thermal management device during fabrication of the thermal management device. The build head 410 may be configured to hold one or more of the plurality of slices corresponding to one or more horizontal cross-sections of the thermal management device or a portion of the thermal management device during fabrication of the thermal management device. Prior to directing a photoinitiation light and/or a photoinhibition light through the print window 402 and to the resin, the build head 410 may be moved towards the print window 402 and brought into contact with the resin.

The resin may be subsequently exposed to a photoinitiation light and/or a photoinhibition light to cure a portion of the resin between the build head 410 and the open platform 401. The cured portion of the resin may correspond to a first slice of the thermal management device. The first slice may be attached to the build head 410. The build head 410 may be moved away from the build platform and any excess (uncured) resin may be removed from the open platform 401.

Next, resin may be applied to a portion of the open platform 401, including the print window 402, and the build head 410 may be moved towards the open platform 401 to a position such that the first slice is in contact with the resin. The resin may be subsequently exposed to a photoinitiation light and/or a photoinhibition light to cure a portion of the resin. The cured portion of the resin may correspond to a second slice of the thermal management device, which may be attached to the first slice.

This process may be repeated until all of the plurality of slices corresponding to a horizontal cross-section of the thermal management device or a portion of the thermal management device have been generated on the build head 410. The plurality of slices may then be removed from the open platform 401 to yield the thermal management device.

### Computer Systems

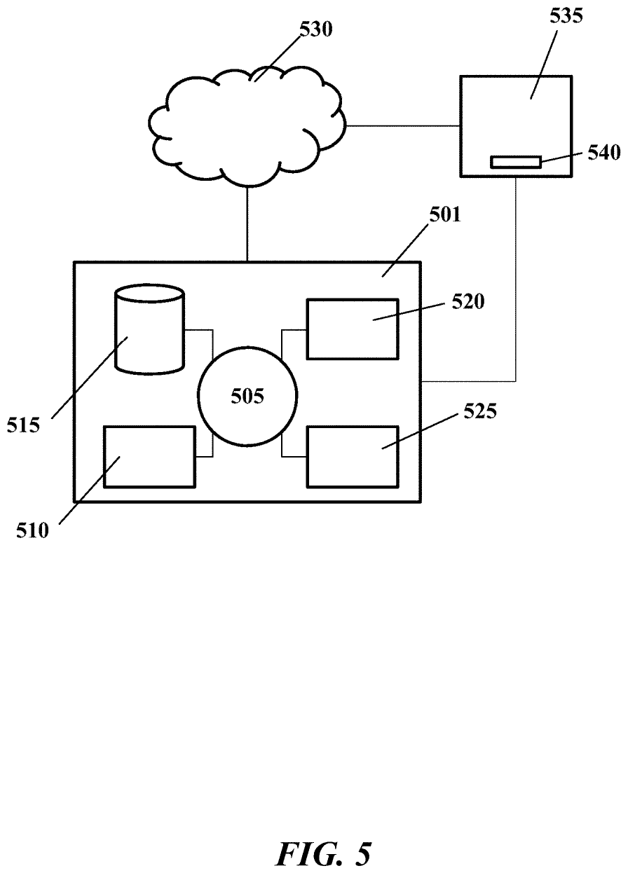

Another aspect of the present disclosure provides computer systems that are programmed or otherwise configured to implement methods for fabricating the thermal management devices disclosed herein. FIG. 5 shows a computer system 501 that is programmed or otherwise configured to implement a method for fabricating the thermal management devices disclosed herein, using one or more additive manufacturing techniques. The computer system 501 may be configured to implement additive manufacturing techniques such as vat photopolymerization, powder bed fusion, material extrusion, material jetting, binder jetting, and/or direct energy deposition to fabricate the thermal management devices disclosed herein. In some cases, the computer system 501 may be configured to implement one or more 3D printing methods, such as direct light processing (DLP), continuous direct light processing (CDLP), stereolithography (SLA), fused deposition modeling (FDM), fused filament fabrication (FFF), selective laser sintering (SLS), material jetting (MJ), nano particle jetting (NPJ), drop on demand (DOD), binder jetting, direct metal laser sintering (DMLS), selective laser melting (SLM), electron beam melting (EBM), multi jet fusion (MJF), direct energy deposition (DED), laser engineered net shaping, and/or electron beam additive manufacturing to fabricate the thermal management devices disclosed herein. The computer system 501 may be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“net-work”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user (e.g., an end user, an engineer, a designer, etc.). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 335 that comprises a user interface (UI) 540 for providing, for example, a portal for monitoring the fabrication of the thermal management devices disclosed herein. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. The algorithm may be configured to control the computer system to implement additive manufacturing techniques such as vat photopolymerization, powder bed fusion, material extrusion, material jetting, binder jetting, and/or direct energy deposition, to fabricate the thermal management devices disclosed herein. In some cases, the algorithm may be configured to control the computer system to implement one or more 3D printing methods, such as direct light processing (DLP), continuous direct light processing (CDLP), stereolithography (SLA), fused deposition modeling (FDM), fused filament fabrication (FFF), selective laser sintering (SLS), material jetting (MJ), nano particle jetting (NPJ), drop on demand (DOD), binder jetting, direct metal laser sintering (DMLS), selective laser melting (SLM), electron beam melting (EBM), multi jet fusion (MJF), direct energy deposition (DED), laser engineered net shaping, and/or electron beam additive manufacturing, to fabricate the thermal management devices disclosed herein.

### Liquid Cooling

In another aspect, the present disclosure provides a thermal management device configured for liquid cooling. The thermal management device configured for liquid cooling may be a liquid cooling device. The liquid cooling device may comprise a plate, an array of fins in thermal contact with a surface of the plate, and a manifold block located adjacent to and/or above the plate.

The three-dimensional (3D) printing system 400 of FIG. 4 may be used to print the liquid cooling device. Initially, a computer model (e.g., a CAD model) of the liquid cooling device may be obtained in computer memory. The computer model may be sliced into a plurality of slices (e.g., a first slice, a second slice, etc.). The plurality of slices can be parallel to a base or a bottom surface of the liquid cooling device. The plurality of slices may correspond to one or more horizontal cross-sections of the liquid cooling device or a portion of the liquid cooling device (e.g., a plate of the liquid cooling device, a portion of the plate, an array of fins of the liquid cooling device, a portion of the array of fins, the manifold block of the liquid cooling device, and/or a portion of the manifold block). The plurality of slices may have a thickness of at least about 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The plurality of slices may have a thickness of at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less.

Next, resin may be deposited on a portion of the print window 402 of the open platform 401. The open platform 401 may be a build platform. After resin is deposited on a portion of the print window 402 of the open platform 401, a build head 410 may be provided. The build head 410 may be configured to hold at least a portion of the liquid cooling device during fabrication of the liquid cooling device. The build head 410 may be configured to hold one or more of the plurality of slices corresponding to one or more horizontal cross-sections of the liquid cooling device or a portion of the liquid cooling device during fabrication of the liquid cooling device. Prior to directing a photoinitiation light and/or a photoinhibition light through the print window 402 and to the resin, the build head 410 may be moved towards the print window 402 and brought into contact with the resin.

The resin may be subsequently exposed to a photoinitiation light and/or a photoinhibition light to cure a portion of the resin between the build head 410 and the open platform 401. The cured portion of the resin may correspond to a first slice of the liquid cooling device. The first slice may be attached to the build head 410. The build head 410 may be moved away from the build platform and any excess (uncured) resin may be removed from the open platform 401.

Next, resin may be applied to a portion of the open platform 401, including the print window 402, and the build head 410 may be moved towards the open platform 401 to a position such that the first slice is in contact with the resin. The resin may be subsequently exposed to a photoinitiation light and/or a photoinhibition light to cure a portion of the resin. The cured portion of the resin may correspond to a second slice of the liquid cooling device, which may be attached to the first slice.

This process may be repeated until all of the plurality of slices corresponding to a horizontal cross-section of the liquid cooling device or a portion of the liquid cooling device have been generated on the build head 410. The plurality of slices may then be removed from the open platform 401 to yield the liquid cooling device.

The liquid cooling device generated by the three-dimensional (3D) printing system of FIG. 4 may be manufactured as a single unitary piece or structure. As such, the liquid cooling device may not require a sealing unit (e.g., an O-ring) between two or more components or two or more sub-components of the liquid cooling device, to prevent a cooling fluid from leaking between the two or more components or the two or more sub-components of the liquid cooling device. The liquid cooling device, as printed, may be substantially uniform, and may not include any seams on a surface of the liquid cooling device and/or any material discontinuities within an internal structure of the liquid cooling device. The liquid cooling device may have a uniform grain structure. The liquid cooling device, as printed, may have substantially ordered grains or grain boundaries.

The single unitary piece or structure may comprise at least one metal (e.g., copper). The single unitary piece or structure may have one or more material properties substantially similar to one or more material properties of bulk copper. The one or more material properties may include, for example, brittleness, bulk modulus, coefficient of restitution, compressive strength, creep, ductility, durability, elasticity, fatigue limit, flexibility, fracture toughness, hardness, malleability, mass diffusivity, plasticity, resilience, shear modulus, shear strength, specific modulus, specific weight, stiffness, tensile strength, toughness, yield strength, Young's modulus, thermal conductivity, thermal diffusivity, thermal expansion, specific heat, melting point, capacitance, electrical resistivity, electrical conductivity, and/or density.

As described above, the liquid cooling device may comprise a plate. The plate may be a hot plate configured to facilitate a transfer of thermal energy from a cooling fluid to the plate. Alternatively, the plate may be a cold plate configured to facilitate a transfer of thermal energy from the plate to a cooling fluid. The plate may be in thermal contact with a source of thermal energy. The plate may be in the shape of a circle, a square, a rectangle, a triangle, a pentagon, a hexagon, a heptagon, an octagon, a nonagon, a decagon, or any polygon with at least three or more sides. The plate may have a horizontal cross-section and/or a vertical cross-section that is circular, triangular, square, rectangular, pentagonal, hexagonal, heptagonal, octagonal, nonagonal, decagonal, or any partial cross-section or combination of cross-sections thereof.

The plate may be positioned adjacent to the source of thermal energy. The source of thermal energy may include a circuit, a computer processor, a plurality of computer processors, a light source (e.g., a lamp, such as an incandescent lamp, a halogen lamp, a carbon arc lamp, or a discharge lamp), a torch, a laser, a heater, a furnace (e.g., an induction furnace, an electric arc furnace, a gas-fired furnace, a plasma arc furnace, a microwave furnace, or an electric resistance furnace), or a hot fluid (e.g., superheated steam). The source of thermal energy may be an object (e.g., a mechanical component, a mechanical structure, and/or a surface of a mechanical component or a mechanical structure) that is in thermal contact with a hot object, such as a circuit, a computer processor, a plurality of computer processors, a light source (e.g., a lamp, such as an incandescent lamp, a halogen lamp, a carbon arc lamp, or a discharge lamp), a torch, a laser, a heater, a furnace (e.g., an induction furnace, an electric arc furnace, a gas-fired furnace, a plasma arc furnace, a microwave furnace, or an electric resistance furnace), or an open flame. The source of thermal energy may include an electronic component (e.g., a circuit board, a computer processor(s), a graphics processing unit, or an application-specific integrated circuit) and/or an object (e.g., a mechanical component, a mechanical structure, and/or a surface of a mechanical component or a mechanical structure) that is in thermal communication with the electronic component such that the object is capable of absorbing and transmitting at least a portion of the thermal energy generated by the electronic component.

The source of thermal energy may generate thermal energy by combustion. The source of thermal energy may generate thermal energy by resistive heating. The source of thermal energy may generate thermal energy through inductive heating. The source of thermal energy may generate thermal energy through dielectric heating.

The thermal energy generated by the source of thermal energy may be transferred from the source of thermal energy to the cold plate and/or a surface of the cold plate using one or more heat transfer mechanisms. The one or more heat transfer mechanisms may include advection, conduction, convection, radiation, and/or any combination thereof.

The cold plate may be configured to facilitate a transfer of thermal energy from a source of thermal energy to a surface of the cold plate. The cold plate may be configured to facilitate the transfer of thermal energy from the source of thermal energy to a bottom surface of the cold plate using conduction. The cold plate may be configured to facilitate the transfer of thermal energy from the bottom surface of the cold plate to a top surface of the cold plate using conduction.

The cold plate may be in thermal contact with an array of fins. The array of fins may be in thermal contact with an upper surface of the cold plate. The array of fins may be configured to facilitate a transfer of said thermal energy from an upper surface of the cold plate to a cooling fluid by advection, conduction, convection, radiation, and/or any combination thereof. The array of fins may comprise a plurality of fins. The fins may be plate fins. The plurality of fins may be configured in a diagonal arrangement of fins.

The cooling fluid may be a liquid and/or a gas. In other cases, the cooling fluid may be a working fluid. The working fluid may be a gas and/or a liquid that is capable of absorbing or transmitting thermal energy. The working fluid may be oxygen, nitrogen, an inert gas (e.g., argon or helium), air, water, ammonia, methanol, ethanol, hydrogen, helium, propane, butane, isobutane, ammonia, sulfur dioxide, or any combination thereof. The working fluid may include one or more chlorofluorocarbons, one or more hydrochlorofluorocarbons, one or more hydrofluorocarbons, and/or one or more fluorocarbons. For example, the working fluid may be trichlorofluoromethane; dichlorodifluoromethane; difluoromethane; pentafluoroethane; chlorotrifluoromethane; chlorodifluoromethane; dichlorofluoromethane; chlorofluoromethane; bromochlorodifluoromethane; 1,1,2-trichloro-1,2,2-trifluoroethane; 1,1,1-trichloro-2,2,2-trifluoroethane; 1,2-dichloro-1,1,2,2-tetrafluoroethane; 1-chloro-1,1,2,2,2-pentafluoroethane; 2-chloro-1,1,1,2-tetrafluoroethane; 1,1-dichloro-1-fluoroethane; 1-chloro-1,1-difluoroethane; tetrachloro-1,2-difluoroethane; tetrachloro-1,1-difluoroethane; 1,1,2-trichlorotrifluoroethane; 1-bromo-2-chloro-1,1,2-trifluoroethane; 2-bromo-2-chloro-1,1,1-trifluoroethane; 1,1-dichloro-2,2,3,3,3-pentafluoropropane; and/or 1,3-dichloro-1,2,2,3,3-pentafluoropropane. The working fluid may be trifluoromethane (HFC-23); difluoromethane (HFC-32); fluoromethane (HFC-41); 2-chloro-1,1,1,2-tetrafluoroethane (HFC-124); 1,1,2,2,2-pentafluoroethane (HFC-125); 1,1,2,2-tetraflu-oroethane (HFC-134); 1,1,1,2-tetrafluoroethane (HFC-134a,); 1,1-difluoroethane (HFC-152a); and/or 1,1,1,2,3,3,3-heptafluoropropane (HFC-227ea). The working fluid may be carbon tetrafluoride; perfluorooctane; perfluoro-2-methylpentane; perfluoro-1,3-dimethylcyclohexane; perfluorodecalin; hexafluoroethane; and/or perfluoromethylcyclohexane. The working fluid may exist in a vapor phase, a gas phase, a liquid phase, or both a gas phase and a liquid phase.

The cold plate may be located adjacent to a manifold block of the liquid cooling device. The manifold block may comprise an inlet, an outlet, and a cooling fluid flow path in fluid communication with the inlet and the outlet.

The cooling fluid flow path may be configured to direct the cooling fluid from a reservoir located external to the manifold block to the inlet of the manifold block. The cooling fluid flow path may be configured to direct the cooling fluid from the inlet through a flow splitter of the manifold block. The flow splitter may be configured to split the cooling fluid into a plurality of streams comprising the cooling fluid, and direct the plurality of streams through the array of fins towards an outer edge of the array of fins. The cooling fluid flow path may be further configured to direct the plurality of streams from the outer edge of the array of fins to the outlet of the manifold block.

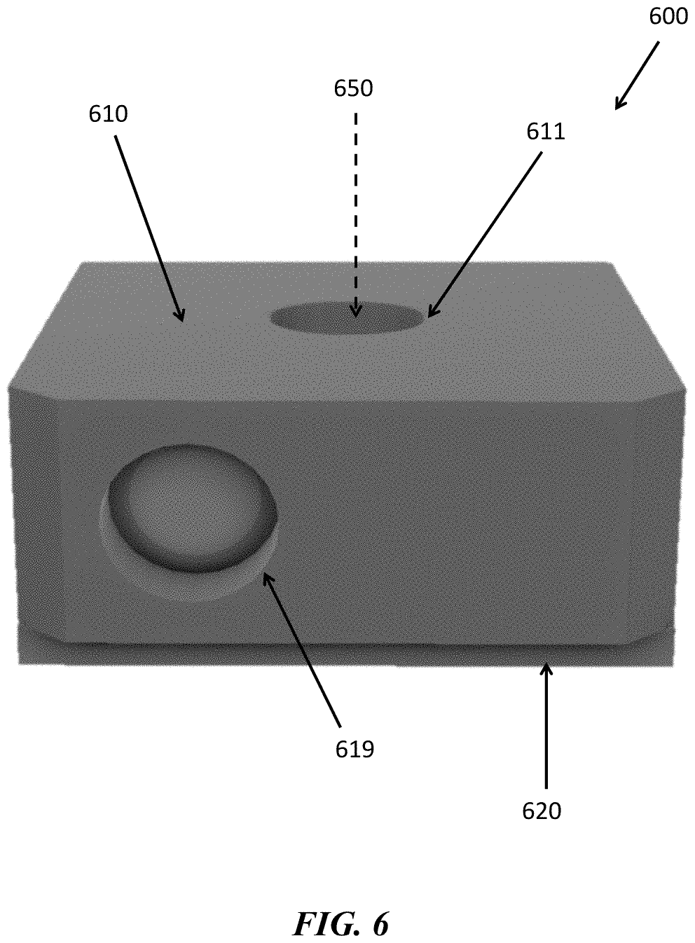

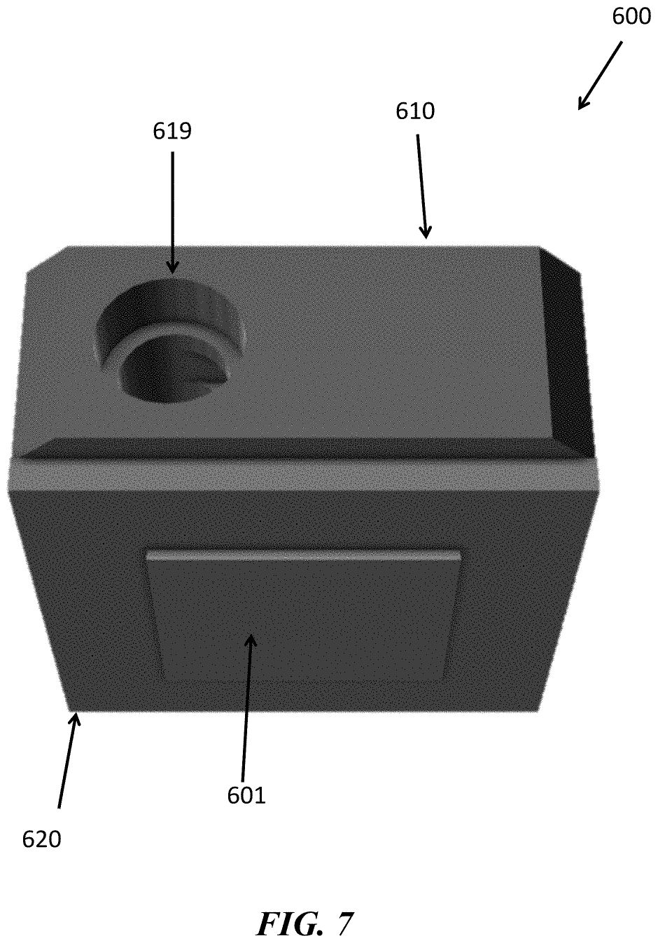

FIG. 6 and FIG. 7 illustrate a liquid cooling device 600 in thermal contact with a source of thermal energy 601. The liquid cooling device 600 may comprise a manifold block 610. The manifold block 610 may comprise an inlet 611 and an outlet 619. The manifold block 610 may be positioned adjacent to and/or on top of a cold plate 620. The manifold block 610 may be configured to direct a cooling fluid along a cooling fluid flow path 650. The cooling fluid flow path 650 may be configured to direct the cooling fluid through the inlet 611, through an internal portion of the manifold block 610, and through the outlet 619 of the manifold block.

As shown in FIG. 7, the liquid cooling device 600 may be configured to draw heat away from a source of thermal energy 601. The source of thermal energy 601 may be in thermal contact with a bottom surface of the cold plate 620. The cold plate 620 may be configured to facilitate a transfer of thermal energy from a bottom surface of the cold plate 620 to a cooling fluid flowing through the manifold block 610. The cold plate 620 may be configured to transfer the thermal energy from the source of the thermal energy 601 to the cooling fluid via an array of fins in thermal contact with an upper surface of the cold plate 620. The cooling fluid may absorb at least a portion of the thermal energy transferred from the source of thermal energy 601 to the upper surface of the cold plate and/or the array of fins in thermal contact with the upper surface of the cold plate, and may exit the manifold block 610 through the outlet 619 of the manifold block 610.

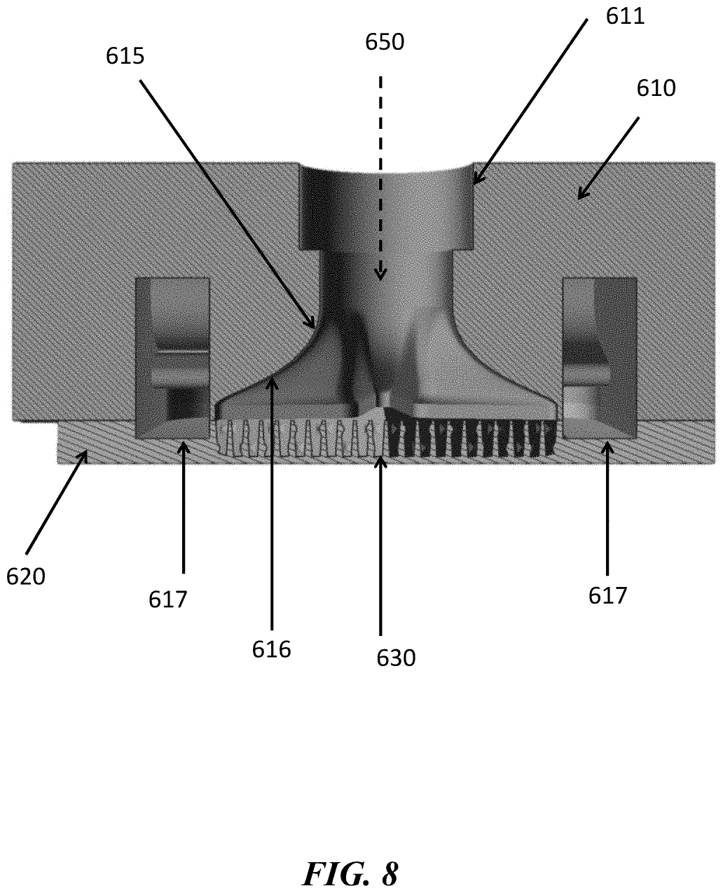

FIG. 8 illustrates an inner portion of the manifold block 610. The manifold block 610 may comprise an inlet 611 and a manifold flow splitter 615. A portion of the manifold block 610 may be located adjacent to and/or above a fluid collection zone 617. The fluid collection zone 617 may be a recessed region formed on an upper surface of the cold plate 620. The inlet 611 of the manifold block 610 may be in fluid communication with the flow splitter 615. The flow splitter 615 may be configured to split a cooling fluid flowing through the inlet 611 of the manifold block into a plurality of streams comprising the cooling fluid. The flow splitter 615 may be configured to direct the plurality of streams comprising the cooling fluid across and/or through an array of fins 630. The plurality of streams may flow across and/or through the array of fins 630 to an outer edge of the array of fins 630. The fluid collection zone 617 may be positioned adjacent to and/or around the outer edge of the array of fins 630 to aggregate at least a portion of the cooling fluid that has flowed across and/or through the array of fins 630 to the outer edge of the array of fins.

Referring to FIG. 8, the cooling fluid flow path 650 may be configured to direct the cooling fluid through the inlet 611 of the manifold block 610, through the flow splitter 615, and across and/or through the array of fins 630. The cooling fluid flow path 650 may be further configured to (i) direct the cooling fluid across and/or through the array of fins 630 to an outer edge of the array of fins 630, (ii) direct the cooling fluid from the outer edge of the array of fins 630 to the fluid collection zone 617 disposed on an upper surface of the cold plate 620, and (iii) direct the cooling fluid up from the fluid collection zone 617 into one or more exit channels within the manifold block 610. The one or more exit channels may be configured to direct the cooling fluid through the outlet of the manifold block 610.

As shown in FIG. 8, the flow splitter 615 may comprise one or more curved surfaces 616 extending outwards from the inlet 611 of the manifold block 610 to an outer edge of the array of fins. Each of the one or more curved surfaces 616 may extend radially outwards from the inlet 611 to an outer edge of the array of fins. Each of the one or more curved surfaces 616 may extend radially outwards in a radial direction. In some cases, a first curved surface 616 may extend in a first radial direction, and a second curved surface 616 may extend in a second radial direction. The first radial direction may be disposed at an angle relative to the second radial direction. The angle may be greater than 0 degrees and less than or equal to 180 degrees. The angle may be greater than 180 degrees and less than or equal to 360 degrees. In some cases, the flow splitter 615 may comprise at least four or more curved surfaces 616 extending in one or more distinct radial directions. The curved surfaces 616 may be configured to (i) split the cooling fluid into a plurality of streams comprising the cooling fluid and (ii) direct at least a portion of one stream of the plurality of streams across and/or through a portion of the array of fins.

The curved surfaces 616 may have a radius of curvature associated with the curved surface 616. The radius of curvature may be at least about 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 100 cm, 200 cm, 300 cm, 400 cm, 500 cm, or more. The radius of curvature may be at most about 500 cm, 400 cm, 300 cm, 200 cm, 100 cm, 50 cm, 40 cm, 30 cm, 20 cm, 10 cm, 9 cm, 8 cm, 7 cm, 6 cm, 5 cm, 4 cm, 3 cm, 2 cm, 1 cm, or less. The curved surfaces 616 may have a same or substantially similar radius of curvature. Alternatively, the curved surfaces 616 may have different radii of curvature.

The curved surfaces 616 may be oriented at an angle relative to one other when viewed from above (i.e., when viewed from a top surface of the manifold block). The angle may be greater than 0 degrees and less than or equal to 90 degrees. The curved surfaces 616 may extends outwards from the inlet of the manifold block to the outer edge of the array of fins along one or more distinct directions. Each of the one or more distinct directions may be oriented at an angle relative to one another. The angle may be greater than 0 degrees and less than or equal to 90 degrees. Each of the one or more distinct directions may correspond to a direction along which at least a portion of the one or more streams may flow before coming into thermal contact with one or more fins of the array of fins.

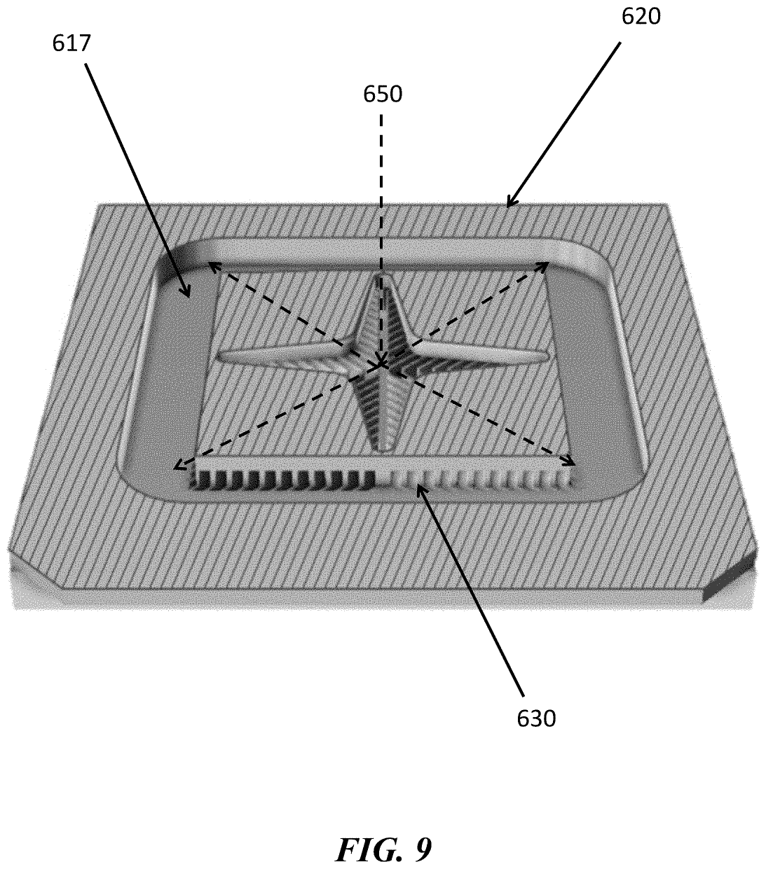

The curved surfaces 616 of the flow splitter 615 may be configured to split a cooling fluid flowing through the inlet 611 into a plurality of streams comprising the cooling fluid. The plurality of streams may comprise at least four or more distinct streams comprising the cooling fluid. Each of the curved surfaces 616 may be configured to direct at least a portion of each respective stream to flow across and/or through a portion of the array of fins. In some cases, the array of fins may comprise a plurality of fins configured in a diagonal arrangement. The plurality of fins may comprise at least four sets of fins comprising two or more parallel fins. Each of the at least four sets of fins may comprise one or more fins that extend from a center of the plate to an outer edge of the plate. As illustrated in FIG. 9, in some cases, a first portion of each of the plurality of streams may flow through and/or across a portion of a first set of fins along a first direction, and a second portion of each of the plurality of streams may flow through and/or across a portion of a second set of fins along a second direction.

The flow splitter may have a horizontal cross-section with a shape configured to split a cooling fluid into a plurality of streams. The shape may have one or more curved edges and/or one or more straight edges. The shape may have at least one, two, three, four, five, six, seven, eight, nine, ten, eleven, twelve, thirteen, fourteen, fifteen, sixteen, seventeen, eighteen, nineteen, twenty, or more sides or edges. The sides or edges may be curved, straight, or a combination thereof. The sides or edges may have different curvatures or dimensions. In some cases, as shown in FIG. 9, the flow splitter may have a horizontal cross-section in a shape of a star. The star may have at least four or more legs with curved ends. The at least four or more legs may be oriented at an angle relative to one another. The angle may be greater than 0 degrees and less than or equal to 90 degrees. The at least four or more legs may extend in one or more distinct directions. Each of the one or more distinct directions may be oriented at an angle relative to one another. The angle may be greater than 0 degrees and less than or equal to 90 degrees. In some cases, the star may have at least four or more legs with ends that are not curved. One or more dimensions of the flow splitter may gradually decrease in size along a height of the manifold block. In other words, a first horizontal cross-section of the flow splitter may have a shape with a first set of dimensions, and a second horizontal cross-section of the flow splitter may have a shape with a second set of dimensions. The second horizontal cross-section of the flow splitter may be closer to the inlet of the manifold block than the first horizontal cross-section of the flow splitter. The second set of dimensions may be less than the first set of dimensions. The shape with the first set of dimensions may be larger than the shape with the second set of dimensions. The shape with the first set of dimensions may be similar to the shape with the second set of dimensions such that the shape with the first set of dimensions has dimensions that are proportional to the dimensions of the shape with the second set of dimensions.

As illustrated in FIG. 8 and FIG. 9, the flow splitter may comprise a plurality of curved surfaces each configured to (i) split at least a portion of the cooling fluid into a plurality of stream, and (ii) direct at least a portion of each stream along one or more distinct directions before coming into physical or thermal contact with at least a portion of the array of fins. The one or more distinct directions may be configured such that a first portion of each of the plurality of streams may flow through and/or across a portion of a first set of fins along a first direction, and a second portion of each of the plurality of streams may flow through and/or across a portion of a second set of fins along a second direction. As shown in greater detail in FIG. 9, a respective width of each curved surface may gradually decrease as the curved surface extends from the inlet of the manifold block to an outer edge of the plate and/or an outer edge of the array of fins.

FIG. 9 further illustrates the fluid collection zone 617 disposed on an upper surface of the plate 620. The fluid collection zone 617 may be configured to collect cooling fluid flowing across and/or through an array of fins 630. The fluid collection zone 617 may be configured to collect at least a portion of the cooling fluid that has flowed through the array of fins 630 to an outer edge of the array of fins. Such portion of the cooling fluid collected at the fluid collection zone 617 may comprise at least a portion of the one or more streams of the cooling fluid, which may be created when the cooling fluid flows through the flow splitter of the manifold block. As shown in FIG. 9, the cooling fluid may flow along a cooling fluid flow path 650. The cooling fluid flow path 650 may be configured to direct the one or more streams of the cooling fluid through different sections and/or quadrants of the array of fins 630. Each section and/or quadrant of the array of fins 630 may be configured to direct one or more of the plurality of streams of the cooling fluid along one or more distinct directions to an outer edge of the array of fins 630 and into the fluid collection zone 617.

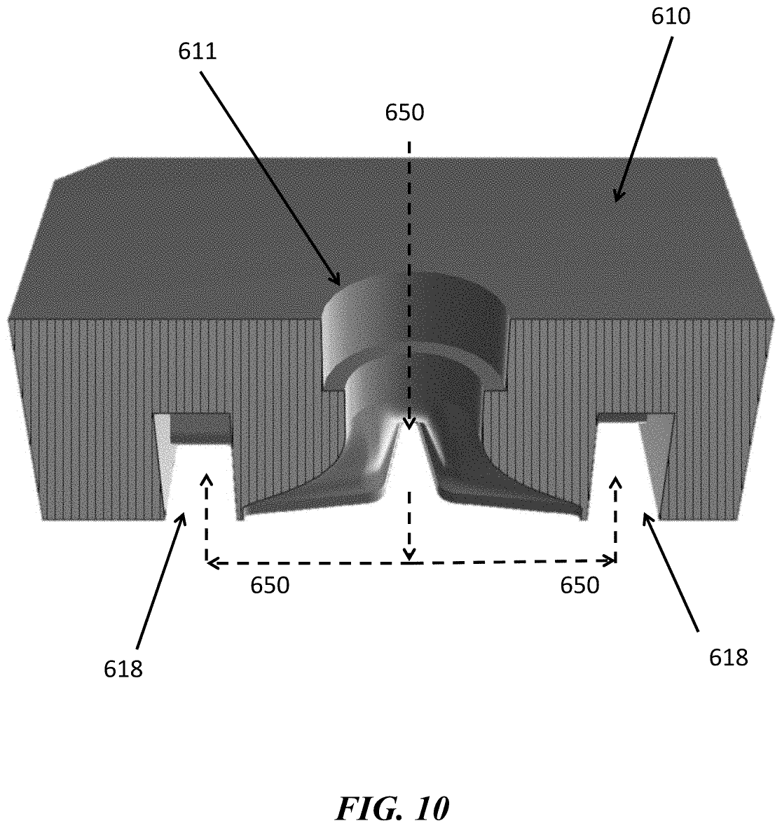

FIG. 10 illustrates an internal cross section of the manifold block 610. The manifold block may comprise an inlet 611 and one or more exit channels 618. The one or more exit channels 618 may be recessed into a body of the manifold block 610. The one or more exit channels 618 may be in fluid communication with the fluid collection zone disposed on an upper surface of the cold plate. The cooling fluid may flow along a cooling fluid flow path 650. The cooling fluid flow path 650 may be configured to direct the cooling fluid through the inlet 611 to the flow splitter. The cooling fluid flow path 650 may be further configured to direct one or more streams of the cooling fluid from the flow splitter to the array of fins disposed on an upper surface of the cold plate. The cooling fluid flow path 650 may be further configured to direct the plurality of streams comprising the cooling fluid through and/or across the array of fins and into a fluid collection zone disposed on an upper surface of the cold plate and located adjacent to an outer edge of the array fins. The cooling fluid flow path 650 may be further configured to direct the cooling fluid from the fluid collection zone into one or more exit channels 618. The one or more exit channels 618 may be in fluid communication with the outlet of the manifold block. The cooling fluid flow path 650 may be further configured to direct the cooling fluid from and/or through the one or more exit channels 618 to the outlet of the manifold block.

As illustrated in FIG. 11, the cooling fluid may flow along a cooling fluid flow path 650 through the inlet 611 of the manifold block, through the flow splitter portion of the manifold block, and across and/or through the array of fins 630. The cooling fluid may flow across and/or through the array of fins 630 to a fluid collection zone 617 disposed on an upper surface of the cold plate. The fluid collection zone 617 may be in fluid communication with one or more exit channels 618. The one or more exit channels 618 may be in fluid communication with the outlet 619 of the manifold block. The cooling fluid flow path 650 may be configured to direct the cooling fluid through the inlet 611, through the flow splitter, and across and/or through the array of fins. The cooling fluid flow path 650 may be configured to direct one or more of the plurality of streams comprising the cooling fluid across and/or through a portion of the array of fins to a fluid collection zone 617 disposed on an upper surface of the cold plate. The cooling fluid flow path 650 may be configured to direct the cooling fluid from the fluid collection zone 617 to the one or more exit channels 618. The cooling fluid flow path 650 may be configured to direct the cooling fluid from the one or more exit channels 618 to the outlet 619 of the manifold block.

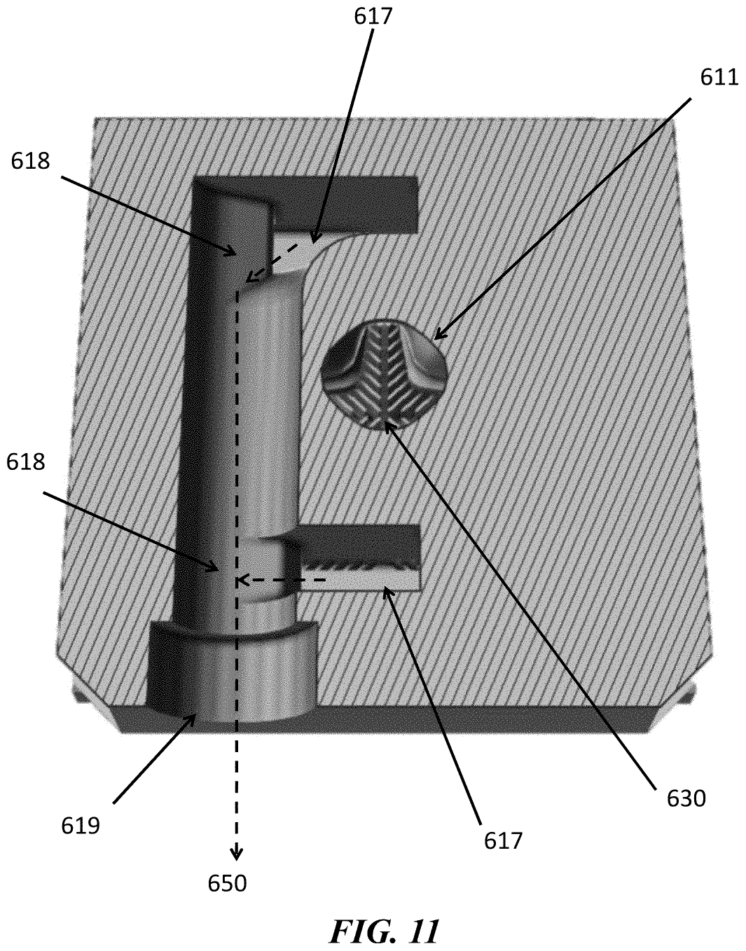

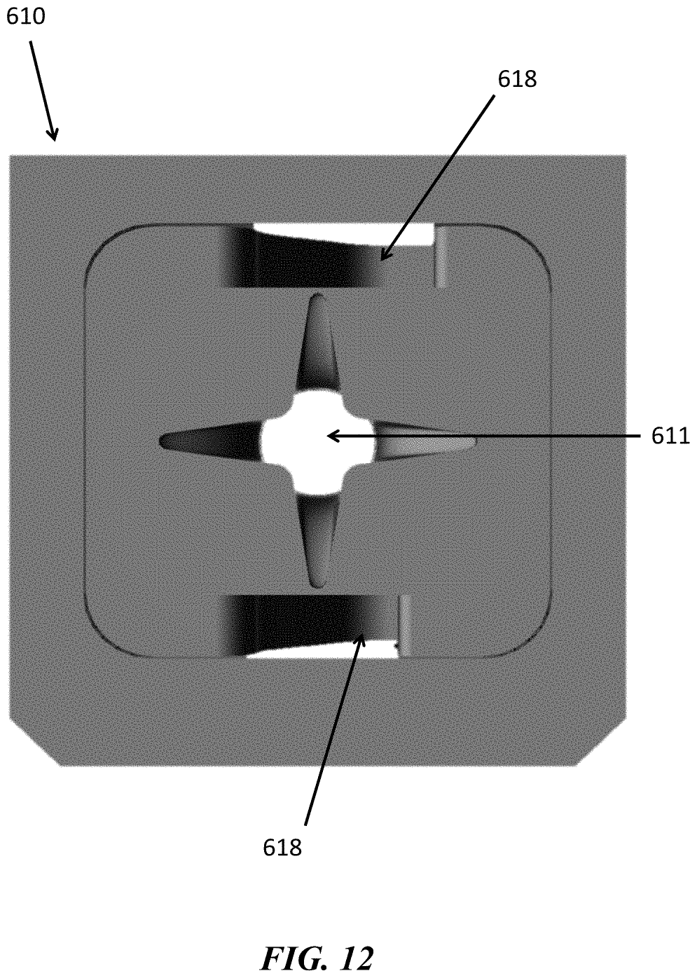

FIG. 12 illustrates a bottom portion of the manifold block 610. The manifold block may comprise an inlet 611 and one or more exit channel 618. The one or more exit channels 618 may be in fluid communication with the inlet 611 via the flow splitter and/or the fluid collection zone. The flow splitter and the fluid collection zone may also be in fluid communication with one another.

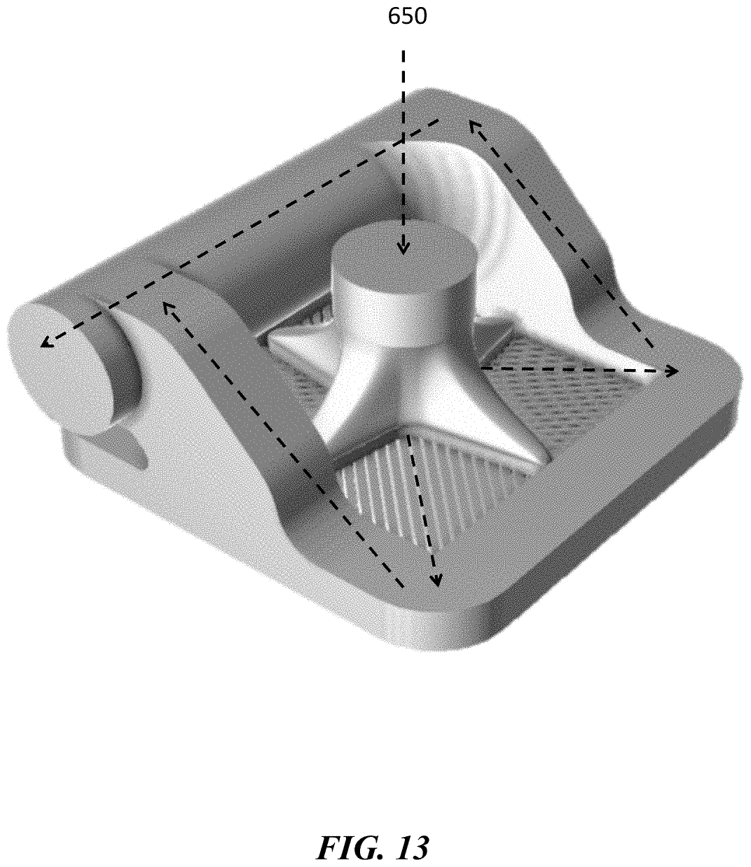

FIG. 13 illustrates the cooling fluid flow path 650 through the liquid cooling device. As described elsewhere herein, the cooling fluid flow path 650 may be configured to direct the cooling fluid through the inlet of the manifold block and through the flow splitter of the manifold block. The flow splitter may be configured to split the cooling fluid flow path 650 into a plurality of separate streams comprising the cooling fluid. The cooling fluid flow path 650 may be further configured to direct the plurality of streams comprising the cooling fluid across and/or through one or more sections and/or quadrants of the array of fins. The cooling fluid flow path 650 may be further configured to direct the plurality of streams comprising the cooling fluid into a fluid collection zone. The fluid collection zone may be configured to collect the plurality of streams into a body of fluid comprising the cooling fluid. The cooling fluid flow path may be configured to direct the body of fluid comprising the cooling fluid from the fluid collection zone to the one or more exit channels of the manifold block, which one or more exit channels are in fluid communication with the outlet of the manifold block. The cooling fluid flow path 650 may be further configured to direct the cooling fluid from the one or more exit channels to the outlet of the manifold block.

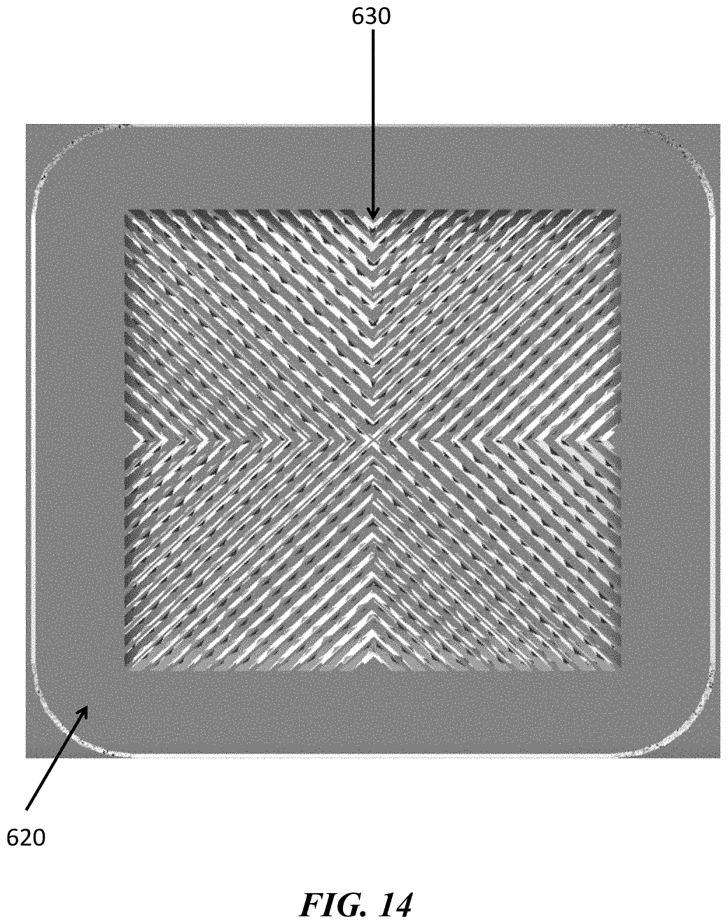

FIG. 14 illustrates an array of fins 630. The array of fins may be disposed on an upper surface of the cold plate 620. The array of fins may be configured in a diagonal arrangement of fins. The diagonal arrangement of fins may comprise at least four or more sets of fins. The at least four or more sets of fins may be positioned adjacent to each other such that the array of fins is configured in the shape of a square. In some cases, the array of fins comprising the diagonal arrangement of fins may be configured in the shape of a circle, a square, a rectangle, a triangle, a pentagon, a hexagon, a heptagon, an octagon, a nonagon, a decagon, or any polygon with at least three or more sides. Each of the four sets of fins may be oriented such that at least one fin of each set of fins extends from a center of the square to a vertex of the square. Each fin in a set of fins may be parallel to one or more fins in the same set of fins. Each fin in a set of fins may be in contact with and/or in thermal communication with another fin in another set of fins. In some cases, a first fin in a first set of fins may be positioned adjacent to a second fin in a second set of fins such that the first fin in the first set of fins and the second fin in the second set of fins is disposed at an angle relative to one another. The angle may be a fin separation angle. The fin separation angle may be at least about 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, or more. In some cases, the fin separation angle may be at most about 90 degrees, 85 degrees, 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, 15 degrees, 10 degrees, 5 degrees, or less. The fin separation angle may be from 10 degrees to 90 degrees, or 20 degrees to 90 degrees, or 30 degrees to 90 degrees, 40 degrees to 90 degrees, or 45 degrees to 90 degrees.

As described above, the array of fins 630 may comprise a plurality of fins configured in a diagonal arrangement. The plurality of fins may comprise at least four sets of fins comprising two or more parallel fins. Each of the at least four sets of fins may comprise one or more fins that extend from a center of the plate to an outer edge of the plate. The one or more fins in a set of fins may be oriented in the same direction relative to each other. Alternatively, the one or more fins in a set of fins may be oriented in different directions relative to each other. The one or more fins in a first set of fins may be oriented in a first direction, and the one or more fins in a second set of fins may be oriented in a second direction that may not be the same as the first direction. The first direction and the second direction may form an angle ranging from 0 degrees to 180 degrees, or more. In some cases, a first fin of a first set of fins may be in thermal contact with a second fin of a second set of fins. In such cases, the first fin may be oriented at an angle relative to the second fin, which angle may be greater than 0° and less than or equal to 180°.

In some embodiments, the fins of the array of fins may comprise one or more turbulating features disposed on a surface of the fin. The one or more turbulating features may be configured to generate turbulence when the cooling fluid flows across and/or through the array of fins, thereby enhancing heat transfer between the cooling fluid and the one or more fins of the array of fins. In some cases, the one or more turbulating features may comprise one or more protrusions on a surface of the one or more fins in the array of fins. In some cases, the one or more protrusions may be shaped as a diamond or a pyramid.

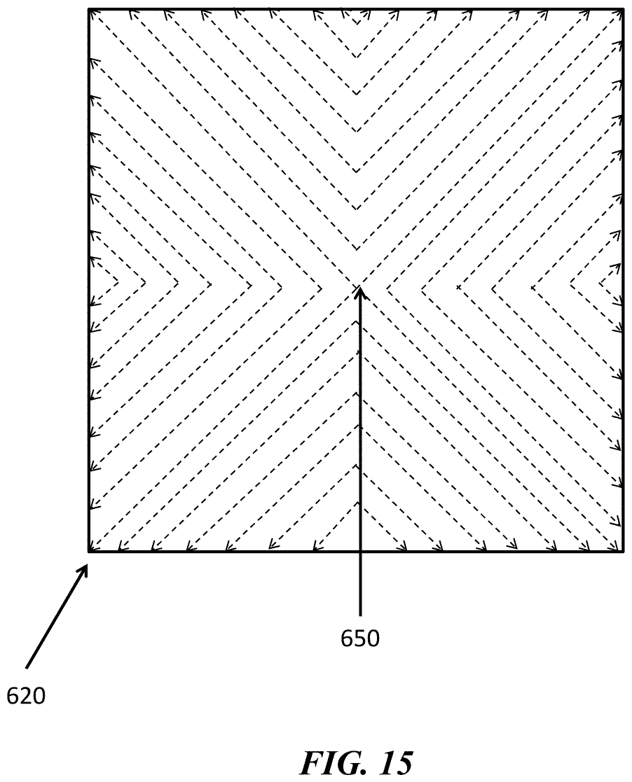

FIG. 15 illustrates a fluid flow path 650 of the cooling fluid across the array of fins disposed on an upper surface of the cold plate 620. The cooling fluid flow path may be configured to direct the cooling fluid across and/or through the array of fins. The array of fins may be configured to direct one or more of the plurality of streams comprising the cooling fluid in a diagonal pattern corresponding to the diagonal arrangement of fins described above. The plurality of streams may flow from a center of the diagonal arrangement of fins to an outer edge of the array of fins. The diagonal arrangement of fins may be configured to further split the plurality of streams into a plurality of sub-streams, which sub-streams may flow along a diagonal flow path defined by one or more gaps between one or more fins of the array of fins. In some cases, a first portion of a stream may flow across and/or through a first set of fins, and a second portion of the stream may flow across and/or through a second set of fins. The first set of fins may be oriented in a first direction, and the second set of fins may be oriented in a second direction. In some cases, a first portion of a stream may flow across and/or through a first section of the first set of fins, and a second portion of the stream may flow across and/or through a second section of the first set of fins. The first section and the second section may be configured to direct each portions of a stream along two or more directions that are substantially parallel to each other. The first section and the second section of a set of fins may be configured to direct each portion of the stream to a different location along an outer edge of the cold plate 620.

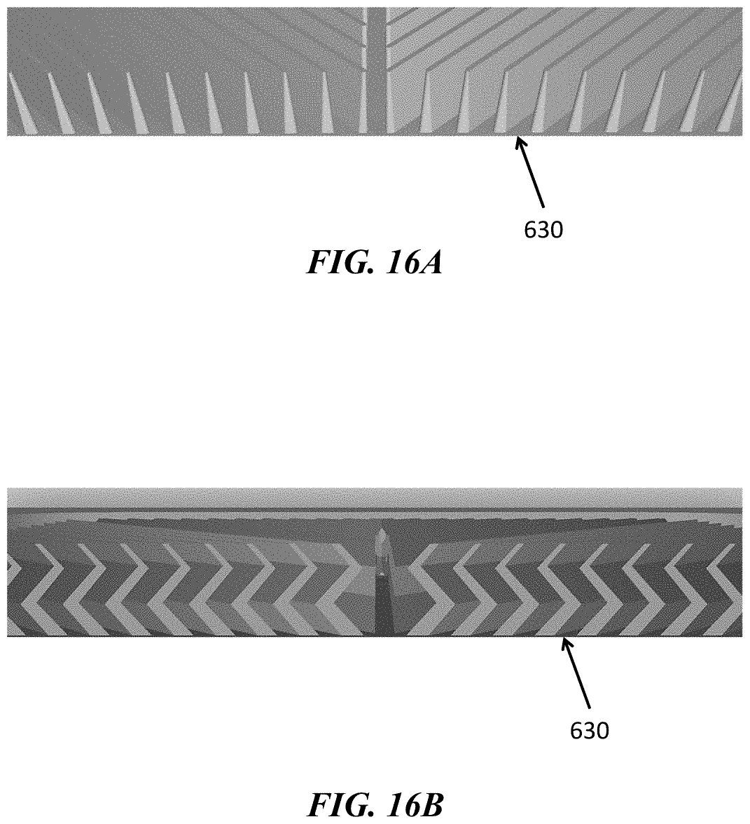

FIG. 16A shows an array of fins comprising one or more tapered fins. The one or more tapered fins may be configured such that a width of the tapered fins gradually decreases along an axis spanning the height of the tapered fins.

FIG. 16B shows an array of fins comprising one or more jagged fins. The one or more jagged fins may extend upwards from a surface of the cold plate. The one or more jagged fins may have a vertical cross-section that is in a zigzag pattern. A first portion of the one or more jagged fins may extend upwards from the cold plate at a first angle. A second portion of the one or more jagged fins may extend upwards from an upper end of the first potion of the one or more jagged fins at a second angle. The first angle may be equal to the second angle. Alternatively, the first angle may not be equal to the second angle. The one or more jagged fins may comprise a plurality of portions that extend upwards from one another at a plurality of angles and/or directions relative to the cold plate. The one or more jagged fins may be configured to increase a surface area of the one or more jagged fins in thermal contact with the cooling fluid, thereby enhancing heat transfer between the cooling fluid and the one or more jagged fins.

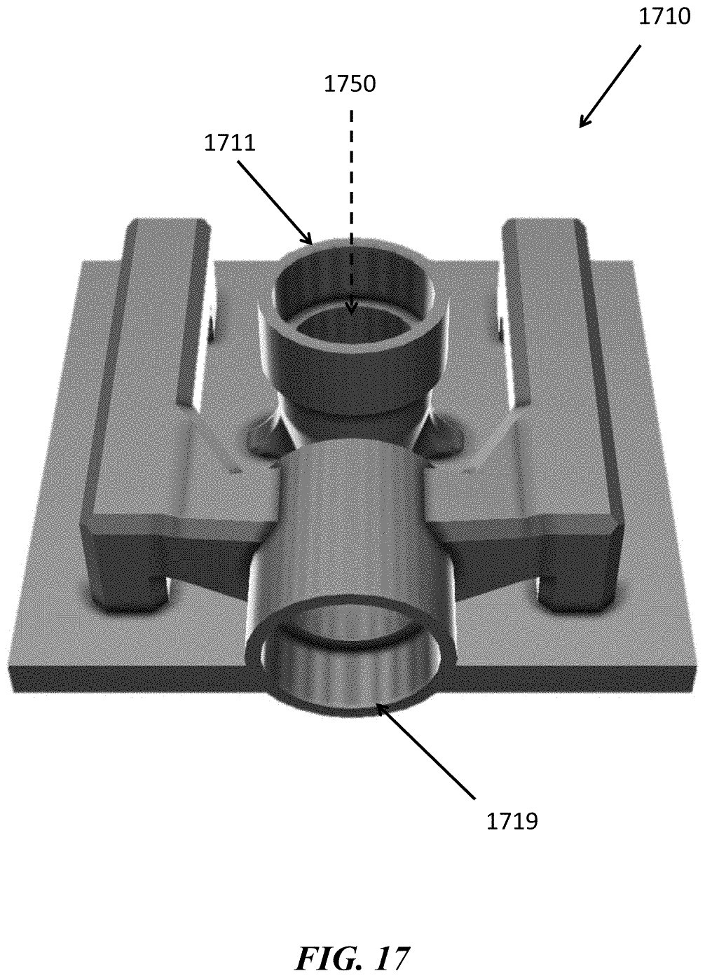

FIG. 17 illustrates a 4-way exit liquid cooling device comprising a manifold block 1710 with a plurality of exit channels. Although a 4-way exit is shown, the exit may be a multi-way exit, such as an exit having at least 2, 3, 4, 5, 6, 7, 8, 9, 10 or more exits. The plurality of exit channels may comprise at least four or more exit channels. The plurality of exit channels may be in fluid communication with an inlet of the manifold block via a flow splitter of the manifold block and a fluid collection zone of the manifold block. The plurality of exit channels may be in fluid communication with an outlet of the manifold block. The 4-way exit liquid cooling device may comprise a manifold block with a flow splitter comprising a geometry that is substantially similar to the flow splitter described above and shown in FIG. 8 and FIG. 9.

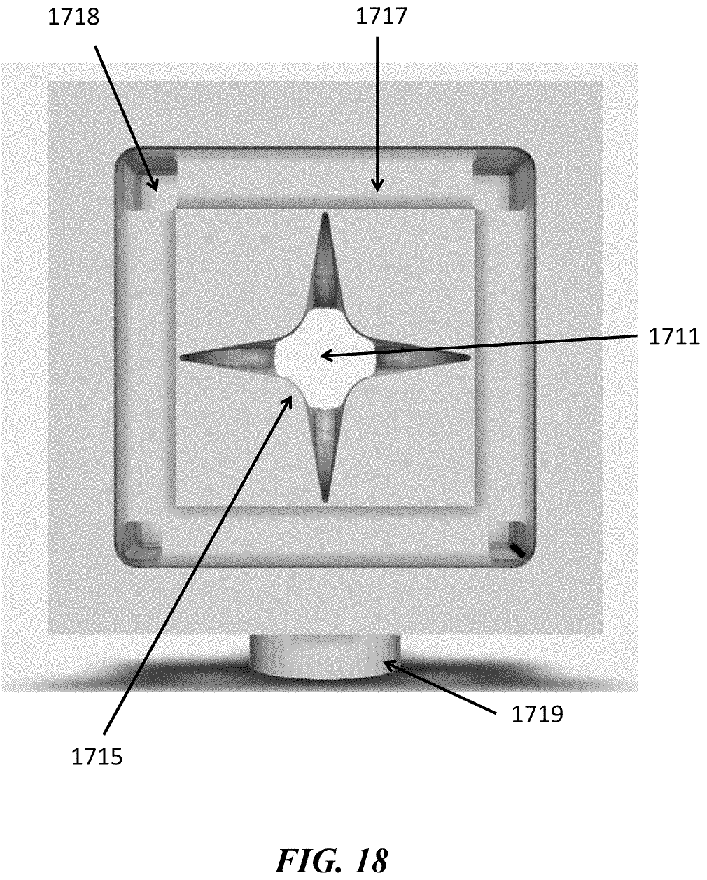

FIG. 18 illustrates a lower surface of the manifold block 1710 of the 4-way exit liquid cooling device. The manifold block 1710 may have an inlet 1711 and a flow splitter 1715 within the manifold block 1710. The manifold block 1710 may have a recessed region disposed on a lower surface of the manifold block 1710. The recessed region may be in fluid communication with a fluid collection zone disposed on an upper surface of a cold plate. The fluid collection zone may be in fluid communication with a plurality of exit channels 1718 disposed at one or more corners of the recessed region disposed on the lower surface of the manifold block 1710. The plurality of exit channels 1718 may be in fluid communication with the outlet 1719 of the manifold block.

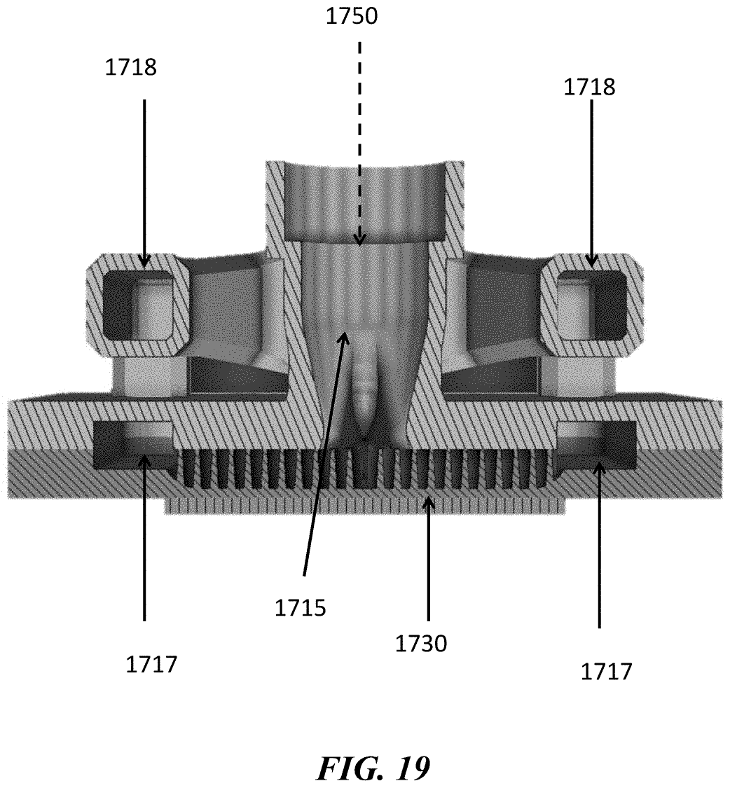

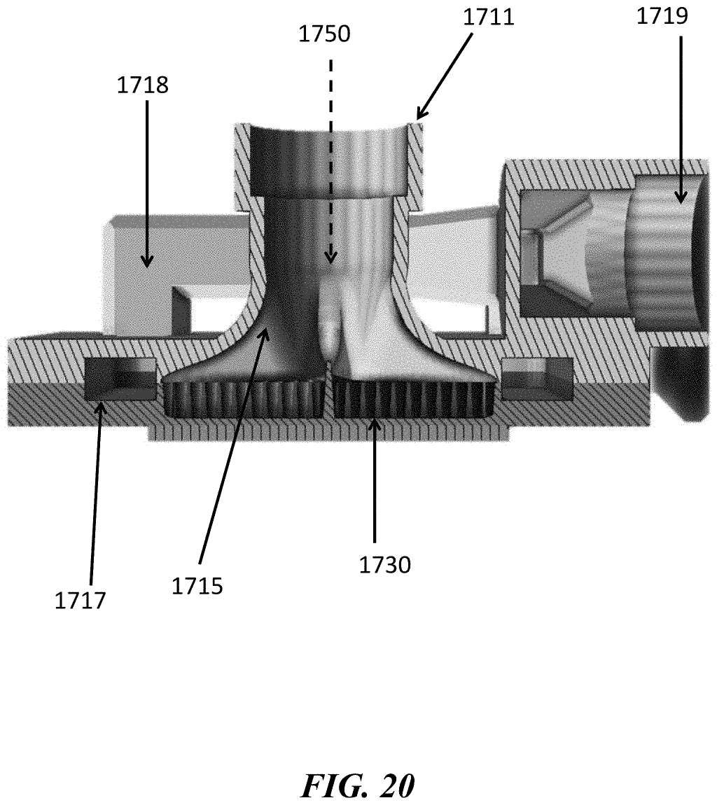

FIG. 19 illustrates a first vertical cross section of the 4-way exit liquid cooling device. The 4-way exit liquid cooling device may comprise a manifold block 1710 with an inlet 1711 and a flow splitter 1715. The flow splitter 1715 may be in fluid communication with the inlet 1711. The flow splitter 1715 may be configured to split the cooling fluid into a plurality of streams comprising the cooling fluid. The 4-way exit liquid cooling device may further comprise a fluid collection zone 1717 disposed on an upper surface of the cold plate. The fluid collection zone 1717 may be recessed into a portion of the upper surface of the cold plate. The fluid collection zone 1717 may be in fluid communication with the flow splitter 1715. The fluid collection zone 1717 may be in fluid communication with a plurality of exit channels 1718. As shown in FIG. 20, the plurality of exit channels 1718 may be in fluid communication with an outlet 1719 of the 4-way exit liquid cooling device.

As shown in FIG. 19, the 4-way exit liquid cooling device may comprise a cooling fluid flow path 1750. The cooling fluid flow path may be configured to direct the cooling fluid into the inlet 1711, through the flow splitter 1715, across and/or through an array of fins 1730, into a fluid collection zone 1717, into the plurality of exit channels 1718, and through the outlet 1719 of the manifold block of the 4-way exit liquid cooling device.

FIG. 20 illustrates a second vertical cross section of the 4-way exit liquid cooling device. As described above, the 4-way exit liquid cooling device may comprise a manifold block 1710 with an inlet 1711 and a flow splitter 1715. The flow splitter 1715 may be in fluid communication with the inlet 1711. The flow splitter 1715 may be configured to split the cooling fluid into a plurality of streams comprising the cooling fluid. The 4-way exit liquid cooling device may further comprise a fluid collection zone 1717 disposed on an upper surface of the cold plate. The fluid collection zone 1717 may be recessed into a portion of the upper surface of the cold plate. The fluid collection zone 1717 may be in fluid communication with the flow splitter 1715. The fluid collection zone 1717 may be in fluid communication with a plurality of exit channels 1718. The plurality of exit channels 1718 may be in fluid communication with an outlet 1719 of the 4-way exit liquid cooling device.

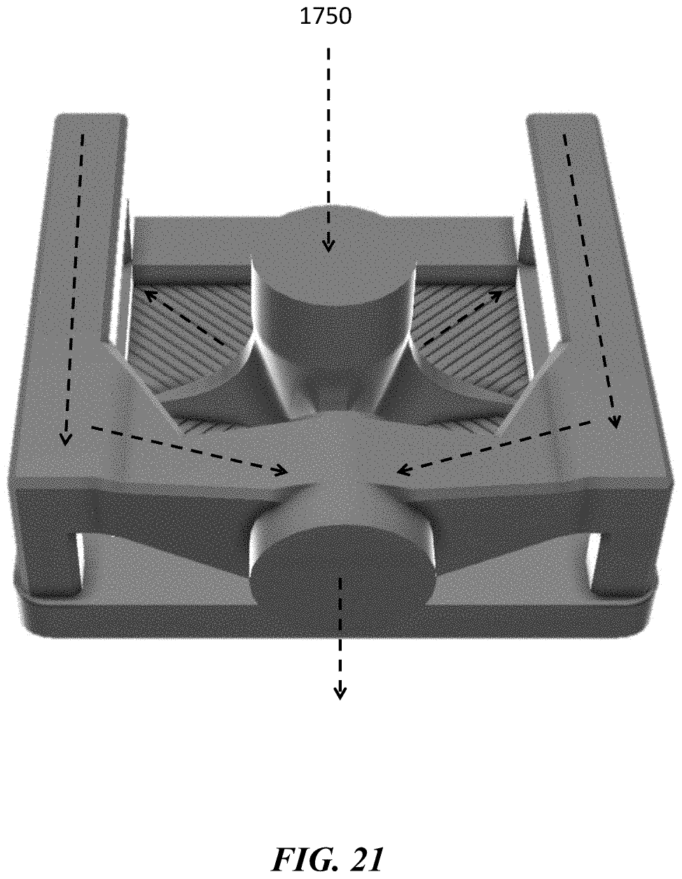

FIG. 21 illustrates a cooling fluid flow path 1750 of the cooling fluid through the 4-way exit liquid cooling device. As described above, the cooling fluid flow path may be configured to direct the cooling fluid into the inlet 1711, through the flow splitter 1715, across and/or through an array of fins 1730, into a fluid collection zone 1717, into the plurality of exit channels 1718, and through the outlet 1719 of the manifold block of the 4-way exit liquid cooling device.

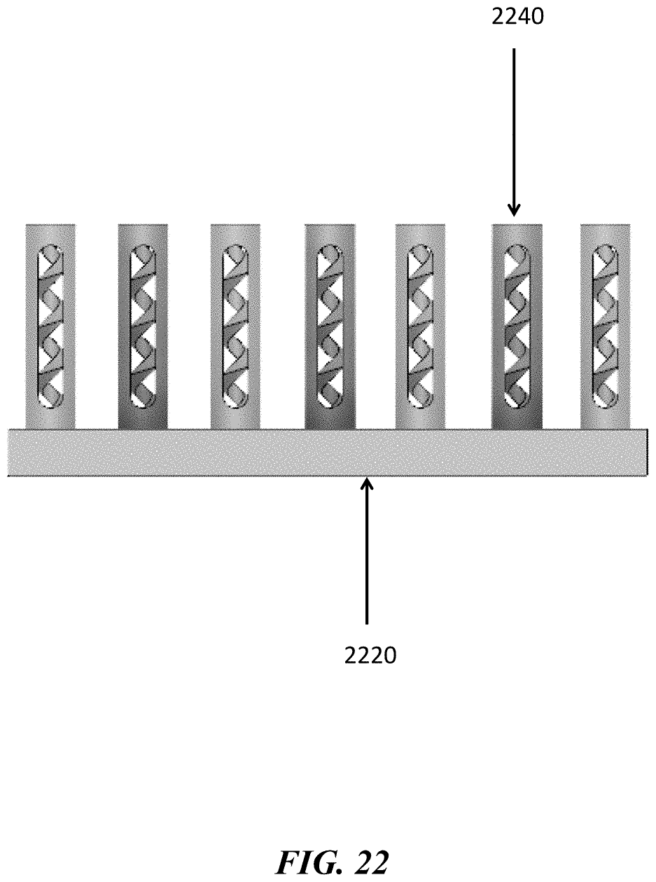

FIG. 22 illustrates one or more turbulating pins 2240 configured to enhance turbulence within the cooling fluid when the cooling fluid flows through the array of fins. The one or more turbulating pins 2240 may be disposed in between two or more fins of the array of fins. In some cases, the one or more turbulating pins 2240 may be disposed on a surface of one or more fins. The one or more turbulating pins 2240 may be in thermal contact with a plate 2220 of the thermal management device. The one or more turbulating pins 2240 may be configured to facilitate a transfer of thermal energy between the plate 2220 and a cooling fluid flowing past and/or the one or more turbulating pins 2240. The one or more turbulating pins 2240 may have a height that is greater than, less than, or equal to the height of one or more fins of the array of fins. In some cases, each of the one or more turbulating pins 2240 may have different heights. The one or more turbulating pins 2240 may comprise different shapes and/or sizes. In some cases, the one or more turbulating pins 2240 may comprise a cross-sectional shape. The cross-sectional shape may be a circle, an oval, an ellipse, or any polygon with three or more sides. In some cases, the one or more turbulating pins may be configured as one or more airfoils as described elsewhere herein.

The one or more turbulating pins may have a hollow internal region. The one or more turbulating pins may have an opening disposed on a surface of the one or more turbulating pins. The opening may be configured to allow a cooling fluid to flow through the opening from a front side of the turbulating pin to a back side of the turbulating pin. The opening may be in the shape of a circle, a square, an ellipse, a rectangle, or a combination thereof. The one or more turbulating pins may comprise a turbulating feature located within the hollow internal region. The turbulating feature may be configured as a helical structure that extends from a bottom of the turbulating pin to a top of the turbulating pin. The helical structure may have one or more coils extending from a bottom of the turbulating pin to a top of the turbulating pin. The one or more coils may make a predetermined number of turns along a height of the helical structure. The predetermined number of turns may range from 1 turn to 100 turns. The helical structure may have a predetermined pitch. The predetermined pitch may range from 1 millimeter (mm) to 1 meter (m). The predetermined pitch may vary along a height of the helical structure. The helical structure may have a predetermined diameter. The predetermined diameter may range from 1 millimeter to 1 meter. The predetermined diameter may vary across one or more coils of the helical structure. The one or more coils may have a predetermined coil angle. The coil angle may range from 0.001 degrees to 90 degrees. The predetermined coil angle may vary along a height of the helical structure. The helical structure may have a coil with a cross-section. The cross-section may be in the shape of a circle, a square, a rectangle, or an airfoil as described elsewhere herein. In some cases, one or more features of the helical structure (e.g., height, number of coils, number of turns for each coil, pitch, diameter, coil angle, or cross-sectional shape) may be pre-determined and/or adjusted to generate turbulence within the cooling fluid while the cooling fluid flows past and/or through the array of fins or the turbulating pins. Further, the one or more features of the helical structure may be pre-determined and/or adjusted to enhance mixing of the cooling fluid and to enhance heat transfer between the cooling fluid and one or more components of the liquid cooling device (e.g., the array of fins, the plate, or the manifold block), while the cooling fluid flows past and/or through the array of fins or the turbulating pins.

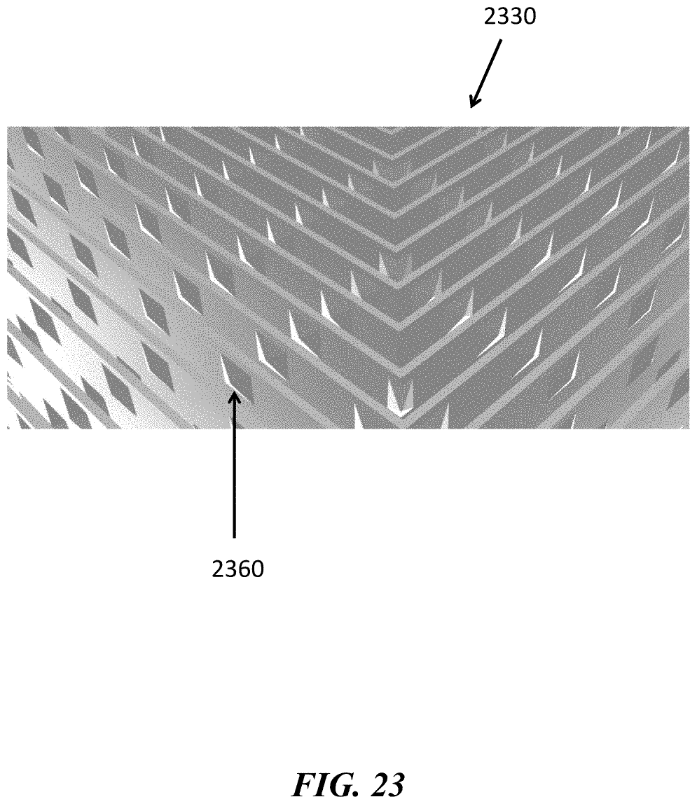

FIG. 23 illustrates a plurality of fins 2330 with one or more turbulating features 2360 disposed on a surface of the plurality of fins 2330. The one or more turbulating features 2360 may comprise one or more protrusions on a surface of the plurality of fins 2330. As described above, the one or more turbulating features 2360 may be in the shape of a square pyramid, a triangular pyramid, a rectangular pyramid, a tetrahedron, a triangular prism, a pentagonal pyramid, a hexagonal pyramid, a heptagonal pyramid, an octagonal pyramid, a cube, a rectangular prism, a sphere, a cylinder, a cone, an airfoil, or any partial shape or combination of shapes thereof. In some cases, the one or more turbulating features 2360 may have a cross-section that is circular, triangular, square, rectangular, pentagonal, hexagonal, or any partial cross-section or combination of cross-sections thereof. The one or more turbulating features 2360 may be configured to generate turbulence within the cooling fluid while the cooling fluid flows past and/or across the array of fins or the one or more turbulating features 2360, thereby enhancing heat transfer between the cooling fluid and the array of fins. Further, the shape and/or the size of the one or more turbulating features may be pre-determined and/or adjusted to enhance mixing of the cooling fluid and to enhance heat transfer between the cooling fluid and one or more components of the liquid cooling device (e.g., the array of fins, the plate, or the manifold block), while the cooling fluid flows past and/or across the array of fins 2330 or the one or more turbulating features 2360.

Connecting Structures

In another different aspect, the present disclosures provides a thermal management device. The thermal management device may comprise an array of fins comprising a first fin and a second fin adjacent to the first fin. The first fin and the second fin may have a horizontal cross-section and/or a vertical cross-section that is circular, elliptical, teardrop-shaped, triangular, square, rectangular, or any partial cross-section or combination of cross-sections thereof. The first fin and/or the second fin may be a tube fin, a plate fin, a pin fin, or an annular fin.

The first fin and the second fin may be configured for heat transfer to and/or from a fluid in contact with the first fin and/or the second fin. As described elsewhere in this specification, the fluid may comprise a gas and/or a liquid.

The thermal management device may comprise a heat transfer structure disposed between and in thermal contact with the first fin and the second fin. The heat transfer structure may be configured for heat transfer (i) to the first fin and the second fin, or (ii) from the first fin and the second fin. In some cases, the heat transfer structure may be configured to transfer heat to the first fin and the second fin. In other cases, the heat transfer structure may be configured to absorb heat from the first fin and the second fin, and subsequently transfer the heat to a fluid in thermal contact with the first fin and the second fin. The fluid may be configured to flow through and/or across the heat transfer structure. The fluid may be configured to flow between the first fin and the second fin, or flow across one or more surfaces of the first fin and/or the second fin.

The thermal management device may further comprise a plate adjacent to the array of fins. The array of fins may be in thermal contact with the plate. The plate may be configured to transfer heat from a source of heat to the array of fins. Alternatively, or in addition, the plate may be configured to transfer heat from the array of fins to a sink of the heat. The plate may have a horizontal cross-section and/or a vertical cross-section in a shape of a square or a rectangle.

The source of the heat, also referred to herein as a source of thermal energy, may comprise a circuit, a computer processor, and/or a plurality of computer processors. The source of thermal energy may be an object (e.g., a mechanical component, a mechanical structure, and/or a surface of a mechanical component or a mechanical structure) that is in thermal contact with a circuit, a computer processor, and/or a plurality of computer processors. The source of thermal energy may include an electronic component (e.g., a circuit board, a computer processor(s), a graphics processing unit, or an application-specific integrated circuit) and/or an object (e.g., a mechanical component, a mechanical structure, and/or a surface of a mechanical component or a mechanical structure) that is in thermal communication with the electronic component. The object in thermal communication with the electronic component may be configured to absorb and/or transmit at least a portion of the thermal energy generated by the electronic component.

The sink of the heat may comprise an object or device that is configured to absorb heat from the plate and/or the array of fins. In some cases, the sink of the heat may be a passive heat exchanger. The sink of the heat may be configured to transfer the heat from the plate and/or the array of fins to a fluid medium. The fluid medium may comprise an air or a liquid coolant. The heat may be transferred from the plate and/or the array of fins to the sink of the heat by one or more heat transfer mechanisms. The heat may be transferred from the sink of the heat to the fluid medium by one or more heat transfer mechanisms. As described elsewhere herein, the one or more heat transfer mechanisms may include advection, conduction, convection, radiation, and/or any combination of heat transfer mechanisms thereof.

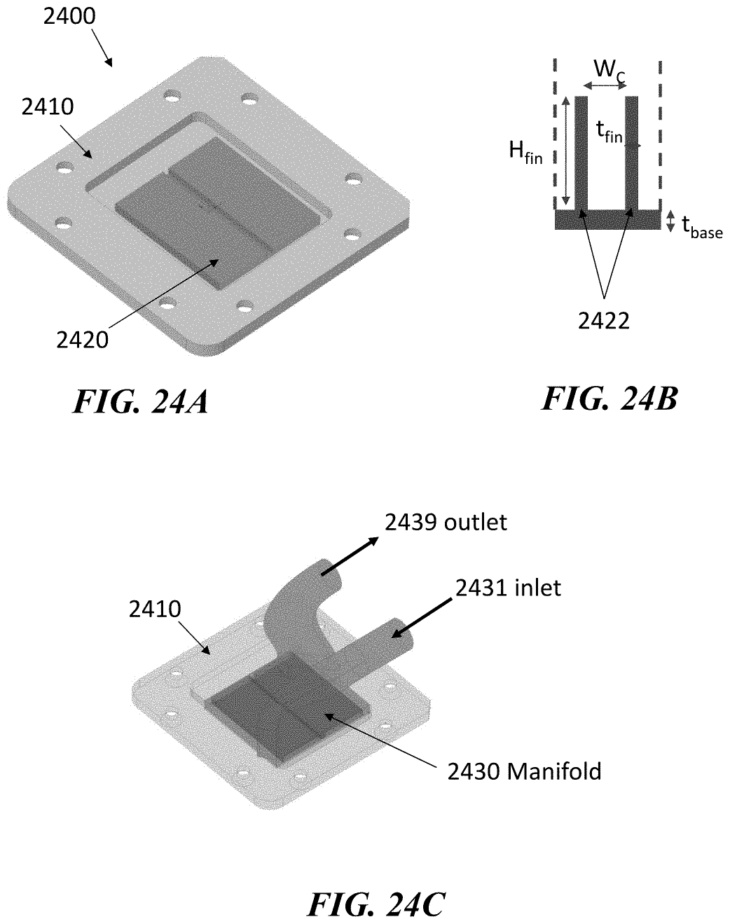

FIG. 24A illustrates a thermal management device 2400 comprising a plate 2410. The plate 2410 may be in thermal contact with a source of heat or a source of thermal energy. In some cases, the plate 2410 may be in thermal contact with a microprocessor. The plate 2410 may be configured to transfer heat from the source of heat or the source of thermal energy to an array of fins 2420 disposed on a surface of the plate 2410. In some cases, the plate 2410 may be configured to transfer heat from the array of fins 2420 to a heat sink that is in thermal communication with the plate 2410. The array of fins 2420 may comprise a plurality of parallel plate fins in thermal communication with the plate 2410.

FIG. 24B illustrates a plurality of fins 2422 of the array of fins shown in FIG. 24A. A fin 2422 of the array of the fins may have a fin height. The fin height may range from about 0.001 microns (or 1 nm) to about 100,000 microns (or 10 centimeters (cm)). The fin height may be at least about 0.001 microns. The fin height may be at most about 100,000 microns. The fin height may range from about 0.001 microns to about 0.01 microns, about 0.001 microns to about 0.1 microns, about 0.001 microns to about 1 micron, about 0.001 microns to about 10 microns, about 0.001 microns to about 100 microns, about 0.001 microns to about 1,000 microns, about 0.001 microns to about 10,000 microns, about 0.001 microns to about 100,000 microns, about 0.01 microns to about 0.1 microns, about 0.01 microns to about 1 micron, about 0.01 microns to about 10 microns, about 0.01 microns to about 100 microns, about 0.01 microns to about 1,000 microns, about 0.01 microns to about 10,000 microns, about 0.01 microns to about 100,000 microns, about 0.1 microns to about 1 micron, about 0.1 microns to about 10 microns, about 0.1 microns to about 100 microns, about 0.1 microns to about 1,000 microns, about 0.1 microns to about 10,000 microns, about 0.1 microns to about 100,000 microns, about 1 micron to about 10 microns, about 1 micron to about 100 microns, about 1 micron to about 1,000 microns, about 1 micron to about 10,000 microns, about 1 micron to about 100,000 microns, about 10 microns to about 100 microns, about 10 microns to about 1,000 microns, about 10 microns to about 10,000 microns, about 10 microns to about 100,000 microns, about 100 microns to about 1,000 microns, about 100 microns to about 10,000 microns, about 100 microns to about 100,000 microns, about 1,000 microns to about 10,000 microns, about 1,000 microns to about 100,000 microns, or about 10,000 microns to about 100,000 microns. The fin height may be about 0.001 microns, about 0.01 microns, about 0.1 microns, about 1 micron, about 10 microns, about 100 microns, about 1,000 microns, about 10,000 microns, or about 100,000 microns. In some embodiments, the fin height may range from about 1 mm to about 10 cm.

In some embodiments, the fin height may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the fin height may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less.

The height of two or more fins in the array of fins (e.g., two adjacent fins) may be the same. Alternatively, the height of two or more adjacent fins in the array of fins may be different. In such cases, a difference in height between two fins may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the difference in height between two fins may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less.

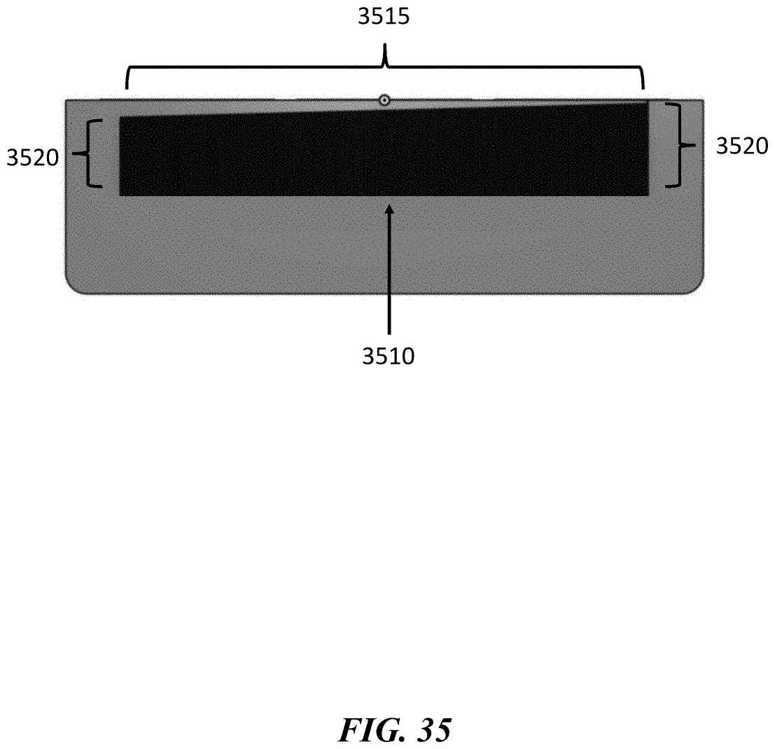

The height of a fin in the array of fins may vary across a length, a width, and/or a thickness of the fin. In some embodiments, a height of one or more fins in the array of fins may vary across a length and/or a width of the array of fins. For example, the height of the one or more fins in the array of fins may increase along a length and/or a width of the array of fins. Alternatively, the height of the one or more fins in the array of fins may decrease along a length and/or a width of the array of fins. FIG. 35 illustrates an array of fins comprising a plurality of fins with varying heights across a length of the array of fins. As shown in FIG. 35, a height 3520 of the plurality of fins of the array of fins 3510 may vary (e.g., increase) across a length 3515 of the array of fins 3510. In some cases, a length, a width, and/or a thickness of the plurality of fins may vary (i.e., increase or decrease) across a length of the array of fins. In other cases, a length, a width, a height, and/or a thickness of the plurality of fins may vary in a pre-determined or randomized pattern across a length of the array of fins to maximize an amount of heat transfer from the array of fins to a fluid flowing through the array of fins.

Each fin of the array of the fins may have a fin thickness. The fin thickness may range from about 0.001 microns (or 1 nm) to about 100,000 microns (or 10 cm). The fin thickness may be at least about 0.001 microns. The fin thickness may be at most about 100,000 microns. The fin thickness may range from about 0.001 microns to about 0.01 microns, about 0.001 microns to about 0.1 microns, about 0.001 microns to about 1 micron, about 0.001 microns to about 10 microns, about 0.001 microns to about 100 microns, about 0.001 microns to about 1,000 microns, about 0.001 microns to about 10,000 microns, about 0.001 microns to about 100,000 microns, about 0.01 microns to about 0.1 microns, about 0.01 microns to about 1 micron, about 0.01 microns to about 10 microns, about 0.01 microns to about 100 microns, about 0.01 microns to about 1,000 microns, about 0.01 microns to about 10,000 microns, about 0.01 microns to about 100,000 microns, about 0.1 microns to about 1 micron, about 0.1 microns to about 10 microns, about 0.1 microns to about 100 microns, about 0.1 microns to about 1,000 microns, about 0.1 microns to about 10,000 microns, about 0.1 microns to about 100,000 microns, about 1 micron to about 10 microns, about 1 micron to about 100 microns, about 1 micron to about 1,000 microns, about 1 micron to about 10,000 microns, about 1 micron to about 100,000 microns, about 10 microns to about 100 microns, about 10 microns to about 1,000 microns, about 10 microns to about 10,000 microns, about 10 microns to about 100,000 microns, about 100 microns to about 1,000 microns, about 100 microns to about 10,000 microns, about 100 microns to about 100,000 microns, about 1,000 microns to about 10,000 microns, about 1,000 microns to about 100,000 microns, or about 10,000 microns to about 100,000 microns. The fin thickness may be about 0.001 microns, about 0.01 microns, about 0.1 microns, about 1 micron, about 10 microns, about 100 microns, about 1,000 microns, about 10,000 microns, or about 100,000 microns. In some embodiments, the fin thickness may range from about 1 micron to about 10 cm.

In some embodiments, the fin thickness may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the fin thickness may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less. In some embodiments, the fin thickness may range from about 1 millimeter (mm) to about 10 centimeters (cm).

The thickness of two or more fins in the array of fins (e.g., two adjacent fins) may be the same. Alternatively, the thickness of two or more adjacent fins in the array of fins may be different. In such cases, a difference in thickness between two adjacent fins may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the difference in thickness between two fins may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less.

The thickness of a fin in the array of fins may vary across a length, a width, and/or a height of the fin. In some embodiments, a thickness of the one or more fins in the array of fins may vary across a length and/or a width of the array of fins. For example, the thickness of the one or more fins in the array of fins may increase along a length and/or a width of the array of fins. Alternatively, the thickness of the one or more fins in the array of fins may decrease along a length and/or a width of the array of fins.

Each fin of the array of fins may be separated from one or more adjacent fins of the array of fins by a separation distance. The separation distance between adjacent fins within the array of fins may be different across the array of fins. The separation distance may range from about 0.001 microns (or 1 nm) to about 100,000 microns (or 10 cm). The separation distance may be at least about 0.001 microns. The separation distance may be at most about 100,000 microns. The separation distance may range from about 0.001 microns to about 0.01 microns, about 0.001 microns to about 0.1 microns, about 0.001 microns to about 1 micron, about 0.001 microns to about 10 microns, about 0.001 microns to about 100 microns, about 0.001 microns to about 1,000 microns, about 0.001 microns to about 10,000 microns, about 0.001 microns to about 100,000 microns, about 0.01 microns to about 0.1 microns, about 0.01 microns to about 1 micron, about 0.01 microns to about 10 microns, about 0.01 microns to about 100 microns, about 0.01 microns to about 1,000 microns, about 0.01 microns to about 10,000 microns, about 0.01 microns to about 100,000 microns, about 0.1 microns to about 1 micron, about 0.1 microns to about 10 microns, about 0.1 microns to about 100 microns, about 0.1 microns to about 1,000 microns, about 0.1 microns to about 10,000 microns, about 0.1 microns to about 100,000 microns, about 1 micron to about 10 microns, about 1 micron to about 100 microns, about 1 micron to about 1,000 microns, about 1 micron to about 10,000 microns, about 1 micron to about 100,000 microns, about 10 microns to about 100 microns, about 10 microns to about 1,000 microns, about 10 microns to about 10,000 microns, about 10 microns to about 100,000 microns, about 100 microns to about 1,000 microns, about 100 microns to about 10,000 microns, about 100 microns to about 100,000 microns, about 1,000 microns to about 10,000 microns, about 1,000 microns to about 100,000 microns, or about 10,000 microns to about 100,000 microns. The separation distance may be about 0.001 microns, about 0.01 microns, about 0.1 microns, about 1 micron, about 10 microns, about 100 microns, about 1,000 microns, about 10,000 microns, or about 100,000 microns. In some embodiments, the separation distance may range from about 1 micron to about 10 cm. In some embodiments, the separation distance may range from about 1 mm to about 10 cm.

The fin separation distance may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the fin separation distance may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less. In some embodiments, the separation distance between a first fin and a second fin adjacent to the first fin may range from about 100 micrometers to 1 centimeter.

The plurality of fins 2422 may be disposed on a base plate. The base plate may be a plate as described above. The base plate may have a base plate thickness. The base plate thickness may range from about 0.001 microns (or 1 nm) to about 100,000 microns (or 10 cm). The base plate thickness may range from at least about 0.001 microns. The base plate thickness may range from at most about 100,000 microns. The base plate thickness may range from about 0.001 microns to about 0.01 microns, about 0.001 microns to about 0.1 microns, about 0.001 microns to about 1 micron, about 0.001 microns to about 10 microns, about 0.001 microns to about 100 microns, about 0.001 microns to about 1,000 microns, about 0.001 microns to about 10,000 microns, about 0.001 microns to about 100,000 microns, about 0.01 microns to about 0.1 microns, about 0.01 microns to about 1 micron, about 0.01 microns to about 10 microns, about 0.01 microns to about 100 microns, about 0.01 microns to about 1,000 microns, about 0.01 microns to about 10,000 microns, about 0.01 microns to about 100,000 microns, about 0.1 microns to about 1 micron, about 0.1 microns to about 10 microns, about 0.1 microns to about 100 microns, about 0.1 microns to about 1,000 microns, about 0.1 microns to about 10,000 microns, about 0.1 microns to about 100,000 microns, about 1 micron to about 10 microns, about 1 micron to about 100 microns, about 1 micron to about 1,000 microns, about 1 micron to about 10,000 microns, about 1 micron to about 100,000 microns, about 10 microns to about 100 microns, about 10 microns to about 1,000 microns, about 10 microns to about 10,000 microns, about 10 microns to about 100,000 microns, about 100 microns to about 1,000 microns, about 100 microns to about 10,000 microns, about 100 microns to about 100,000 microns, about 1,000 microns to about 10,000 microns, about 1,000 microns to about 100,000 microns, or about 10,000 microns to about 100,000 microns. The base plate thickness may be about 0.001 microns, about 0.01 microns, about 0.1 microns, about 1 micron, about 10 microns, about 100 microns, about 1,000 microns, about 10,000 microns, or about 100,000 microns. In some embodiments, the base plate thickness may range from about 1 micron to about 10 cm. In some embodiments, the base plate thickness may range from about 1 mm to about 10 cm.

In some cases, the base plate thickness may be at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1 microns, 2 microns, 3 microns, 4 microns, 5 microns, 6 microns, 7 microns, 8 microns, 9 microns, 10 microns, 20 microns, 30 microns, 40 microns, 50 microns, 60 microns, 70 microns, 80 microns, 90 microns, 100 microns, 200 microns, 300 microns, 400 microns, 500 microns, 600 microns, 700 microns, 800 microns, 900 microns, 1 millimeter (mm), 2 mm, 3 mm, 4 mm, 5 mm, 6 mm, 7 mm, 8 mm, 9 mm, 1 cm, 2 cm, 3 cm, 4 cm, 5 cm, 6 cm, 7 cm, 8 cm, 9 cm, 10 cm, or more. In some cases, the base plate thickness may be at most about 10 cm, 9 cm, 8 cm, 7 cm, 6 cm, 5 cm, 4 cm, 3 cm, 2 cm, 1 cm, 9 mm, 8 mm, 7 mm, 6 mm, 5 mm, 4 mm, 3 mm, 2 mm, 1 mm, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 microns, 10 microns, 9 microns, 8 microns, 7 microns, 6 microns, 5 microns, 4 microns, 3 microns, 2 microns, 1 microns, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less. In some embodiments, the base plate thickness may range from about 1 millimeter (mm) to about 10 centimeters (cm).

The thermal management device may further comprise a manifold block disposed adjacent to the plate. The manifold block may comprise an inlet, an outlet, and a fluid flow path in fluid communication with the inlet and the outlet. The fluid flow path may be configured to direct a fluid from the inlet of the manifold block, through at least a portion of the array of fins, and towards the outlet of the manifold block.

FIG. 24C illustrates a manifold block 2430 of the thermal management device. The manifold block may be disposed adjacent to a plate 2410. The manifold block may be configured to enclose an array of fins of the thermal management device. The manifold block may comprise an inlet 2431 and an outlet 2439. The inlet 2431 may be configured to receive a fluid (e.g., a working fluid as described elsewhere herein) and direct the fluid through the thermal management device. The outlet 2439 may be configured to direct the fluid out of the thermal management device. The fluid at the inlet 2431 may have a first set of properties (e.g., temperature, pressure, etc.) that is different than a second set of properties of the fluid at the outlet 2439.

The first fin and/or the second fin may be oriented at an angle relative to the plate. The angle may range from about 20 degrees to about 160 degrees. The angle may be at least about 20 degrees, 30 degrees, 40 degrees, 50 degrees, 60 degrees, 70 degrees, 80 degrees, 90 degrees, 100 degrees, 110 degrees, 120 degrees, 130 degrees, 140 degrees, 150 degrees, 160 degrees, or more. The angle may be at most about 160 degrees, 150 degrees, 140 degrees, 130 degrees, 120 degrees, 110 degrees, 100 degrees, 90 degrees, 80 degrees, 70 degrees, 60 degrees, 50 degrees, 40 degrees, 30 degrees, 20 degrees, or less. In some cases, the angle may range between about 45 degrees and about 135 degrees. For example, the angle may be at least about 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, or more. Alternatively, the angle may be at most about 135 degrees, 130 degrees, 125 degrees, 120 degrees, 115 degrees, 110 degrees, 105 degrees, 100 degrees, 95 degrees, 90 degrees, 85 degrees, 80 degrees, 75 degrees, 70 degrees, 65 degrees, 60 degrees, 55 degrees, 50 degrees, 45 degrees, or less.

The first fin and the second fin may be perpendicular to a surface of the plate. In some cases, the first fin and the second fin may be substantially parallel to one another. In other cases, the first fin and the second fin may be angled towards each other. In such cases, a first portion of the first fin may be closer to the second fin than a second portion of the first fin.

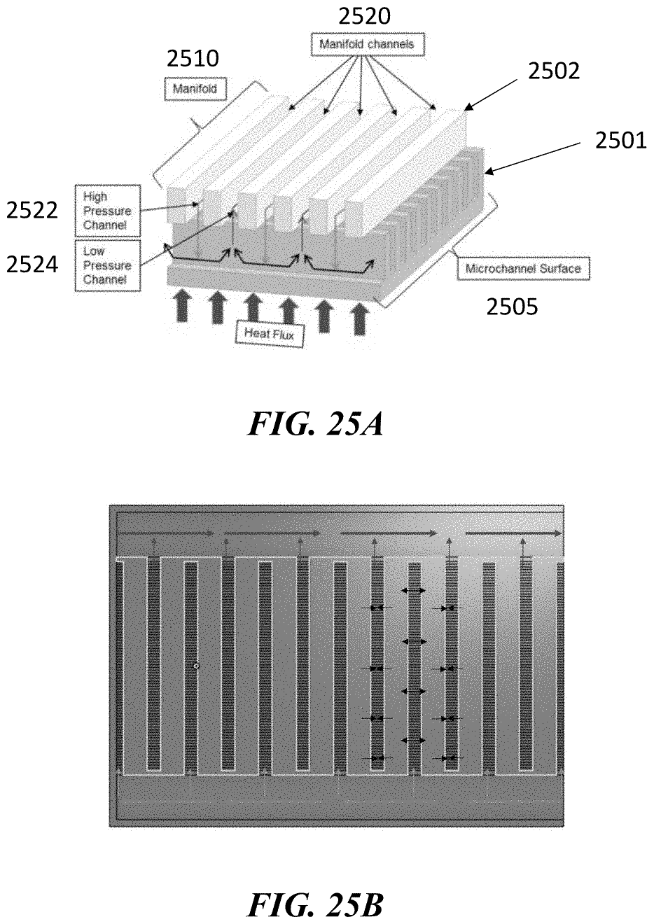

In some cases, the thermal management device may further comprise an array of manifold walls in thermal contact with the array of fins. As illustrated in FIG. 25A, the thermal management device may comprise an array of fins 2501 and an array of manifold walls 2502. The array of manifold walls 2502 may comprise one or more manifold walls disposed above or adjacent to the array of fins 2501. A fin of the array of fins and a manifold wall of the array of manifold walls may be oriented in different directions relative to a microchannel surface. The microchannel surface may correspond to a plate as described elsewhere herein. In some cases, a fin of the array of fins and a manifold wall of the array of manifold walls may be oriented perpendicular to each other. In other cases, a fin of the array of fins and a manifold wall of the array of manifold walls may be oriented at an offset angle relative to each other. The offset angle may be at least about 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees, 160 degrees, 165 degrees, 170 degrees, 175 degrees, or more. Alternatively, the offset angle may be at most about 175 degrees, 170 degrees, 165 degrees, 160 degrees, 155 degrees, 150 degrees, 145 degrees, 140 degrees, 135 degrees, 130 degrees, 125 degrees, 120 degrees, 115 degrees, 110 degrees, 105 degrees, 100 degrees, 95 degrees, 90 degrees, 85 degrees, 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, 15 degrees, 10 degrees, 5 degrees, or less. In some cases, a first fin of the array of fins and a first manifold wall of the array of manifold walls may be oriented at a first offset angle relative to each other, and a second fin of the array of fins and a second manifold wall of the array of manifold walls may be oriented at a second offset angle relative to each other. The first offset angle may be different than the second offset angle.

In some cases, the array of fins and the array of manifold walls may comprise a same material. The same material may comprise a metallic material, an intermetallic material, a ceramic material, a composite material, or any combination thereof, as described elsewhere herein. In other cases, the array of fins and the array of manifold walls may comprise one or more different materials. In some cases, a first fin of the array of fins and a second fin of the array of fins may comprise different materials. In some cases, a first manifold wall of the array of manifolds and a second manifold wall of the array of manifolds may comprise different materials. In some cases, a fin of the array of fins may comprise a different material than a manifold wall of the array of manifold walls.

The array of manifold walls 2502 may be in thermal communication with the array of fins 2501 or one or more fins of the array of fins 2501. As shown in FIG. 25A, the array of fins 2501 may be in thermal contact with a microchannel surface 2505. The microchannel surface 2505 may be a portion of a surface of a plate. The array of fins 2501 and the array of manifold walls 2502 may be in thermal communication with a source of heat via the microchannel surface 2505. The microchannel surface 2505 may correspond to a plate as described elsewhere herein.

The array of manifold walls 2502 may comprise one or more manifold walls. As used throughout this specification, a manifold wall may be referred to interchangeably as a manifold. A manifold wall may be a wall or a plate with a thickness. The manifold wall may be configured to direct a fluid in a desired direction along a length of the manifold wall or along a portion of a surface of the manifold wall. In some cases, a manifold wall may be configured to function or operate in a manner substantially similar to that of a fin of the array of fins 2501. In such cases, a manifold wall of the array of manifold walls 2502 may be configured to facilitate a transfer of heat between a fluid and an array of fins 2501 located adjacent to the array of manifold walls 2502. The one or more manifolds 2510 of the array of manifold walls 2502 may be parallel to one another. In some cases, the one or more manifolds 2510 of the array of manifold walls 2502 may not be parallel to one another. The one or more manifolds 2510 may form a series of manifold channels 2520. Each of the manifold channels 2520 may or may not be parallel with one another. The plurality of manifold channels 2520 may comprise a high pressure channel 2522 configured to direct a cooling fluid flowing through the array of manifold walls 2502 to one or more channels disposed between two or more fins of the array of fins 2501. The plurality of manifold channels 2520 may comprise a low pressure channel 2524 configured to direct a cooling fluid flowing through the array of fins 2501 to one or more manifold channels of the array of manifold walls 2502.

In any of the embodiments described herein, the use of manifolds and manifold channels may permit the thermal management devices disclosed herein to achieve highly distributed flow arrangements, thereby improving temperature uniformity across a heated base plate, increasing a convection coefficient in the microchannels, and lowering a pressure drop of the cooling fluid via a reduction of a local flow velocity and a fluid path length.

FIG. 25B illustrates a top view of a thermal management device comprising a manifold microchannel cold plate. As illustrated in FIG. 25B, a cooling fluid may flow in a direction that is parallel to a plate of a thermal management device. The thermal management device may comprise the array of fins and the array of manifold walls. The array of manifold walls may be disposed above the array of fins. The cooling fluid may enter from a bottom right side of the illustrated manifold microchannel cold plate and flow into one or more open top channels corresponding to the one or more manifold channels formed by the array of manifold walls. The cooling fluid may flow into every other channel of the one or more open top channels. The cooling fluid may then flow downwards into one or more channels formed by the array of fins disposed below the array of manifold walls. Subsequently, the cooling fluid may flow upwards back into one or more channels formed by the array of manifold walls disposed above the array of fins. The one or more channels may be different than the one or more open top channels described above. The cooling fluid may be configured to flow through one or more channels of the array of manifold walls that do not correspond to the one or more open top channels, and subsequently exit the thermal management device through a top right side of the illustrated manifold microchannel cold plate.

In any of the embodiments described herein, the manifold may comprise an integrated copper manifold. The integrated copper manifold may require minimal assembly. The integrated copper manifold may be configured to optimize flow passages.

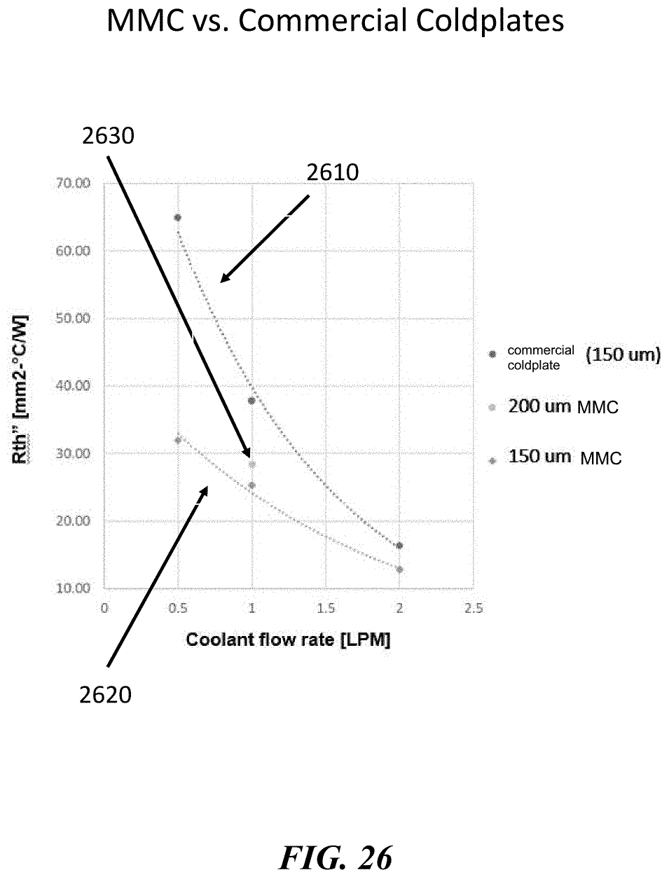

FIG. 26 schematically illustrates a performance comparison between a manifold micro-channel (MMC) cold plate and a commercial micro-channel cold plate. The performance of a cold plate may be quantified as a thermal resistance of a cold plate as a function of a flow rate of a cooling fluid. The cooling fluid may comprise about 30% propylene glycol-water (weight by volume) and may have a temperature of about 27 degrees Celsius at an inlet of the manifold block. The thermal resistance may be calculated based in part on an average surface temperature of the cold plate and an average temperature of the fluid at an inlet of the manifold block. As shown in FIG. 26, a performance of a commercial microchannel cold plate 2610 in thermal contact with one or more fins having a fin wall width of about 150 microns may be less than a performance of a manifold microchannel cold plate 2620 in thermal contact with one or more fins having a fin wall width of about 150 microns. Further, for a fluid flow rate of about 1 liter per minute, the performance of a commercial microchannel cold plate 2610 in thermal contact with one or more fins having a fin wall width of about 150 microns may be less than a performance of a manifold microchannel cold plate 2630 in thermal contact with one or more fins having a fin wall width of about 200 microns.

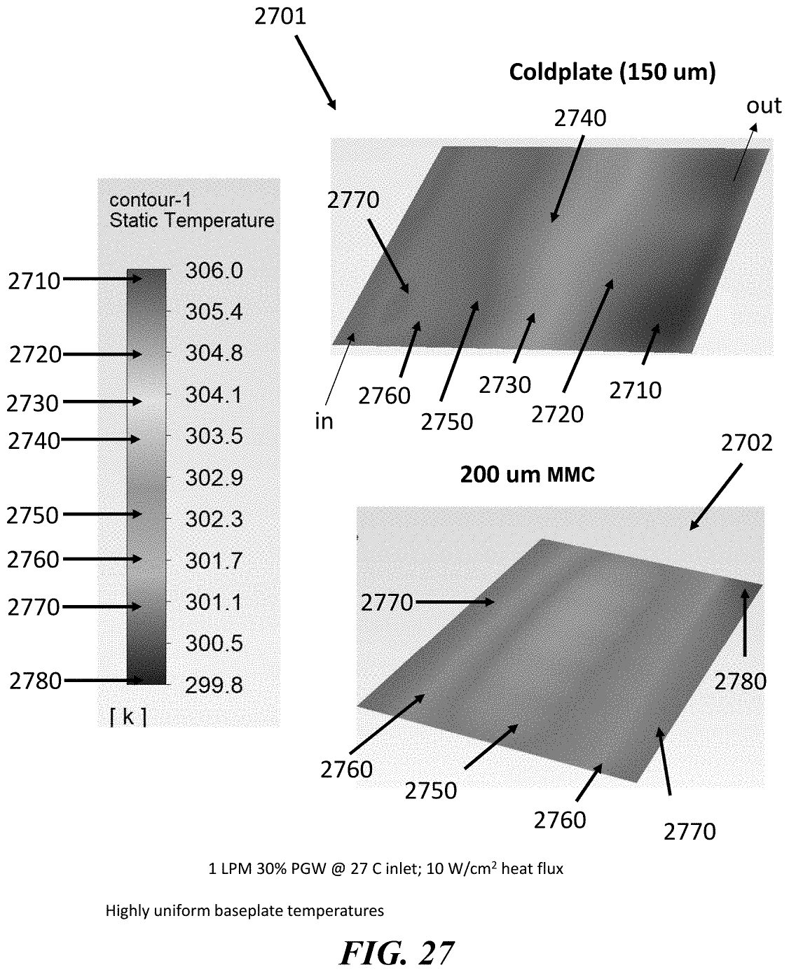

FIG. 27 illustrates a heat map comparison between a manifold micro-channel (MMC) cold plate and a commercial micro-channel cold plate. The heat map may comprise one or more zones of a cold plate. The one or more zones may have different temperatures. A heat map of a commercial microchannel cold plate 2701 and a heat map of a manifold microchannel cold plate 2702 may be generated based on a flow of a cooling fluid across the commercial microchannel cold plate 2701 and the manifold microchannel cold plate 2702. The cooling fluid may comprise about 30% propylene glycol-water (weight by volume) and may have a temperature of about 27 degrees Celsius at an inlet of the manifold block. The heat maps 2701 and 2702 for the manifold micro-channel (MMC) cold plate and the commercial micro-channel cold plate may be generated based on a pre-determined heat flux through the manifold micro-channel (MMC) cold plate and the commercial micro-channel cold plate. In some embodiments, the pre-determined heat flux may be about 10 Watts/cm². The commercial microchannel cold plate associated with the heat map 2701 may be in thermal contact with one or more fins having a fin wall width of about 150 microns. The manifold microchannel cold plate associated with the heat map 2702 may be in thermal contact with one or more fins having a fin wall width of about 150 microns.

As shown in FIG. 27, the heat maps 2701 and 2702 for the commercial microchannel cold plate and the manifold microchannel cold plate may comprise a plurality of zones 2710, 2720, 2730, 2740, 2750, 2760, 2770, and 2780. A first zone 2710 may correspond to a portion of the cold plate with a static temperature of about 306.0 kelvins. A second zone 2720 may correspond to a portion of the cold plate with a static temperature of about 304.8 kelvins. A third zone 2730 may correspond to a portion of the cold plate with a static temperature of about 304.1 kelvins. A fourth zone 2740 may correspond to a portion of the cold plate with a static temperature of about 303.5 kelvins. A fifth zone 2750 may correspond to a portion of the cold plate with a static temperature of about 302.3 kelvins. A sixth zone 2760 may correspond to a portion of the cold plate with a static temperature of about 301.7 kelvins. A seventh zone 2770 may correspond to a portion of the cold plate with a static temperature of about 301.1 kelvins. An eighth zone 2780 may correspond to a portion of the cold plate with a static temperature of about 299.8 kelvins.

The heat map 2701 for the commercial microchannel cold plate may comprise a plurality of zones 2710, 2720, 2730, 2740, 2750, 2760, and 2770. The plurality of zones may be generated as a cooling fluid flows from a bottom left portion of the illustrated heat map 2701 to an upper right portion of the illustrated heat map 2701. The heap map 2701 may correspond to a commercial microchannel cold plate with an array of fins comprising one or more fins with a feature size (i.e., a fin wall width) of about 150 microns.

The heat map 2702 for the manifold microchannel cold plate may comprise a plurality of zones 2750, 2760, 2770, and 2780. The plurality of zones may be generated as a cooling fluid flows from a bottom left portion of the illustrated heat map 2702 to an upper right portion of the illustrated heat map 2702. The heap map 2702 may correspond to a manifold microchannel cold plate with an array of fins comprising one or more fins with a feature size (i.e., a fin wall width) of 200 microns.

As shown in FIG. 27, the manifold microchannel cold plate may exhibit better thermal performance than a commercial microchannel cold plate. Based on a comparison of the heat maps 2701 and 2702, a manifold microchannel cold plate may exhibit baseplate temperatures that are more uniform than the baseplate temperatures of a commercial microchannel cold plate, for a similar pre-determined heat flux.

A fin of the array of fins and a manifold wall of the array of manifold walls may be oriented in different directions. In some cases, a fin of the array of fins and a manifold wall of the array of manifold walls may be oriented perpendicular to each other. A fin from the array of fins may be disposed at an angle relative to a manifold wall of the array of manifold walls. The angle may be at least about 5 degrees, 10 degrees, 15 degrees, 20 degrees, 25 degrees, 30 degrees, 35 degrees, 40 degrees, 45 degrees, 50 degrees, 55 degrees, 60 degrees, 65 degrees, 70 degrees, 75 degrees, 80 degrees, 85 degrees, 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees, 160 degrees, 165 degrees, 170 degrees, 175 degrees, or more. Alternatively, the angle may be at most about 175 degrees, 170 degrees, 165 degrees, 160 degrees, 155 degrees, 150 degrees, 145 degrees, 140 degrees, 135 degrees, 130 degrees, 125 degrees, 120 degrees, 115 degrees, 110 degrees, 105 degrees, 100 degrees, 95 degrees, 90 degrees, 85 degrees, 80 degrees, 75 degrees, 70 degrees, 65 degrees, 60 degrees, 55 degrees, 50 degrees, 45 degrees, 40 degrees, 35 degrees, 30 degrees, 25 degrees, 20 degrees, 15 degrees, 10 degrees, 5 degrees, or less.

As described above, in some cases the array of fins and the array of manifold walls may comprise a same material. Alternatively, the array of fins and the array of manifold walls may comprise different materials.

In another aspect, the present disclosure provides a thermal management device comprising a baseplate in thermal communication with a heat source. An area of the baseplate may be divided into a plurality of zones. A zone of the plurality of zones may comprise a plurality of fins in thermal communication with the baseplate.

The array of fins may comprise a plurality of zones. The plurality of zones may correspond to one or more portions of a surface of the plate or the microchannel surface. The plurality of zones may comprise one or more fins within the array of fins. The plurality of zones may comprise a first zone and a second zone. The first zone and the second zone may have different thermal resistivities. The first zone and the second zone may have different flow resistances.

The array of fins may be configured such that a fluid may be permitted to flow across and/or through the array of fins. In some cases, a fluid may flow across a first zone of the array of fins at a first flow rate. The fluid may flow across a second zone of the array of fins at a second flow rate. The first flow rate may different than the second flow rate. In some cases, the first zone of the array of fins may have a different flow resistance than the second zone of the array of fins. A variability of flow rates and/or flow resistances across different zones of the array of fins may allow for a reduction in pressure drop between an inlet and an outlet of the manifold block of the thermal management devices disclosed herein.

The flow rate of a fluid across one or more zones of the plurality of zones may range from a flow rate of between about 0.01 liters per meter (LPM) to about 10 LPM. For example, the flow rate may be at least about 0.01 LPM, 0.02 LPM, 0.03 LPM, 0.04 LPM, 0.05 LPM, 0.06 LPM, 0.07 LPM, 0.08 LPM, 0.09 LPM, 0.1 LPM, 0.2 LPM, 0.3 LPM, 0.4 LPM, 0.5 LPM, 0.6 LPM, 0.7 LPM, 0.8 LPM, 0.9 LPM, 1 LPM, 2 LPM, 3 LPM, 4 LPM, 5 LPM, 6 LPM, 7 LPM, 8 LPM, 9 LPM, 10 LPM, or more. Alternatively, the flow rate may be at most about 10 LPM, 9 LPM, 8 LPM, 7 LPM, 6 LPM, 5 LPM, 4 LPM, 3 LPM, 2 LPM, 1 LPM, 0.9 LPM, 0.8 LPM, 0.7 LPM, 0.6 LPM, 0.5 LPM, 0.4 LPM, 0.3 LPM, 0.2 LPM, 0.1 LPM, 0.09 LPM, 0.08 LPM, 0.07 LPM, 0.06 LPM, 0.05 LPM, 0.04 LPM, 0.03 LPM, 0.02 LPM, 0.01 LPM, or less. In some embodiments, the flow rate may range from about 0.5 LPM to 2 LPM. For example, the flow rate may be about 0.5 LPM, 0.6 LPM, 0.7 LPM, 0.8 LPM, 0.9 LPM, 1.0 LPM, 1.1 LPM, 1.2 LPM, 1.3 LPM, 1.4 LPM, 1.5 LPM, 1.6 LPM, 1.7 LPM, 1.8 LPM, 1.9 LPM, or 2 LPM.

The plurality of zones may comprise a first zone and a second zone. A first flow rate of the fluid across the first zone may be greater than a second flow rate of the fluid across the second zone by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, 80%, 90%, 100%, 200%, 300%, 400%, 500%, 600%, 700%, 800%, 900%, 1000% or more. The first flow rate of the fluid across the first zone may be greater than the second flow rate of the fluid across the second zone by at most about 1000%, 900%, 800%, 700%, 600%, 500%, 400%, 300%, 200%, 100%, 90%, 80%, 70%, 60%, 50%, 40%, 30%, 20%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less.

As described above, in some cases the thermal management device may comprise a plurality of zones. The plurality of zones may have a similar thermal resistivity. Alternatively, the plurality of zones may have different thermal resistivities. The thermal resistivity of a zone of the plurality zones may be between about 5 square millimeters degrees Celsius per Watt (mm²·° C./W) and about 50 mm²·° C./W.

The plurality of zones may comprise a first zone and a second zone. A first thermal resistivity of the first zone may be greater than a second thermal resistivity of the second zone by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, 80%, 90%, 100%, 200%, 300%, 400%, 500%, 600%, 700%, 800%, 900%, 1000% or more. The first thermal resistivity of the first zone may be greater than the second thermal resistivity of the second zone by at most about 1000%, 900%, 800%, 700%, 600%, 500%, 400%, 300%, 200%, 100%, 90%, 80%, 70%, 60%, 50%, 40%, 30%, 20%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less.

The plurality of zones may comprise one or more zones having one or more areas associated with each zone. The area of a zone of the plurality of zones may range from about 0.01 square millimeter (mm²) to about 1000 mm². For example, the area of the zone may be at least about 0.01 mm², 0.02 mm², 0.03 mm², 0.04 mm², 0.05 mm², 0.06 mm², 0.07 mm², 0.08 mm², 0.09 mm², 0.1 mm², 0.2 mm², 0.3 mm², 0.4 mm², 0.5 mm², 0.6 mm², 0.7 mm², 0.8 mm², 0.9 mm², 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², 200 mm², 300 mm², 400 mm², 500 mm², 600 mm², 700 mm², 800 mm², 900 mm², 1000 mm², or more. Alternatively, the area of the zone may be at most about 1000 mm², 900 mm², 800 mm², 700 mm², 600 mm², 500 mm², 400 mm², 300 mm², 200 mm², 100 mm², 90 mm², 80 mm², 70 mm², 60 mm², 50 mm², 40 mm², 30 mm², 20 mm², 10 mm², 9 mm², 8 mm², 7 mm², 6 mm², 5 mm², 4 mm², 3 mm², 2 mm², 1 mm², 0.9 mm², 0.8 mm², 0.7 mm², 0.6 mm², 0.5 mm², 0.4 mm², 0.3 mm², 0.2 mm², 0.1 mm², 0.09 mm², 0.08 mm², 0.07 mm², 0.06 mm², 0.05 mm², 0.04 mm², 0.03 mm², 0.02 mm², 0.01 mm², or less. In some cases, the area of a zone may range from about 0.05 square millimeter (mm²) to about 650 mm². For example, the area of the zone may be about 0.05 mm², 0.06 mm², 0.07 mm², 0.08 mm², 0.09 mm², 0.1 mm², 0.2 mm², 0.3 mm², 0.4 mm², 0.5 mm², 0.6 mm², 0.7 mm², 0.8 mm², 0.9 mm², 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², 150 mm², 200 mm², 250 mm², 300 mm², 350 mm², 400 mm², 450 mm², 500 mm², 550 mm², 600 mm², or 650 mm². In some embodiments, the area of the zone may be between about 100 square millimeter (mm²) and about 500 mm². For example, the area of the zone may be about 100 mm², 150 mm², 200 mm², 250 mm², 300 mm², 350 mm², 400 mm², 450 mm², or 500 mm².

The plurality of zones may comprise a first zone and a second zone. A first area of the first zone may be greater than a second area of the second zone by at least about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, 80%, 90%, 100%, 200%, 300%, 400%, 500%, 600%, 700%, 800%, 900%, 1000% or more. The first area of the first zone may be greater than the second area of the second zone by at most about 1000%, 900%, 800%, 700%, 600%, 500%, 400%, 300%, 200%, 100%, 90%, 80%, 70%, 60%, 50%, 40%, 30%, 20%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or less.

In some embodiments, the thermal management device may exhibit a thermal resistance that is at least 5% less than that of a thermal management device without any of the heat transfer structures disclosed and contemplated herein. In some cases, the thermal resistance of the thermal management devices disclosed herein may be less than a thermal resistance of a thermal management device without any of the heat transfer structures by at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, or 95%. Alternatively, the thermal resistance of the thermal management devices disclosed herein may be less than a thermal resistance of a thermal management device without any of the heat transfer structures by at most about 95%, 90%, 85%, 80%, 75%, 70%, 65%, 60%, 55%, 50%, 45%, 40%, 35%, 30%, 25%, 20%, 15%, 10%, 5%, or less.

In some embodiments, the thermal management device may exhibit a thermal resistance that is at least 10% less than a thermal management device without any heat transfer structure. In some embodiments, the thermal management device may exhibit a thermal resistance that is at least 40% less than a thermal management device without any heat transfer structure.

As described above, each fin of the array of fins may be separated by a distance. The distance may correspond to a spacing between one or more fins (i.e., a fin-to-fin spacing). In some embodiments, the fin-to-fin spacing may range from between about 10 nanometers to about 1,000 micrometers. The distance between a first fin and a second fin adjacent to the first fin may be at least about 40 micrometers. In some cases, a distance between a first fin and a second fin adjacent to the first fin may be at least about 200 micrometers. In other cases, the distance may be at least about 250 micrometers. In any of the embodiments described herein, the distance between the first fin and the second fin adjacent to the first fin may range from between about 100 micrometers to about 1 centimeter. For example, the distance between the first fin and the second fin may be about 100 micrometers, 150 micrometers, 200 micrometers, 250 micrometers, 300 micrometers, 350 micrometers, 400 micrometers, 450 micrometers, 500 micrometers, 550 micrometers, 600 micrometers, 650 micrometers, 700 micrometers, 750 micrometers, 800 micrometers, 850 micrometers, 900 micrometers, 950 micrometers, 1 millimeter, 2 millimeters, 3 millimeters, 4 millimeters, 5 millimeters, 6 millimeters, 7 millimeters, 8 millimeters, 9 millimeters, or 1 centimeter.

In some cases, a thermal resistivity of the thermal management device may be at most about 25 mm²·° C./W when a fluid comprising 30% propylene glycol in water flows through and/or across a portion of the thermal management device. In some cases, the thermal resistivity may be at most about 20 mm²·° C./W when a fluid comprising 30% propylene glycol in water flows through and/or across a portion of the thermal management device.

In some examples, the heat transfer structure of the thermal management device may fill at least 5% of a volume disposed between a first fin and a second fin of the array of fins. In other examples, the heat transfer structure may fill at least 10% of the volume disposed between the first fin and the second fin. In another example, the heat transfer structure of thermal management device may fill at least 20% of the volume disposed between the first fin and the second fin.

In any of the embodiments described herein, the heat transfer structure may fill between about 1% to 95% of a volume disposed between the first and the second fin. The heat transfer structure may fill at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or more of a volume disposed between the first fin and the second fin. The heat transfer structure may fill at most about 95%, 90%, 85%, 80%, 75%, 70%, 65%, 60%, 55%, 50%, 45%, 40%, 35%, 30%, 25%, 20%, 15%, 10%, 5%, or less of a volume disposed between the first fin and the second fin. In some cases, the heat transfer structure may fill between about 20% and about 50% of the volume disposed between a first fin and a second fin of the array of fins.

The heat transfer structure may be in contact with at least 5% of a surface of the first fin or the second fin. The heat transfer structure may be in contact with at least 10% of the surface of the first fin or the second fin. The heat transfer structure may be in contact with at least 20% of the surface of the first fin or the second fin.

In any of the embodiments described herein, the heat transfer structure may be in contact with about 1% to 95% of a surface of the first or the second fin. The heat transfer structure may be in contact with at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or more of a surface of the first fin or the second fin. The heat transfer structure may be in contact with at most about 95%, 90%, 85%, 80%, 75%, 70%, 65%, 60%, 55%, 50%, 45%, 40%, 35%, 30%, 25%, 20%, 15%, 10%, 5%, or less of a surface of the first fin or the second fin.

The array of fins may comprise a material exhibiting a thermal conductivity greater than about 200 Watts per meter-Kelvin (W/m·K). The thermal conductivity may range from about 100 W/m·K to about 1000 W/m·K. In some cases, the thermal conductivity may range from about 10 W/m·K to about 10,000 W/m·K. For example, the thermal conductivity may be at least about 10 W/m·K, 20 W/m·K, 30 W/m·K, 40 W/m·K, 50 W/m·K, 60 W/m·K, 70 W/m·K, 80 W/m·K, 90 W/m·K, 100 W/m·K, 200 W/m·K, 300 W/m·K, 400 W/m·K, 500 W/m·K, 600 W/m·K, 700 W/m·K, 800 W/m·K, 900 W/m·K, 1000 W/m·K, 2000 W/m·K, 3000 W/m·K, 4000 W/m·K, 5000 W/m·K, 6000 W/m·K, 7000 W/m·K, 8000 W/m·K, 9000 W/m·K, 10,000 W/m·K, or more. Alternatively, the thermal conductivity may be at most about 10,000 W/m·K, 9000 W/m·K, 8000 W/m·K, 7000 W/m·K, 6000 W/m·K, 5000 W/m·K, 4000 W/m·K, 3000 W/m·K, 2000 W/m·K, 1000 W/m·K, 900 W/m·K, 800 W/m·K, 700 W/m·K, 600 W/m·K, 500 W/m·K, 400 W/m·K, 300 W/m·K, 200 W/m·K, 100 W/m·K, 90 W/m·K, 80 W/m·K, 70 W/m·K, 60 W/m·K, 50 W/m·K, 40 W/m·K, 30 W/m·K, 20 W/m·K, 10 W/m·K, or less.

The thermal management device may exhibit a thermal resistivity. The thermal resistivity may be greater than about 0.1 mm²·° C./W. The thermal resistivity may be less than about 100 mm²·° C./W. The thermal resistivity may be at least about 0.1 mm²·° C./W, 0.2 mm²·° C./W, 0.3 mm²·° C./W, 0.4 mm²·° C./W, 0.5 mm²·° C./W, 0.6 mm²·° C./W, 0.7 mm²·° C./W, 0.8 mm²·° C./W, 0.9 mm²
° C./W, 1 mm²·° C./W, 2 mm²·° C./W, 3 mm²·° C./W, 4 mm²·° C./W, 5 mm²·° C./W, 6 mm²·° C./W, 7 mm²·° C./W, 8 mm²·° C./W, 9 mm²·° C./W, 10 mm²·° C./W, 15 mm²·° C./W, 20 mm²·° C./W, 30 mm²·° C./W, 40 mm²·° C./W, 50 mm²·° C./W, 60 mm²·° C./W, 70 mm²·° C./W, 80 mm²·° C./W, 90 mm²·° C./W, 100 mm²·° C./W, or more. The thermal resistivity may be at most about 100 mm²·° C./W, 90 mm²·° C./W, 80 mm²·° C./W, 70 mm²·° C./W, 60 mm²·° C./W, 50 mm²·° C./W, 40 mm²·° C./W, 30 mm²·° C./W, 20 mm²·° C./W, 15 mm²·° C./W, 10 mm²·° C./W, 9 mm²·° C./W, 8 mm²·° C./W, 7 mm²·° C./W, 6 mm²·° C./W, 5 mm²·° C./W, 4 mm²·° C./W, 3 mm²·° C./W, 2 mm²·° C./W, 1 mm²·° C./W, 0.9 mm²·° C./W, 0.8 mm²·° C./W, 0.7 mm²·° C./W, 0.6 mm²·° C./W, 0.5 mm²·° C./W, 0.4 mm²·° C./W, 0.3 mm²·° C./W, 0.2 mm²·° C./W, 0.1 mm²·° C./W, or less.

The heat transfer structure may comprise a structural component. The structural component or a portion of the structural component may be in physical and/or thermal contact with one or more fins. A plurality of structural components may be disposed between two or more fins. The structural component may comprise a linear ridge parallel to the baseplate, a lattice, a pin, and/or a helix. In some cases, the structural component may comprise a portion of a linear ridge parallel to the baseplate, a lattice, a pin, and/or a helix. The one or more structural components may comprise different cross-sectional shapes and/or different dimensions. The heat transfer structure may comprise one or more ancillary structures as described below.

The thermal management device may comprise one or more ancillary structures disposed between at least two adjacent fins. The heat transfer structures described herein may comprise the one or more ancillary structures. The one or more ancillary structures may be in thermal communication with at least one of the two adjacent fins and optionally with the baseplate. The ancillary structures may be selected from the group consisting of linear ridges, aerodynamic solids, chevrons, triangular prisms, lattices, pins, and helices.

In some embodiments, the ancillary structures may comprise one or more aerodynamic solids. As used throughout this specification, an aerodynamic solid may be referred to interchangeably as a chevron. The one or more aerodynamic solids may be solids pieces of material that are arranged on the thermal management device or a portion of the thermal management devise. A cross-section of the aerodynamic solid may vary along a direction of fluid flow. The one or more aerodynamic solids may have a leading edge that is convex. A smallest cross section of the aerodynamic solid may be located at a leading edge of the aerodynamic solid to minimize a pressure drop of a fluid as the fluid flows past the aerodynamic solid. The smallest cross section of the aerodynamic solid may be a cross section of the aerodynamic solid that is perpendicular to a direction of fluid flow. The aerodynamic solid may have one or more trailing edges. A trailing edge of the aerodynamic solid may be flat, concave, or convex. In some cases, the trailing edge may be rounded or sharp. Examples of such aerodynamic solids may include, but are not limited to, ellipsoids, ovoids, three-dimensional (3D) teardrops, airfoils, cones, spheres, octahedrons, triangular prisms, square-based pyramids, triangle-based pyramids, and/or hexagonal-based pyramids.

The ancillary structures of the thermal management device may comprise one or more linear ridges and/or one or more triangular prisms (e.g., square-based pyramids, triangle-based pyramids, and/or hexagonal-based pyramids). The one or more linear ridges and/or the one or more triangular prisms may be parallel to the baseplate of the thermal management device.

As described elsewhere herein, the thermal management device may comprise a baseplate and an array of fins in thermal contact with the baseplate. The baseplate and the array of fins may comprise a material exhibiting a thermal conductivity. The thermal conductivity may be greater than about 200 W/m-K.

The thermal management device may be configured such that a cooling fluid is permitted to flow through said thermal management device with a device flow rate and a device flow velocity. The device flow rate and/or the device flow velocity may be at least about 0.01 liters per minute (LPM), 0.02 LPM, 0.03 LPM, 0.04 LPM, 0.05 LPM, 0.06 LPM, 0.07 LPM, 0.08 LPM, 0.09 LPM, 0.1 LPM, 0.2 LPM, 0.3 LPM, 0.4 LPM, 0.5 LPM, 0.6 LPM, 0.7 LPM, 0.8 LPM, 0.9 LPM, 1 LPM, 2 LPM, 3 LPM, 4 LPM, 5 LPM, 6 LPM, 7 LPM, 8 LPM, 9 LPM, 10 LPM, or more. Alternatively, the flow rate may be at most about 10 LPM, 9 LPM, 8 LPM, 7 LPM, 6 LPM, 5 LPM, 4 LPM, 3 LPM, 2 LPM, 1 LPM, 0.9 LPM, 0.8 LPM, 0.7 LPM, 0.6 LPM, 0.5 LPM, 0.4 LPM, 0.3 LPM, 0.2 LPM, 0.1 LPM, 0.09 LPM, 0.08 LPM, 0.07 LPM, 0.06 LPM, 0.05 LPM, 0.04 LPM, 0.03 LPM, 0.02 LPM, 0.01 LPM, or less.

In some cases, the one or more fins of the plurality of fins may be planar. In some cases, the one or more fins of the plurality of fins may be jagged. In some cases, the one or more fins of the plurality of fins may be parallel to each other.

In another aspect, the present disclosure provides a thermal management device comprising an array of fins and a manifold block located adjacent to the array of fins. A fin of the array of fins may be configured for heat transfer to or from a fluid in contact with the fin. At least a portion of a surface of the fin may be textured.

The textured portion of the fin may comprise one or more surface features. In some cases, the textured portion of the fin may comprise a plurality of periodically-spaced surface features disposed along a smooth surface of the fin in one or more directions. The periodically-spaced surface features may comprise a protrusion, a depression, a well, a void, a channel, a perforation, a groove, a slit, an airfoil, a modification thereof, or a combination thereof. The periodically-spaced surface features may be different. The periodically-spaced surface features may not be different. In other cases, the textured portion of the fin may comprise a plurality of surface features disposed along a smooth surface of the fin in one or more directions. The plurality of surface features may comprise a protrusion, a depression, a well, a void, a channel, a perforation, a groove, a slit, or an airfoil. In some cases, the plurality of surface features of the textured portion of the fin may not be periodically spaced. A textured portion or surface of the fin may have one or more peaks and one or more valleys. The textured portion or surface may have features that are periodic. Alternatively, or in addition, the textured portion or surface may have features that are non-periodic.

The manifold block of the thermal management device may comprise an inlet, an outlet, and a fluid flow path in fluid communication with the inlet and the outlet. The fluid flow path may be configured to direct the fluid (i) from the inlet to the fin, and (ii) from the fin to the outlet.

In some cases, the thermal management device may further comprise a plate adjacent to the array of fins. The plate may be configured to transfer heat from a source of the heat to the array of fins. The plate may be configured to transfer heat from the array of fins to a sink of the heat.

The array of fins of the thermal management device may further comprise an additional fin adjacent to said fin. A portion of the fin and a portion of the additional fin may not be in physical contact with one other.

The thermal management device may further comprise an array of manifold walls in thermal contact with the array of fins. A fin of the array of fins and a manifold wall of the array of manifold walls may be oriented in different directions relative to each other. In some cases, a fin of the array of fins and a manifold wall of the array of manifold walls may be oriented perpendicular to each other. The array of fins and the array of manifold walls may comprise the same material. In some cases, the array of fins and the array of manifold walls may comprise different materials.

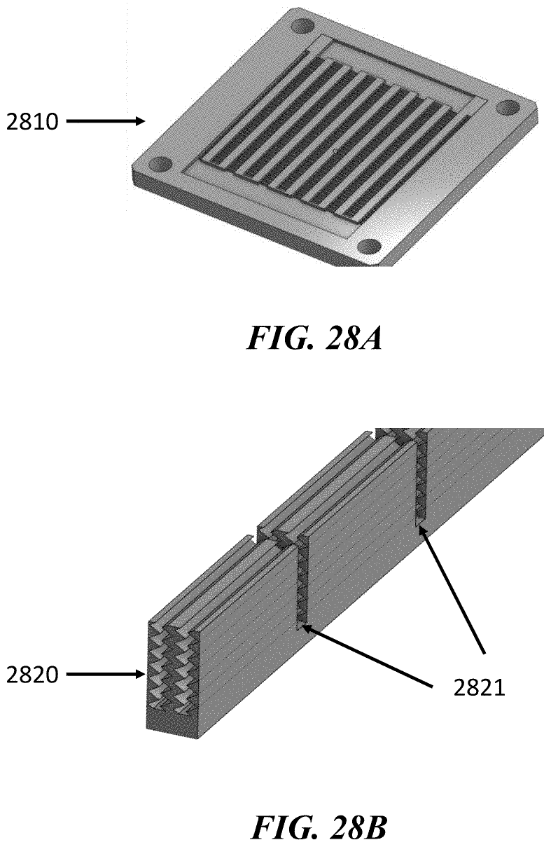

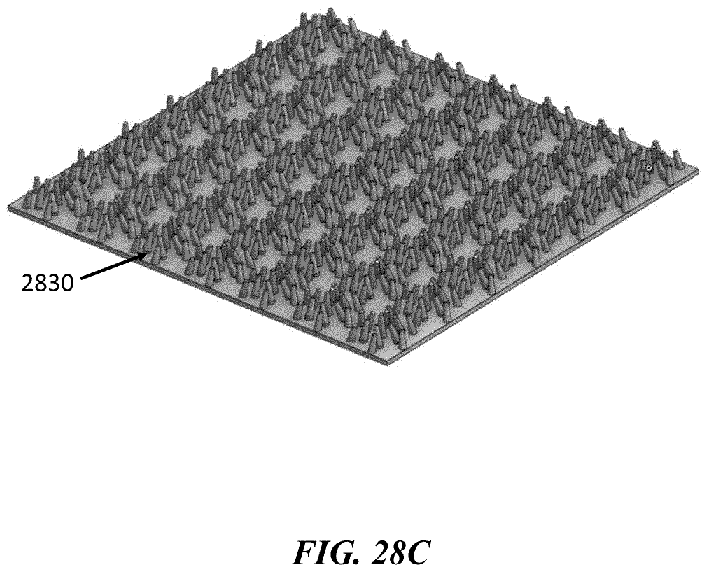

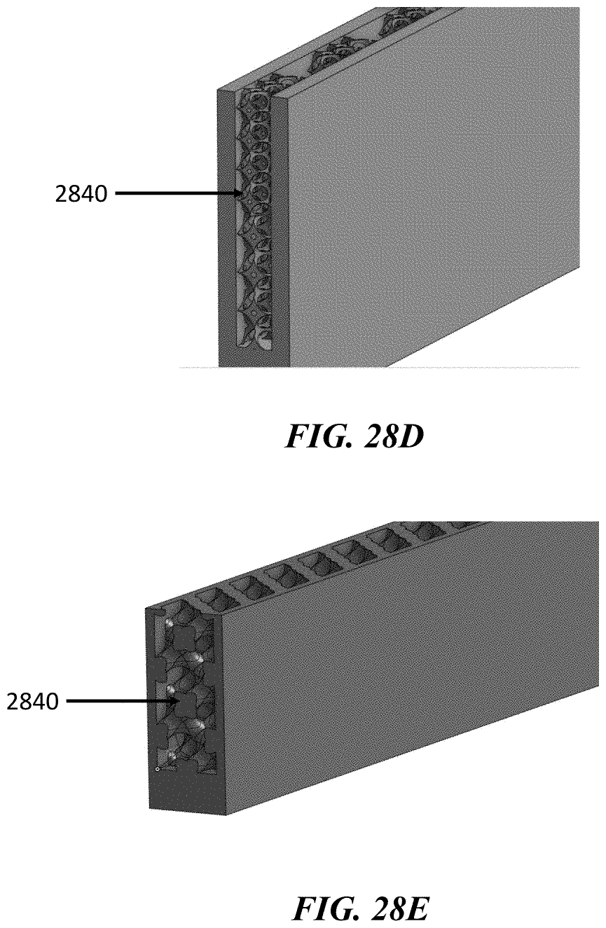

FIG. 28A illustrates an example of a manifold microchannel cold plate with a plurality of manifolds that are parallel to one another. The plurality of manifolds may form a plurality of manifold channels disposed between the manifolds. The manifold microchannel cold plate may operate in a manner similar to the manifold microchannel cold plates described above and referenced in FIGS. 25A-25B.

In some cases, the thermal management devices disclosed herein may comprise an array of fins and an array of manifold walls. The array of manifold walls may be disposed over the array of fins and may be in thermal contact with the array of fins. In some cases, a fin architecture of the array of fins and/or a manifold architecture of the array of manifold walls may be modified to induce turbulence and increase a surface area of the fins, thereby improving heat transfer and the thermal performance of the thermal management device. A fin architecture may correspond to a shape, size, orientation, or distribution of one or more fins in the array of fins. A manifold architecture may correspond to a shape, size, orientation, or distribution of one or more manifold walls of the array of manifold walls. Modifying the fin architecture may provide one or more modified channels between two or more fins of the array of fins. Modifying the manifold architecture may provide one or more modified microchannels between two or more manifold walls of the array of manifold walls.

As shown in FIG. 28B, in some cases the one or more microchannels of the thermal management device may be configured as wavy microchannels 2820. The wavy microchannels 2820 may comprise a plurality of jagged cutouts. The one or more jagged cutouts may be in a shape of a triangle. The one or more jagged cutouts may extend along a length of the wavy microchannels 2820. The wavy microchannels 2820 may increase a surface area usable for heat transfer.

The wavy microchannels 2820 may comprise one or more grooves or slits 2821 for intermixing a cooling fluid across different microchannels. The one or more grooves or slits 2821 may be disposed along a length of the wavy microchannels 2820. The one or more grooves or slits 2821 may be oriented perpendicular to a length of the wavy microchannels 2820. The one or more grooves or slits 2821 may aid in manufacturing or cleaning of the wavy microchannels 2820. The grooves or slits 2821 may have a width of at most about 80 microns.

As shown in FIG. 28C, in some cases the cold plate may comprise a plurality of impingement surfaces. The plurality of impingement surfaces may comprise one or more pins 2830. The one or more pins may be grouped into multiple sets of pins. The multiple sets of pins may be distributed across a surface of the plate. The one or more pins may vary in thickness across a height of the pins. The one or more pins may extend or curve upwards from a surface of the cold plate at one or more distinct angles relative to the cold plate. The one or more pins may be configured to induce turbulence as a cooling fluid flows across and/or through the one or more impingement surfaces.

As shown in FIGS. 28D-28E, in some cases, the thermal management device may comprise one or more connecting structures 2840 disposed between two or more fins of the array of fins. The connecting structures 2840 may be configured to control a flow of a cooling fluid between the two or more fins. The one or more connecting structures 2840 may correspond to the heat transfer structures described elsewhere herein. In some cases, the connecting structures 2840 may comprise one or more lattices. In other cases, the connecting structures 2840 may comprise a plurality of solid objects distributed in between two or more fins. The plurality of solid objects may comprise one or more protrusions, grooves, or periodically-spaced surface features (e.g., one or more protrusions, depressions, wells, voids, channels, perforations, grooves, and/or slits). Alternatively, the connecting structures 2840 may comprise a plurality of semi-solid objects distributed in between two or more fins. The plurality of semi-solid objects may comprise one or more grooves, perforations, void, and/or channels that may permit a cooling fluid to flow through the semi-solid objects. The connecting structures 2840 disposed between the two or more fins may comprise a different material than the two or more fins in thermal contact with the connecting structures 2840.

In some cases, the thermal management device may comprise an array of fins. The array of fins may comprise a plurality of fins. Each fin of the plurality of fins may comprise a continuous fin wall. A continuous fin wall may be a fin wall that does not comprise any discontinuities, slits, openings, or surface features disposed along a surface of a fin wall or a portion of the fin.

In some cases, each fin of the plurality of fins may be discontinuous with one or more discontinuities, slits, openings, holes, perforations, or surface features disposed on a portion of the fin. In such cases, each fin may comprise one or more discontinuities, slits, openings, holes, perforations, or surface features disposed along a length of the fin.

In some cases, at least some of the fins of the thermal management device may comprise a comb structure. A fin with a comb structure may correspond to a fin with one or more discontinuities or slits disposed along a length of the fin. The one or more discontinuities or slits may be arranged periodically along a length of the fin. Alternatively, the one or more discontinuities or slits may be arranged in a non-periodic and irregular pattern along a length of the fin. A fin with a comb structure may comprise a longitudinal cross section having a shape of a sine wave, a triangle wave, a square wave, a sawtooth wave, or a combination thereof. The one or more discontinuities on a fin may be regular with openings arranged periodically. Alternatively, the one or more discontinuities on a fin may be irregular with openings arranged non-periodically. The one or more discontinuities of the fins may help to break or disrupt a boundary layer of a fluid flowing adjacent to a surface of the fin, thereby creating greater turbulence and mixing to enhance heat transfer. Additionally, during fabrication of the thermal management device (e.g., by using one or more three-dimensional (3D) printing methods disclosed herein), the one or more discontinuities in the fin walls may be used to facilitate removal of uncured feedstock.

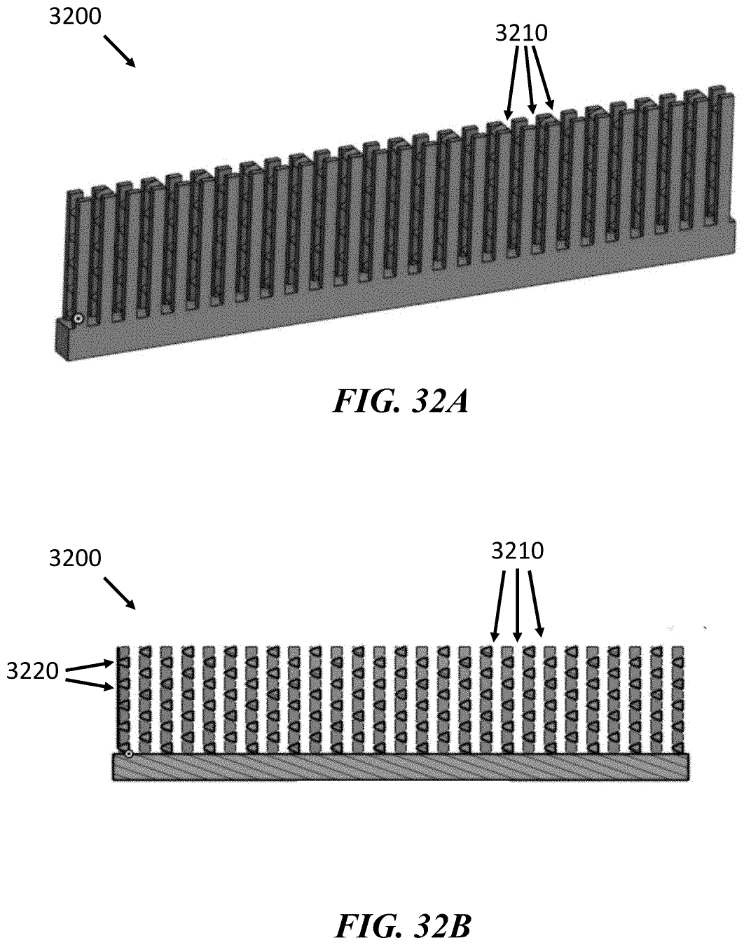

FIGS. 32A and 32B an array of fins 3200 comprising two adjacent fins. The two adjacent fins may have a plurality of slits or discontinuities 3210 disposed along a length of the fins. The discontinuities 3210 may be arranged periodically along a length of the fins. As shown in FIG. 32B, a plurality of aerodynamic solids 3220 may be disposed between the two adjacent fins. The plurality of aerodynamic solids 3220 may provide texture to such fins. The aerodynamic solids 3220 may have a triangular cross section. The aerodynamic solids 3220 may be disposed along a height of the fins. The aerodynamic solids 3220 may be arranged periodically along the height of the fins. In some cases, the aerodynamic solids 3220 may be arranged along the height of the fins in a non-periodic arrangement pattern.

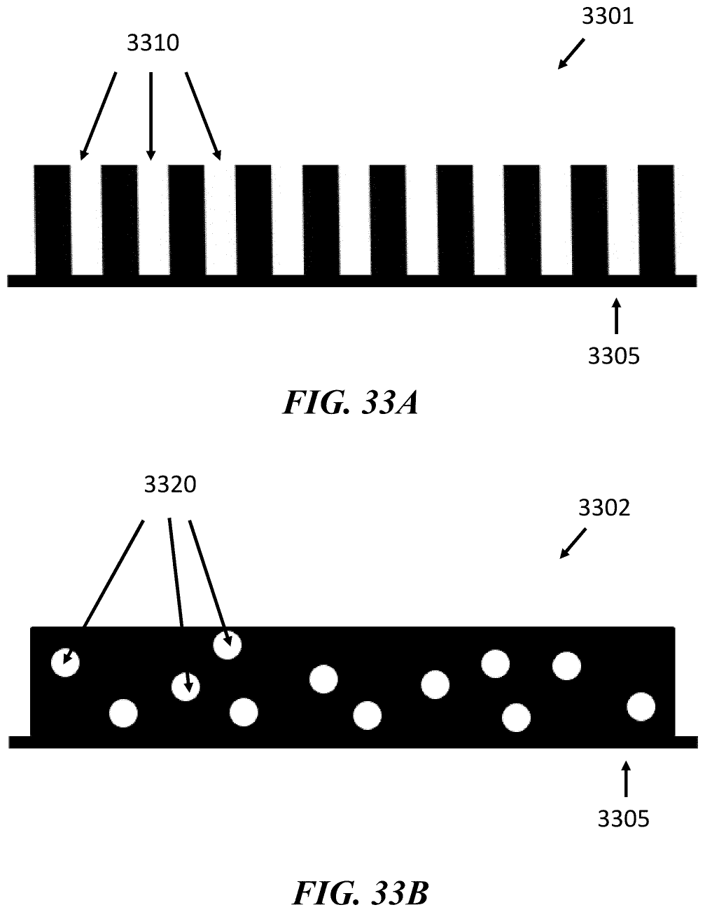

FIGS. 33A and 33B illustrate examples of discontinuous fins. FIG. 33A shows a discontinuous fin 3301 in thermal contact with a baseplate 3305. The discontinuous fin 3301 may be in the shape of a square wave. The discontinuous fin 3301 may comprise a plurality of slits or discontinuities 3210 disposed along a length of the discontinuous fins. The discontinuities 3210 may be arranged periodically along a length of the discontinuous fins. FIG. 33B shows a discontinuous fin 3302 in thermal contact with a baseplate 3305. The discontinuous fin 3302 may comprise a plurality of perforations 3320. The plurality of perforations 3320 may be disposed in a non-periodic and irregular pattern on a portion of the discontinuous fin 3302.

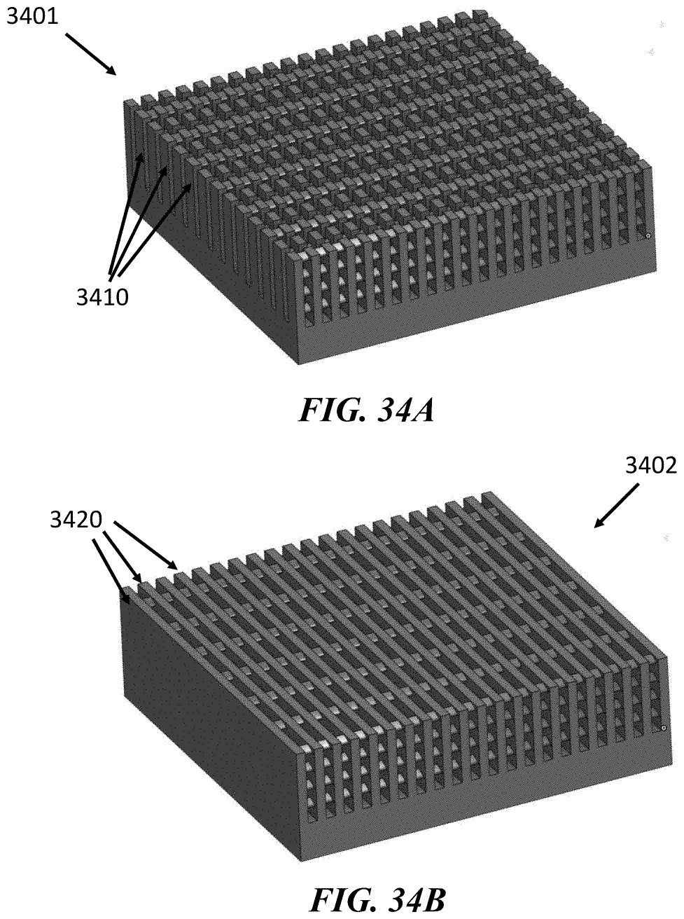

FIG. 34A illustrates an array of fins 3401 comprising a plurality of fins having one or more discrete walls 3410. The one or more discrete walls 3410 may correspond to one or more portions of the fins that do not comprise a discontinuity or slit. As described above, one or more ancillary structures may be disposed between two or more fins within the array of fins 3401. Additionally, the array of fins may or may not have the same number of ancillary structures at each fin to fin spacing. Furthermore, the ancillary structures may be distributed in a regular or irregular manner as pertaining to the cooling or heating needs.

FIG. 34B illustrates an array of fins 3402 comprising a plurality of fins having one or more continuous walls 3420. As described above, one or more ancillary structures may be disposed between two or more continuous walls 3420 of two or more fins within the array of fins 3402. Additionally, the array of fins may or may not have the same number of ancillary structures at each fin to fin spacing. Furthermore, the ancillary structures may be distributed in a regular or irregular manner as pertaining to the cooling or heating needs.

In any of the embodiments described herein, the plurality of fins within the array of fins may have different heights, widths, spacings, lengths, and/or thicknesses. For example, as shown in FIG. 35, a height 3520 of the plurality of fins of the array of fins 3510 may increase across a length 3515 of the array of fins 3510.

The array of fins of the thermal management device may comprise a plurality of zones. Each zone of the plurality of zones may comprise a subset of the fins within the array of fins. The first zone and the second zone of the plurality of zones may have different thermal resistivities and/or different flow resistances.

The thermal management device may be configured to permit a fluid to flow across one or more zones of the plurality of zones. A first flow rate of the fluid across a first zone and a second flow rate of the fluid across a second zone may be different. A first flow resistance of the fluid in a first zone and a second flow resistance of the fluid in a second zone may be different. A variability of flow rates and/or flow resistances across different zones of the array of fins may allow for a reduction in pressure drop of a fluid flowing between an inlet and an outlet of the manifold block of the thermal management device.

In some examples, a flow rate of said fluid across a zone of said plurality of zones may be between about 0.01 liters per meter (LPM) to 10 LPM. For example, the flow rate may be at least about 0.01 LPM, 0.02 LPM, 0.03 LPM, 0.04 LPM, 0.05 LPM, 0.06 LPM, 0.07 LPM, 0.08 LPM, 0.09 LPM, 0.1 LPM, 0.2 LPM, 0.3 LPM, 0.4 LPM, 0.5 LPM, 0.6 LPM, 0.7 LPM, 0.8 LPM, 0.9 LPM, 1 LPM, 2 LPM, 3 LPM, 4 LPM, 5 LPM, 6 LPM, 7 LPM, 8 LPM, 9 LPM, 10 LPM, or more.

Alternatively, the flow rate may be at most about 10 LPM, 9 LPM, 8 LPM, 7 LPM, 6 LPM, 5 LPM, 4 LPM, 3 LPM, 2 LPM, 1 LPM, 0.9 LPM, 0.8 LPM, 0.7 LPM, 0.6 LPM, 0.5 LPM, 0.4 LPM, 0.3 LPM, 0.2 LPM, 0.1 LPM, 0.09 LPM, 0.08 LPM, 0.07 LPM, 0.06 LPM, 0.05 LPM, 0.04 LPM, 0.03 LPM, 0.02 LPM, 0.01 LPM, or less. In some cases, the flow rate may range from about 0.5 LPM to 2 LPM. For example, the flow rate may be at least about 0.5 LPM, 0.6 LPM, 0.7 LPM, 0.8 LPM, 0.9 LPM, 1.0 LPM, 1.1 LPM, 1.2 LPM, 1.3 LPM, 1.4 LPM, 1.5 LPM, 1.6 LPM, 1.7 LPM, 1.8 LPM, 1.9 LPM, 2 LPM, or more. Alternatively, the flow rate may be at most about 2 LPM, 1.9 LPM, 1.8 LPM, 1.7 LPM, 1.6 LPM, 1.5 LPM, 1.4 LPM, 1.3 LPM, 1.2 LPM, 1.1 LPM, 1 LPM, 0.9 LPM, 0.8 LPM, 0.7 LPM, 0.6 LPM, 0.5 LPM, or less.

As described above, in some cases the thermal management device may comprise a plurality of zones. The plurality of zones may have a similar thermal resistivity. Alternatively, the plurality of zones may have different thermal resistivities. The thermal resistivity of a zone of the plurality zones may be between about 5 mm²·° C./W and about 50 mm²·° C./W.

The plurality of zones may have a plurality of areas. Each zone may have a same or similar area. Alternatively, two or more zones of the plurality of zones may have different areas. The area of a zone of said plurality of zones may range from between about 0.01 square millimeter (mm²) to about 1000 mm². For example, the area of the zone may be at least about 0.01 mm², 0.02 mm², 0.03 mm², 0.04 mm², 0.05 mm², 0.06 mm², 0.07 mm², 0.08 mm², 0.09 mm², 0.1 mm², 0.2 mm², 0.3 mm², 0.4 mm², 0.5 mm², 0.6 mm², 0.7 mm², 0.8 mm², 0.9 mm², 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², 200 mm², 300 mm², 400 mm², 500 mm², 600 mm², 700 mm², 800 mm², 900 mm², 1000 mm², or more. Alternatively, the area of the zone may be at most about 1000 mm², 900 mm², 800 mm², 700 mm², 600 mm², 500 mm², 400 mm², 300 mm², 200 mm², 100 mm², 90 mm², 80 mm², 70 mm², 60 mm², 50 mm², 40 mm², 30 mm², 20 mm², 10 mm², 9 mm², 8 mm², 7 mm², 6 mm², 5 mm², 4 mm², 3 mm², 2 mm², 1 mm², 0.9 mm², 0.8 mm², 0.7 mm², 0.6 mm², 0.5 mm², 0.4 mm², 0.3 mm², 0.2 mm², 0.1 mm², 0.09 mm², 0.08 mm², 0.07 mm², 0.06 mm², 0.05 mm², 0.04 mm², 0.03 mm², 0.02 mm², 0.01 mm², or less. In some cases, the area of a zone may range from about 0.05 square millimeter (mm²) to about 650 mm². For example, the area of the zone may be at least about 0.05 mm², 0.06 mm², 0.07 mm², 0.08 mm², 0.09 mm², 0.1 mm², 0.2 mm², 0.3 mm², 0.4 mm², 0.5 mm², 0.6 mm², 0.7 mm², 0.8 mm², 0.9 mm², 1 mm², 2 mm², 3 mm², 4 mm², 5 mm², 6 mm², 7 mm², 8 mm², 9 mm², 10 mm², 20 mm², 30 mm², 40 mm², 50 mm², 60 mm², 70 mm², 80 mm², 90 mm², 100 mm², 150 mm², 200 mm², 250 mm², 300 mm², 350 mm², 400 mm², 450 mm², 500 mm², 550 mm², 600 mm², 650 mm² or more. Alternatively, the area of the zone may be at most about 650 mm², 600 mm², 550 mm², 500 mm², 450 mm², 400 mm², 350 mm², 300 mm², 250 mm², 200 mm², 150 mm², 100 mm², 90 mm², 80 mm², 70 mm², 60 mm², 50 mm², 40 mm², 30 mm², 20 mm², 10 mm², 9 mm², 8 mm², 7 mm², 6 mm², 5 mm², 4 mm², 3 mm², 2 mm², 1 mm², 0.9 mm², 0.8 mm², 0.7 mm², 0.6 mm², 0.5 mm², 0.4 mm², 0.3 mm², 0.2 mm², 0.1 mm², 0.09 mm², 0.08 mm², 0.07 mm², 0.06 mm², 0.05 mm², or less. In some embodiments, the area of the zone may be between about 100 square millimeter (mm²) and about 500 mm². For example, the area of the zone may be about 100 mm², 150 mm², 200 mm², 250 mm², 300 mm², 350 mm², 400 mm², 450 mm², or 500 mm².

In an aspect, the present disclosure provides a thermal management device comprising an array of fins comprising one or more fins configured for heat transfer to or from a fluid in contact with the one or more fins. The array of fins may comprise a first subarray of fins with a first fin configuration and a second subarray of fins with a second fin configuration.

The thermal management device may further comprise a manifold block located adjacent to said array of fins. The manifold block may comprise an inlet, an outlet, and a fluid flow path in fluid communication with the inlet and the outlet. The fluid flow path may be configured to direct a fluid (i) from the inlet to the one or more fins, and (ii) from the one or more fins to the outlet.

The first fin configuration and the second fin configuration may comprise a fin density, a fin material, a fin position, a fin orientation, a fin size, and/or a fin geometry. In some cases, the first fin configuration and the second fin configuration may be different. In such cases, the first fin configuration may provide a first set of flow characteristics for the fluid as the fluid flows through the first subarray of fins, and the second fin configuration may provide a second set of flow characteristics for the fluid as the fluid flows through the first subarray of fins. The first set of flow characteristics and the second set of flow characteristics may comprise a fluid flow rate or a hydraulic diameter of a fluid flow through a subarray of fins.

In some cases, the first fin configuration may provide a first set of thermal performance characteristics for the first subarray of fins, and the second fin configuration may provide a second set of thermal performance characteristics for the second subarray of fins. The first set and the second set of thermal performance characteristics may comprise a thermal resistivity.

In some examples, the array of fins of the thermal management device may further comprise an additional fin adjacent to a fin within the array of fins. A distance between the fin and the additional fin may be at least about 100 micrometers. In some cases, the distance may be at least about 150 micrometers. In some cases, the distance may be at least about 300 micrometers. In any of the embodiments described herein, the distance between a fin and an additional fin may range from between about 100 micrometers to 1 centimeter. For example, the distance may be at least about 100 micrometers, 150 micrometers, 200 micrometers, 250 micrometers, 300 micrometers, 350 micrometers, 400 micrometers, 450 micrometers, 500 micrometers, 550 micrometers, 600 micrometers, 650 micrometers, 700 micrometers, 750 micrometers, 800 micrometers, 850 micrometers, 900 micrometers, 950 micrometers, 1 millimeter (mm), 2 mm, 3 mm, 4 mm, 5 mm, 6 mm, 7 mm, 8 mm, 9 mm, 1 centimeter (cm), or more. In some cases, the distance may be at most about 1 cm, 9 mm, 8 mm, 7 mm, 6 mm, 5 mm, 4 mm, 3 mm, 2 mm, 1 mm, 950 micrometers, 900 micrometers, 850 micrometers, 800 micrometers, 750 micrometers, 700 micrometers, 650 micrometers, 600 micrometers, 550 micrometers, 500 micrometers, 450 micrometers, 400 micrometers, 350 micrometers, 300 micrometers, 250 micrometers, 200 micrometers, 150 micrometers, 100 micrometers, or less.

The thermal management device may have a thermal resistivity. In some cases, the thermal resistivity of the thermal management device may be at most about 35 mm²·° C./W. In some cases, the thermal resistivity of the thermal management device may be greater than 35 mm²·° C./W. For example, a thermal management device with a fin-to-fin spacing of about 300 micrometers may have a thermal resistivity of about 39 mm²·° C./W. In some cases, the thermal management device may exhibit a thermal resistivity that is at least 5% less than a thermal management device having an array of fins that are not textured. An array of fins that are not textured may comprise one or more fins with a substantially flat surface. The one or more fins with substantially flat surfaces may not comprise one or more surface features disposed along the substantially flat surfaces of the one or more fins. As described above, the surface features may comprise a protrusion, a depression, a well, a void, a channel, a perforation, a groove, and/or a slit. In some cases, the thermal management device may exhibit a thermal resistivity that is less than a thermal resistivity of a thermal management device that does not have textured fins by at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or more. In some cases, the thermal management device may exhibit a thermal resistivity that is less than a thermal resistivity of a thermal management device that does not have textured fins by at most about 95%, 90%, 85%, 80%, 75%, 70%, 65%, 60%, 55%, 50%, 45%, 40%, 35%, 30%, 25%, 20%, 15%, 10%, 5%, or less.

As described above, the thermal management devices disclosed herein may comprise one or more fins having a textured surface. The one or more textured fins may have one or more protrusions or depressions on at least a portion of the surface of the fins. In some cases, the one or more textured fins may comprise one or more periodically-spaced surface features disposed along a surface of the one or more textured fin in one or more directions. The periodically-spaced surface features may comprise a protrusion, a depression, a well, a void, a channel, a perforation, a groove, a slit, and/or an airfoil.

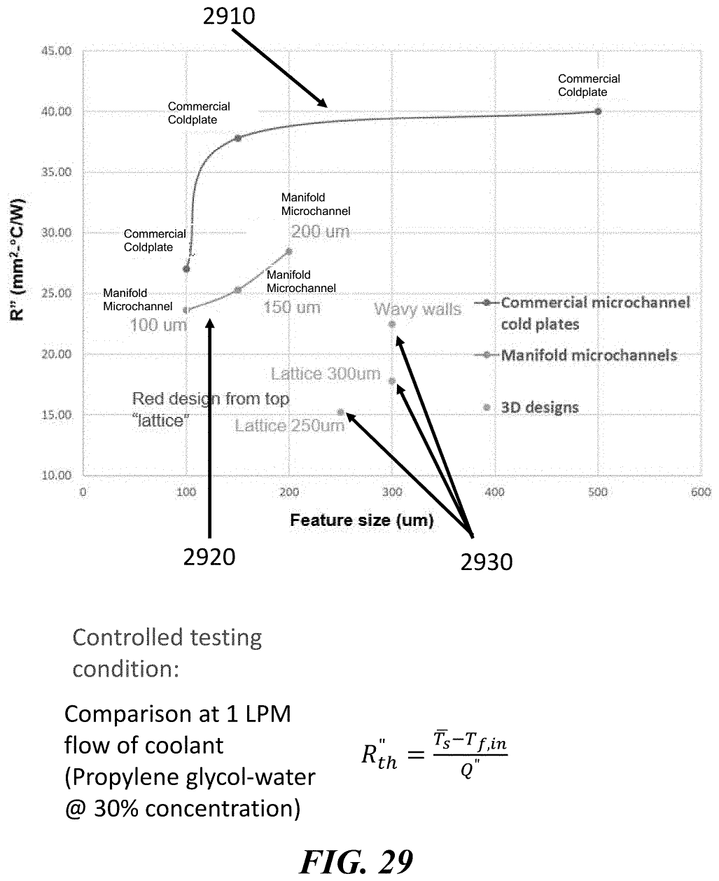

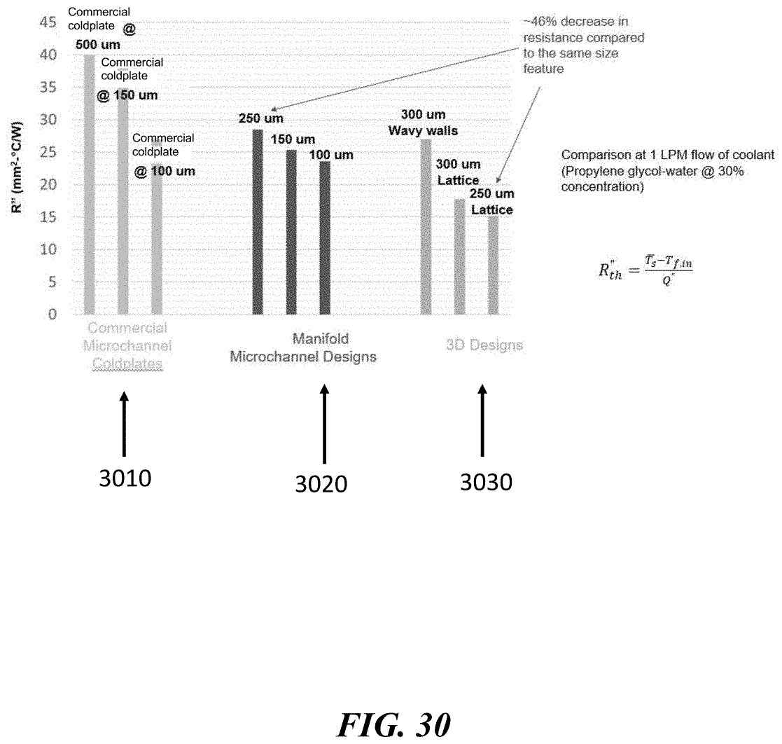

FIGS. 29-30 illustrate a comparison of thermal performances of manifold microchannel cold plates and commercial microchannel cold plates as a function of feature size. As shown in FIG. 29, commercial microchannel cold plates may exhibit a thermal performance 2910 that is inferior to a thermal performance 2920 of a manifold microchannel cold plate for feature sizes ranging from 100 microns (or micrometers) to 200 microns. The feature sizes may correspond to a fin wall width of one or more fins in the array of fins adjacent to a plate. The commercial microchannel cold plates may also exhibit a thermal performance 2910 that is inferior to a thermal performance 2930 of a manifold microchannel cold plate having one or more 3D designs, including lattices and/or wavy walls. The lattices may be disposed between two or more fins having a fin wall width of 250 microns or 300 microns. The wavy walls may be implemented in thermal management devices comprising one or more fins having a fin wall width of 300 microns. The thermal performances shown in FIG. 29 may be determined based on testing conditions under which a cooling fluid comprising propylene glycol-water at 30% concentration (weight by volume) flows through the microchannels at a flow rate of 1 liter per minute.

As shown in FIG. 30, the thermal performance 3020 of manifold microchannel cold plate designs may be superior to the thermal performance 3010 of commercial microchannel cold plate designs, for similar feature sizes. As illustrated, the thermal performance 3020 of the manifold microchannel cold plate designs may correspond to thermal management devices with fins having a fin wall width of 100 microns, 150 microns, and 250 microns. The thermal performance 3010 of the commercial microchannel cold plate designs may correspond to thermal management devices with fins having a fin wall width of 100 microns, 150 microns, and 500 microns. Further, the thermal performance 3030 of manifold microchannel cold plate designs with three-dimensional features such as ancillary structures selected from the group consisting of linear ridges, aerodynamic solids, chevrons, triangular prisms, lattices, pins, and helices may be superior to the thermal performance 3020 of manifold microchannel cold plate designs without such three-dimensional features. As illustrated in FIG. 30, for thermal management devices with feature sizes of 250 microns, the manifold microchannel cold plate designs with three-dimensional features may provide about a 40% reduction in thermal resistance compared to manifold microchannel cold plate designs without such three-dimensional features.

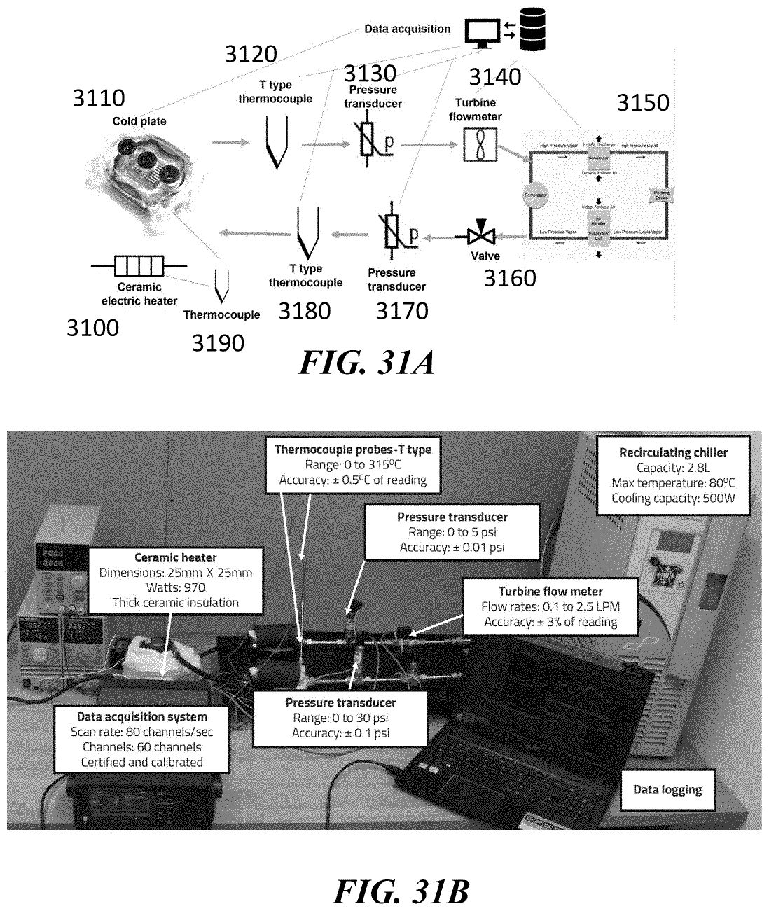

FIGS. 31A-31B illustrate a test setup for measuring a thermal performance of a thermal management device. The test setup may be configured to measure pressure drops to an accuracy of ±0.1 psi and thermal resistance to an accuracy of ±0.003° C./W. The test setup may comprise a ceramic electric heater 3100 in thermal contact with a cold plate 3110. The test setup may further comprise a first T type thermocouple 3120, a first pressure transducer 3130, a turbine flowmeter 3140, a recirculating chiller 3150, a valve 3160, a second pressure transducer 3170, a second T type thermocouple 3180, and a thermocouple 3190. The ceramic heater 3100 may have dimensions of 25 millimeters by 25 millimeters and may be configured to transfer or output heat at a rate of 970 watts. The T type thermocouples 3120 and 3180 may have a reading range of 0 degrees Celsius to 315 degrees Celsius and an accuracy of ±0.5 degrees Celsius. The first pressure transducer 3130 may have a reading range of 0 pounds per square inch to 5 pounds per square inch and an accuracy of ±0.01 pounds per square inch. The second pressure transducer 3170 may have a reading range of 0 pounds per square inch to 30 pounds per square inch and an accuracy of ±0.01 pounds per square inch. The turbine flow meter 3140 may be configured to measure flow rates ranging from 0.1 liters per minute to 2.5 liters per minute and an accuracy of ±3%. The recirculating chiller 3150 may comprise a compressor, a condenser, a metering device, an air handler, and an evaporator coil. The recirculating chiller 3150 may have a capacity of 2.8 liters and a cooling capacity of 500 watts. The test setup may further comprise a data acquisition unit configured to obtain measurements from one or more components of the test setup at a data acquisition rate of 80 channels per second. The data acquisition unit may comprise 60 channels.

As described above, any of the thermal management devices disclosed herein may be manufactured using the three-dimensional (3D) printing system 400 illustrated in FIG. 4. The three-dimensional (3D) printing system 400 of FIG. 4 may be used to print the thermal management device. Initially, a computer model (e.g., a CAD model) of the thermal management device may be obtained in computer memory. The computer model may be sliced into a plurality of slices (e.g., a first slice, a second slice, etc.). The plurality of slices can be parallel to a base or a bottom surface of the thermal management device. The plurality of slices may correspond to one or more horizontal cross-sections of the thermal management device or a portion of the thermal management device (e.g., a plate of the thermal management device, a portion of the plate, an array of fins of the thermal management device, a portion of the array of fins, an array of manifold walls of the thermal management device, a portion of the array of manifold walls, the manifold block of the thermal management device, and/or a portion of the manifold block). The plurality of slices may have a thickness of at least about 1 micrometer (μm), 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 100 μm, 200 μm, 300 μm, 400 μm, 500 μm, 600 μm, 700 μm, 800 μm, 900 μm, 1000 μm, or more. The plurality of slices may have a thickness of at most about 1000 μm, 900 μm, 800 μm, 700 μm, 600 μm, 500 μm, 400 μm, 300 μm, 200 μm, 100 μm, 90 μm, 80 μm, 70 μm, 60 μm, 50 μm, 40 μm, 30 μm, 20 μm, 10 μm, 9 μm, 8 μm, 7 μm, 6 μm, 5 μm, 4 μm, 3 μm, 2 μm, 1 μm, or less.

Next, resin may be deposited on a portion of the print window 402 of the open platform 401. The open platform 401 may be a build platform. After resin is deposited on a portion of the print window 402 of the open platform 401, a build head 410 may be provided. The build head 410 may be configured to hold at least a portion of the thermal management device during fabrication of the thermal management device. The build head 410 may be configured to hold one or more of the plurality of slices corresponding to one or more horizontal cross-sections of the thermal management device or a portion of the thermal management device during fabrication of the thermal management device. Prior to directing a photoinitiation light and/or a photoinhibition light through the print window 402 and to the resin, the build head 410 may be moved towards the print window 402 and brought into contact with the resin.

The resin may be subsequently exposed to a photoinitiation light and/or a photoinhibition light to cure a portion of the resin between the build head 410 and the open platform 401. The cured portion of the resin may correspond to a first slice of the thermal management device. The first slice may be attached to the build head 410. The build head 410 may be moved away from the build platform and any excess (uncured) resin may be removed from the open platform 401.

Next, resin may be applied to a portion of the open platform 401, including the print window 402, and the build head 410 may be moved towards the open platform 401 to a position such that the first slice is in contact with the resin. The resin may be subsequently exposed to a photoinitiation light and/or a photoinhibition light to cure a portion of the resin. The cured portion of the resin may correspond to a second slice of the thermal management device, which may be attached to the first slice.

This process may be repeated until all of the plurality of slices corresponding to a horizontal cross-section of the thermal management device or a portion of the thermal management device have been generated on the build head 410. The plurality of slices may then be removed from the open platform 401 to yield the thermal management device.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-58. (canceled)

59. A thermal management device, comprising:
a baseplate in thermal communication with a heat source, wherein an area of said baseplate is divided into a plurality of zones,
wherein a zone of said plurality of zones comprises a plurality of fins in thermal communication with said baseplate,
wherein one or more ancillary structures are (i) disposed between at least two adjacent fins of said plurality of fins, and (ii) in thermal communication with at least one of said at least two adjacent fins and optionally with said baseplate,
wherein said one or more ancillary structures are selected from the group consisting of: linear ridges, aerodynamic solids, chevrons, triangular prisms, lattices, pins, and helices,
wherein said baseplate and said array of fins comprise a material exhibiting a thermal conductivity greater than about 200 W/m-K, and
wherein said thermal management device is configured for a cooling fluid to flow through said thermal management device with a device flow rate and a device flow velocity.

60. The thermal management device of claim 59, wherein one or more fins of said plurality of fins are planar.

61. The thermal management device of claim 59, wherein one or more fins of said plurality of fins are jagged.

62. The thermal management device of claim 59, wherein one or more fins of said plurality of fins are parallel.

63. The thermal management device of claim 59, wherein said linear ridges or said triangular prisms are parallel to said baseplate.

64. The thermal management device of claim 59, wherein at least one of said plurality of fins has a comb structure.

65.-106. (canceled)

107. The thermal management device of claim 59, wherein said one or more ancillary structures are linear ridges.

108. The thermal management device of claim 59, wherein said one or more ancillary structures are aerodynamic solids.

109. The thermal management device of claim 59, wherein said one or more ancillary structures are chevrons.

110. The thermal management device of claim 59, wherein said one or more ancillary structures are triangular prisms.

111. The thermal management device of claim 59, wherein said one or more ancillary structures are lattices.

112. The thermal management device of claim 59, wherein said one or more ancillary structures are pins.

113. The thermal management device of claim 59, wherein said one or more ancillary structures are helices.

114. The thermal management device of claim 59, wherein said one or more ancillary structures are in thermal communication with said at least two adjacent fins.

115. The thermal management device of claim 59, wherein said one or more ancillary structures are in thermal communication with (1) said at least one of said at least two adjacent fins and (2) said baseplate.

116. The thermal management device of claim 59, wherein an additional zone of said plurality of zones comprises an additional plurality of fins in thermal communication with said baseplate.

117. The thermal management device of claim 116, wherein said zone and said additional zone exhibit different thermal resistivity values.

118. The thermal management device of claim 116, wherein said zone and said additional zone exhibit different flow resistance values.

119. The thermal management device of claim 59, wherein said thermal conductivity is greater than about 300 W/m-K.

120. The thermal management device of claim 59, wherein a cross-sectional dimension of said one or more ancillary structures vary along a direction of flow of said cooling fluid along said zone.
